(19) United States
(12) Patent Application Publication
(10) Pub. No.: US 2012/0259752 A1
(43) Pub. Date: Oct. 11, 2012

(54) FINANCIAL AUDIT RISK TRACKING SYSTEMS AND METHODS

(76) Inventor: Brad Agee, Lubbock, TX (US)

(21) Appl. No.: 13/080,225

(22) Filed: Apr. 5, 2011

(51) Int. Cl. G06Q 40/00

(52) U.S. Cl. 705/35

(57) ABSTRACT

A system is provided for audit risk and tracking (ART) including an audit firm application (ART1) and a client bank application (ART2). The system maintains a data model of control activities for a best practices bank (BPB), against which control activity gap assessments are conducted for client banks. An interactive gap assessment report allows insight into controls that are lacking versus the BPB. The ART1 and ART2 systems interact to allow the client bank to interact with the audit firm to cooperate in assessing and managing business initiatives and other control, audit, and ERM activity. Novel risk scoring assessments are provided to help manage client bank controls in relation to the BPB model. A web service is provided that automatically updates the BPB model from ART1 to ART2.

### FIELD OF THE INVENTION

The invention relates to financial institution audit and risk tracking systems, applications, and processes, and particularly to those that help financial audit firms and banks assess the bank's risk management activities against a theoretical ideal.

### BACKGROUND

While large banks often have systemized internal audit and risk mapping controls, mid-size banks frequently do not have mature systems implemented that are demonstrably compliant with such standards as the Committee of Sponsoring Organizations of the Treadway Commission (COSO) standard. The COSO standard helps businesses manage risk by providing framework for internal control of financial processes within any organization. COSO also helps companies comply with financial reporting as required by the Sarbanes-Oxley Act of 2002 (SOX).

In response to SOX and COSO, the industry has developed certain Active Risk Management systems that are designed to embed the COSO Enterprise Risk Management (ERM) methodologies into business operations. However, these systems are typically not suited to small and mid-sized banks, which do not have existing control structures, audit management, and assessment systems suitable for implementing COSO, and therefore need substantial interaction with outside consultants such as an audit firm in assessing and implementing risk management methodologies. Nor do the Active Risk Management systems provide ability to analyze the existing control structures in a bank to see how they compare with the theoretical best practices ideal. Further, existing systems do not provide a way for smaller and medium banks to develop efficient cooperation with outside audit firms in assessing and managing risk.

Further, existing Active Risk Management systems typically do not provide a way for banks to decide on how to implement new control activities through new business initiatives. Existing systems to evaluate the costs and risk associated with new control initiatives are often subjective, and frequently based on proprietary methodologies internal to the bank or the bank's audit firm. Existing systems also do not manage updates to industry best practices in a cohesive manner, and further do not provide a way for audit firms, who stay up to date on regulatory updates, to easily push their best practices updates to their client banks.

As used herein, the terms ‘Bank’ and ‘financial institution’ are interchangeable. They are defined as deposit-taking institutions that accept and manage deposits and make loans; they include commercial banks, credit unions, and mortgage loan companies. ‘Banks’ in the United States have various agencies that function as key governing bodies; (1) The Federal Financial Institutions Examination Council (FFIEC); (2) the Office of the Comptroller of the Currency (OCC)—for National Banks; (3) Federal Deposit Insurance Corporation (FDIC)—for State “non-member” banks; (4) National Credit Union Administration (NCUA)—for Credit Unions; (5) Federal Reserve (Fed)—“member” Banks; (6) Office of Thrift Supervision—National Savings & Loan Association; and (7) State governments which each often regulate and charter financial institutions within their respective state.

The term ‘Audit Firm’ might be defined as follows: CPA firms that perform audits toward financial institutions; sample audit area titles include: Financial Statement Audit (Fiduciary); Internal Controls Audit; Compliance Audit; Information Systems/Technology Audit; Automated Clearing House (ACH) Audit.

### SUMMARY OF THE INVENTION

A system is provided for audit risk and tracking (ART) including an audit firm application (ART1) and a client bank application (ART2). The system maintains a data model of controls for a best practices bank (BPB), against which control activity gap assessments are conducted for client banks. An interactive gap assessment report allows insight into controls that are lacking versus the BPB. The ART1 and ART2 systems interact to allow the client bank to manage business initiatives and other control, audit, and Enterprise Risk Management (ERM) activity. Novel risk scoring assessments are provided to help assess risk and make choices in managing controls in relation to the BPB model. A web service is provided that automatically updates the BPB model from ART1 to ART2.

In one embodiment, the invention provides a method of managing risk in a bank. The method preferably employs a system of one or more software running on one or more application server processors. A data model is provided of a hypothetical BPB stored in memory of one of the application servers. The application presents one or more web forms to one or more client bank employees. Through the forms, the application receives data that characterizes risk management controls operating at the client bank. The application also receives data classifying selected ones of the first risk management controls as being associated with certain business functions present in the data model of the hypothetical BPB. The audit firm uses the gathered information to generate a control activity gap assessment report comparing the first risk management controls to the data model of the hypothetical best practices bank and identifying areas where the first risk management controls are lacking compared to the hypothetical best practices bank. The control activity gap assessment report is made available to the client in an interactive manner allowing insight into the source of various risks measured by the report.

In another embodiment, the invention includes a method of providing risk scoring services to a bank using one or more software applications running on one or more application server processors. Such a method uses a number of novel factors in determining risk scores associated with various business functions. The method is conducted as follows. First, it includes receiving an indication that a set of risk factors is associated with a logical parent entity of an institution being evaluated, based on the logical parent entities from the BPB model developed for the system herein. The method provides an indicator of a risk factor score associated with an estimated inherent risk level for each respective one of the set of risk factors. Also provided is an indicator of a risk factor weight associated with each respective one of the set of risk factors. From these indicators, the method calculates a final inherent risk score value for each of the respective set of risk factors from its associated risk factor score and risk factor weight.

The method also helps evaluate the risk by taking into account various factors about control activities present within the bank to mitigate the risk defined by each risk factor. This methodology includes first receiving an indicator of one or more control activities associated with a particular risk factor of the set of risk factors. Next, for each control activity, the method provides an initial mitigation percentage indicator of an assessment of how much the control activity mitigates its associated risk. For those risk factors having two or more associated control activities, the method receives an assessment of a percent impact exposure for each of the control activities associated with the risk factor.

The method also preferably uses some indicator of the weakness of the control activity to help assess risk. For each control activity, the method provides a weakness point total based on a set of weakness point assignments associated with the control activity. Then the method calculates a mitigation markdown percentage for each control activity based on its respective weakness point total and percentage impact estimate. For risk factors having two or more associated control activities, the method calculates a final mitigation markdown percentage based on the mitigation markdown percentage and a number of layered control activities associated with each risk factor.

Finally, the method calculates a residual risk score for each logical parent entity based on the final inherent risk score, the initial marginal percentage rate, and the final markdown percentage for all of the risk factors associated with the parent entity.

In another embodiment, a system provides a tool with which the bank and audit firm can map the bank's internal policies, reflected in policy documents, to the various Control Activities (CAs) or ERM activities conducted in the bank.

In another embodiment, the system provides an automated web service allowing client banks to receive updates to their best practices bank model and create internal initiatives to implement those updates in their control infrastructure.

### BRIEF DESCRIPTION OF THE DRAWINGS

FIG. 1 is a block diagram showing the functional entities and system elements of the ART1 and ART2 systems according to one embodiment.

FIG. 2A is a block diagram of various software modules in the ART1 application.

FIGS. 2B-C are a block diagram of certain software modules in the ART2 system.

FIG. 3 shows a general, high-level flow chart 300 of how the ART system may be used in an example relationship between the audit firm and a client bank.

FIG. 4A shows a table with a list of BPB model parent entities as employed in one preferred embodiment.

FIG. 4B shows a diagram of the Non-Control Services logical parent entity.

FIG. 4C shows a diagram of the second logical parent entity in the BPB model structure, the Enterprise control functions.

FIG. 4D shows a diagram of the third logical parent entity in the BPB model, the Enterprise Risk Management Q&A entity.

FIG. 4E shows a diagram of the next logical parent entity in the BPB model, Outsourcing Engagements with Third Party Firms

FIG. 4F shows a diagram of the next parent entity in the BPB model, the Application System Services entity.

FIG. 4G is a diagram of the next logical parent entity in the BPB model, the Products and Related Services entity.

FIG. 4H shows a diagram of the next model parent entity, the formal regulations model.

FIGS. 4J and 4K show an example embodiment of the Control Setting Risk Report.

FIG. 4L shows a database schema for implementing the Application Service entity (Parent Entity 5) functionality in one preferred embodiment.

FIG. 4M is a block diagram of a data structure implementing Parent Entity 1 in one embodiment.

FIG. 4N is a block diagram of a data structure implementing Parent Entity 2 in one embodiment.

FIG. 4P is a block diagram of a data structure implementing Parent Entity 3 in one embodiment.

FIG. 4Q is a block diagram of a data structure implementing Parent Entity 4 in one embodiment.

FIG. 5A is a use-case block diagram of the CA-GA pre-assessment activity process.

FIG. 5B is a use-case block diagram of certain CA-GA assessment data gathering activity process.

FIG. 5C is a use-case block diagram of further CA-GA assessment activity to document client bank control activities.

FIG. 5D is a flow chart of a process for mapping a client banks hierarchical structure.

FIG. 5E is an example screenshot of a web form allowing selection of active business units.

FIG. 5F is an example screenshot of a web form allowing reorganization of business units entered into the ART system.

FIG. 5G is an example screenshot of a web form allowing the user to view and edit business units already entered into the ART system.

FIG. 5H is an example screenshot of a web form allowing users to edit client bank divisions already entered into the ART system.

FIG. 5J is a flowchart of a use-case diagram showing the process of executing and delivering the CA-GA report to a client. Beginning at step 581, the firm/auditor personnel 102 execute the ART1 system functionality to produce a CA-GA report.

FIG. 5K is a screenshot of an example view of a portion of a CA-GA report.

FIGS. 5L-N show a sequence of screenshots for an example process of verifying the control activity infrastructure in a bank.

FIG. 6 is a flow chart of a scoring process according to one embodiment.

FIGS. 7A-7F illustrate an example of the risk scoring process described generally with respect to FIG. 6.

FIGS. 8A-F are parts of a diagram for an SQL schema for database tables implementing the scoring process described above. The figures are connected by the lines labeled with capital letters.

FIGS. 9A-B are diagrams of two use cases showing a process for automatically updating a best practices bank model at a client bank according to another embodiment.

FIG. 9C shows an SQL schema associated with the BPB model update process of FIGS. 9A-B.

FIG. 10A is a diagram of a use case for a policy mapping process according to another embodiment.

FIG. 10B is a diagram of an SQL schema used to implement the policy mapping process described with respect to FIG. 10A.

### DETAILED DESCRIPTION OF PREFERRED EMBODIMENTS

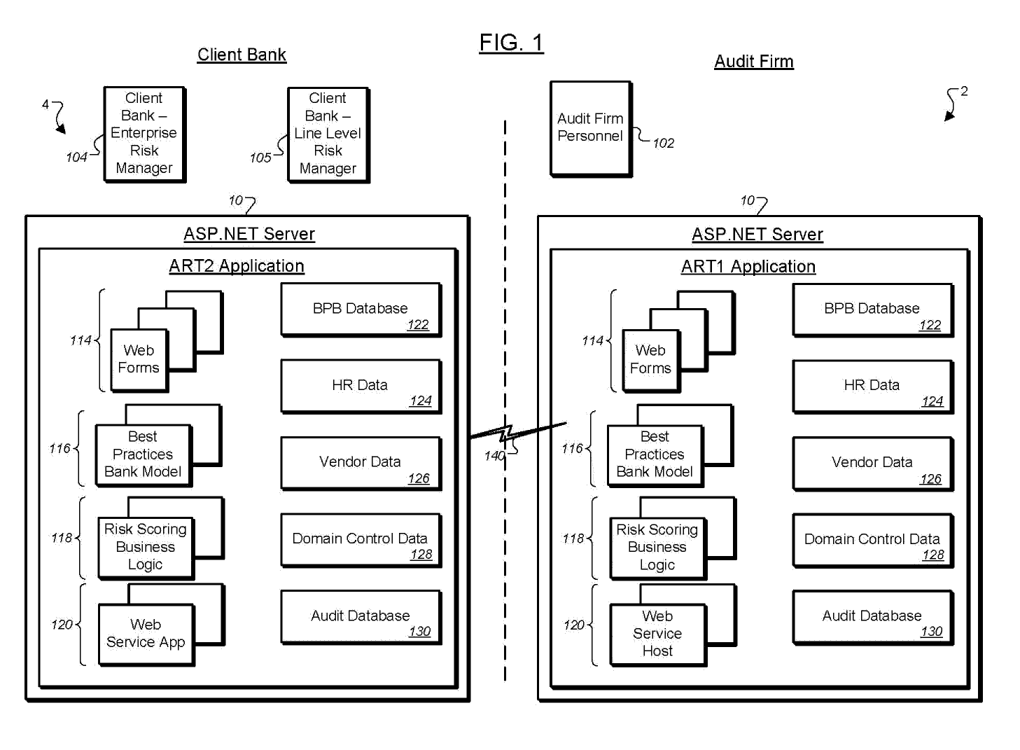

FIG. 1 is a block diagram showing the functional entities and system elements of the Audit Risk Tracking One (ART1) and Two (ART2) systems according to one embodiment. Depicted to the right is financial audit firm 2, which employs audit firm personnel 102 and performs financial audits for banks. The left of the diagram represents a single client bank 4, which employs enterprise risk managers 104 and line level risk managers 105.

In a preferred embodiment, the system herein provides two server applications, which run on respective ASP.NET servers 10 inside the trusted network of each organization. These applications provide a platform to manage and track audits and associated risks. The ART1 application is utilized by audit firms that conduct external audit services toward client banks in the financial services industry. While the applications are preferably used as a pair, much of the functionality herein may also be obtained using only ART1 installed at the audit firm, and allowing banking personnel to login securely. Generally the use of the system, whether ART1 alone or paired with ART2, will be referred to as “the ART system.” While the preferred embodiment is ASP.NET including the Common Language Runtime (CLR), allowing programmers to write ASP.NET code using any supported language, any other suitable web applications platform may be used, such as a LAMP architecture, for example. The depicted applications ART1 and ART2 run as web applications presenting web forms 114 to users over a network. According to the code-behind architecture of ASP.NET, the business logic of applications ART1 and ART2 is presented in a compiled set of controls and libraries, such as the depicted Best Practices Bank model control 116, the depicted risk scoring business logic library 118, and the depicted web service app 120. The functionality of these and other controls in ART1 and ART2 will be further described with respect to later figures.

The web forms 114 and their code-behind controls interact with a database, preferably Microsoft SQL Server, as the backend data repository. Depicted are several databases that appear in a preferred embodiment, although this is not limiting and of course databases may be combined and other databases may be used to implement other functionality described herein. The ART1 provides a platform for the Audit Firm to document (in a relational database 122) a hypothetical ‘Best Practice Bank (BPB)’ in terms of its internal controls. The BPB database 122 may also be present on the ART2 application, as shown. The human resources (HR) database 124 stores data regarding personnel and costs, used to calculate certain indicators and metrics in the Audit Risk Tracking management process as will be further described below. The vendor database 126 provides cost and indicator data regarding certain vendors. The domain control database 128 provides domain and role authorization data for the application. The audit database 130 stores data regarding past and prospective audits of various client bank functions, as will be further discussed below. While these databases have been depicted, this is not limiting and more detailed database schema will be discussed below, as well as novel functionality that one of ordinary skill in the art can implement with standard database techniques.

The ART1 and ART2 applications, in some embodiments, may communicate with a web service 120 to import and exchange non-sensitive information externally to the ‘trusted network.’ One such service will be further described below. Preferably ART1 and ART2 employ role-based authentication to each application's services; and use dual authentication and SSL encryption for user access external the trusted network.

ART1 leverages both the ASP.NET ‘browser based technology’ and the BPB model to provide client banks varied services such as, for example:
1. Service—Managing Request for Bid/Proposals (RFP's)
2. Core Service—Control Activity Mapped to the BPB
3. Service—Historical Audit Mapping and Implementation Status
4. Service—Products and Service Mapping to Bank Services
5. Service—Policy Statement Mapping to Control Activities

In particular, the system herein is useful for providing audit tracking and management services for mid-sized banks, those sized around $300M-$600 million in assets, although of course the concepts herein may be used with larger and smaller banks. While large banks often have internal audit and risk mapping controls already systemized, mid-size banks frequently do not have mature systems implemented that are demonstrably compliant with such standards as the Committee of Sponsoring Organizations of the Treadway Commission (COSO) standard, which helps businesses manage risk by providing framework for internal control of financial processes within any organization. COSO also helps companies comply with financial reporting as required by the Sarbanes-Oxley Act of 2002 (SOX). The ART1 and ART2 applications provide a platform to help comply with COSO and other management standards and duties.

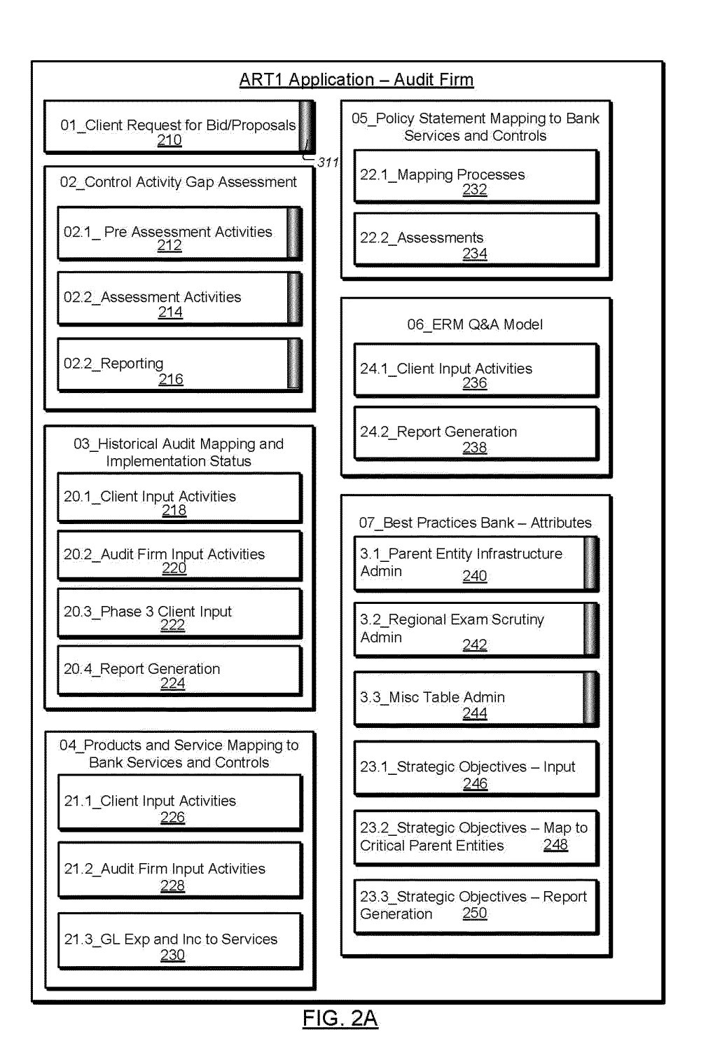

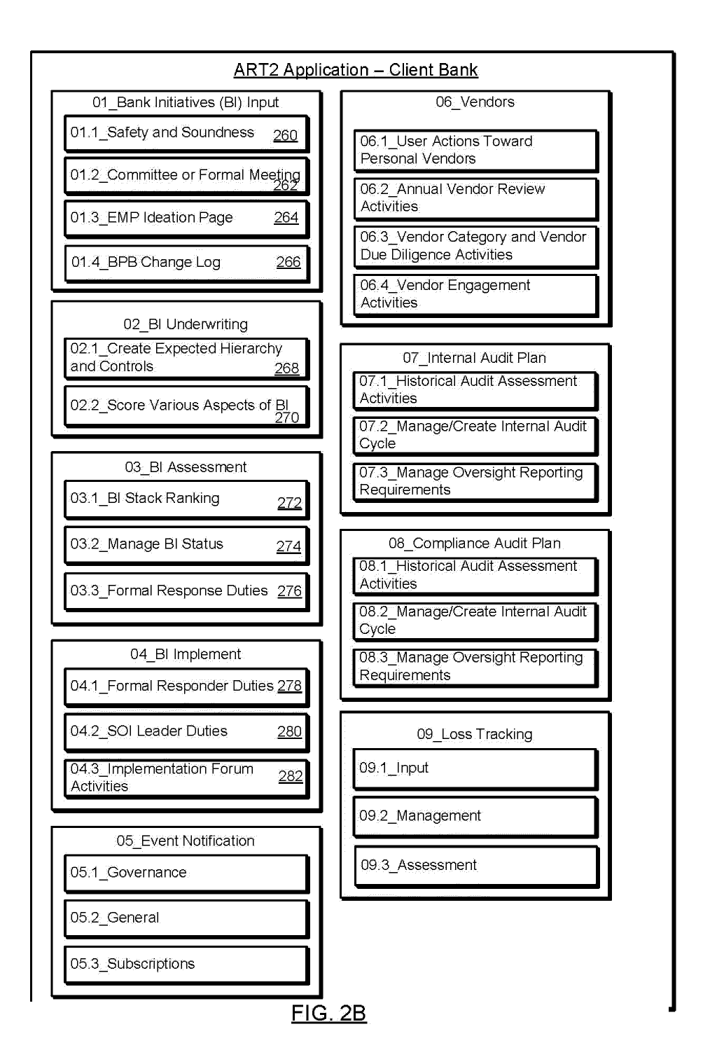

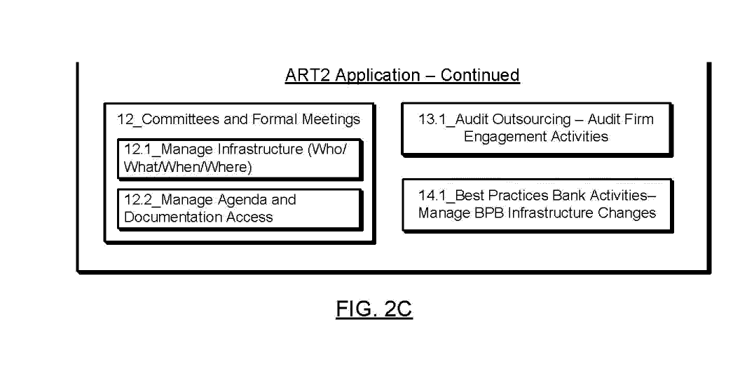

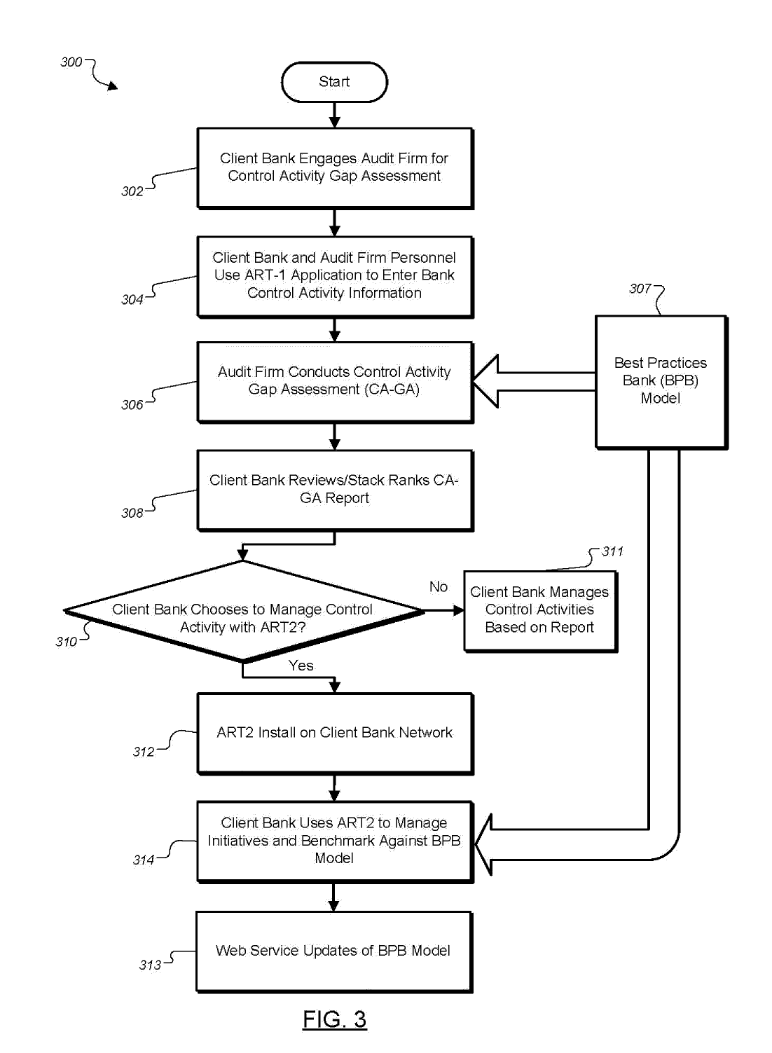

FIG. 3 shows a general, high-level flow chart 300 of how the ART system may be used in an example relationship between the audit firm and a client bank. Further details of preferred embodiments will be described with respect to other Figures. In the depicted process 300, the client bank initially engages the audit firm at step 302 to provide audit control services such as the preferred control activity gap assessment (CA-GA) described herein, which compares the bank control activities to the hypothetical BPB model. This functionality is further described with respect to the RFP module (FIG. 2A).

At step 304, the client bank personnel (such as 104 and 105) and the audit firm personnel (102) use the ART1 application to enter information about the banks control activities. It is important to note that preferred versions of ART system employ a client-initiated control identification and control assessment during the CA-GA, which helps achieve the following benefits:
a. Limited On-site Costs: Significant cost savings is passed on to the client, given that the identification and assessment phase does not include the time and travel expenses that customarily are logged by the Audit Firm auditors during a full control activity gap assessment.
b. Flexible Client Schedule During CA Mapping: Less work disruption toward the client's work schedule, given that the client is able to conduct the control identifications and assessments according to their schedule.
   Further, the entire process of performing a CA-GA is preferably done via the ‘web-interface’. Traditionally, assessments involve numerous spreadsheets of information where calculations and summary conclusions are based on spreadsheet references which are inherently unreliable in an Excel like tabbed spreadsheet environment. The ART methodology therefore helps provide more accurate documentation at this phase of the review. Based on this information, the audit firm now uses the ART system to provide a control activity gap assessment (CA-GA) report at step 306. The report is based on a comparison of the bank control structure with the BPB model 307. The client bank personnel can now review the CA-GA report and analyze the reported information in various ways such as stack ranking and browsing between levels (step 308). The client bank may also choose to have ART2 installed inside its own trusted network, as depicted in FIG. 1. This may be done in response to the CA-GA as depicted in step 310 if the bank decides they wish to employ ART2 to help manage their control activities using ART2. The client bank may also install ART2 at other points in the process or for other reasons such as other services provided through ART2 as further discussed below. Generally the process may include a subscription fee service to run ART2, or may instead be a fee for service business model where each particular service delivered through the ART system is purchased from the audit firm. If the client bank does not install ART2 on their services, they may manage their control activity with another system or their own established processes, and use the CA-GA report as input to that process as depicted at step 311. Should the client bank choose to use ART2 (step 310), it is installed in their internal trusted network (step 312). This may be done by the audit firm personnel or a third party Software Publisher or vendor. The client bank then, at step 314, uses ART2 to manage new initiative and other audit-risk control activity, and compare or benchmark this activity against the BPB model 307 provided by the audit firm. ART2 is targeted to be utilized by the client bank of the audit firm. Preferably, any data collected from the various modules of ART1 is imported into ART2. The only ‘required’ import is the ‘Control Activity Gap Assessment (CA-GA)’ data. The BPB model, at this step, preferably resides in a database on the ART2 system, but may also reside on ART2 and be accessed over a secure internet or network connection from ART2 to ART1. The preferred embodiment stores an updated set of data for the BPB model in the BPB database of ART2, and updates it via a web service from ART1 or from a third party subscription service that may provide an applicable BPB model (step 313). While the depicted process ends here, many other services and process are provided in preferred embodiments, as further described below.

The core construction of ART system functionality described above centers upon the concept of the Audit Firm creating/designing or employing a Best Practice Bank (“BPB”) that models the industry's ‘best practice’ control and risk infrastructure. In a preferred version, the BPB maintains logical data-sets titled ‘Parent Entities’. Each Parent Entity can be visualized as a high level grouping of similar activities that are performed within the BPB.

### ART1 Application Core Functionality

FIG. 2A is a block diagram of various software modules in the ART1 application. Those modules marked with a bar 311 are unique to the ART1 application. The remaining unmarked modules represent common core functionality to both the ART1 and ART2 applications. The depicted modules 210-250 each preferably have associated web forms and compiled code executing their functionality, although this is not limiting and some web application platforms used in certain embodiments may use un-compiled code.

Client Requests for Bid/Proposals

The client requests for bid/proposals module 210 (“audit RFP module 210”) shown is preferably used in ART1 (audit firm) and typically not present in the client bank application ART2, although ART2 may have a module for managing audit outsourcing. Audit RFP module 210 presents web forms allowing clients and potential clients to enter RFP's and submit audit work for bid to the host audit firm. In general such a scenario arises from the client bank or other financial institution needing an external audit firm to conduct and/or provide a proposal for audit services. ART1 automates various aspects of both the proposal and the audit services provided by the audit firm. The content and pricing for audit services are preferably drawn from the centralized SQL Database. Preconfigured Audit Plans may be programmed into ART1 based on any number of criteria such as the following:

a. Number of years engagement

b. Annual Budget for Audit services

c. Type of Audit (i.e. Compliance, Internal Audit etc)

Preferably at this step the client is able to dynamically change the final ‘selection’ of Audit Services. An initial proposal delivered via ART1 ‘authenticated’ web browser log-in. The proposal is first grouped by Audit Areas then by the details of the Business Functions to be audited. The content/information provided at this granular level allows the client to determine the value of the audit service, such as:

a. Audit Objectives

b. Estimated cost

c. Audit Scope (if applicable)

The client is given the option to remove (i.e. de-select) any audit services initially proposed. Upon removal the total ‘Proposed Bid’ is reduced per the stated ‘Estimated Cost’. Client is given the ability to toggle unselected audit services. This allows the client to see the full breadth of what could be audited as well as pricing and audit objectives. After selecting a particular set of audit services, the financial institution clients, or bank clients, have the ability to run audit penetration reports against any number of criteria that is related to the Best Practice Bank (i.e. ‘High Impact Regulatory Controls’, ‘High Time Constraint Variability Controls’, ‘High Execution Complexity Controls’, ‘High Residual Risk Scores’, ‘High Impact Scores’, etc.).

These penetration reports help achieve the following benefits.

a. Exposure to Additional Audit Services: The client bank is given a visual outline of possible audit services that might not have been evident to the client bank before the review of the penetration report.

b. Foreshadow Extensiveness of BPB Infrastructure: Although the penetration reports are in summary form, the client bank is able to see the extensive nature of the BBP infrastructure; which can pave the road for a future CA-GA.

Control Activity Gap Assessment

Next in FIG. 2A are the Control Activity Gap Assessment (CA-GA) modules 212-216. As discussed above, one of the core functions of the ART1 application is to provide ability for the Audit Firm to conduct a gap assessment for the client bank of both the control activities entity wide and at the business function level.

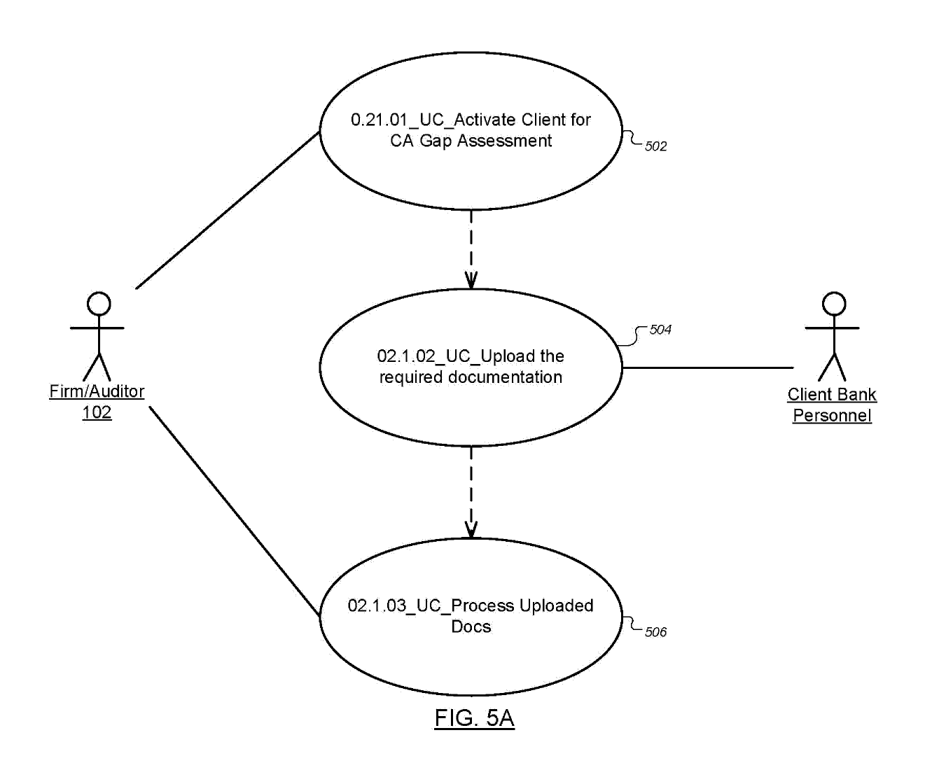

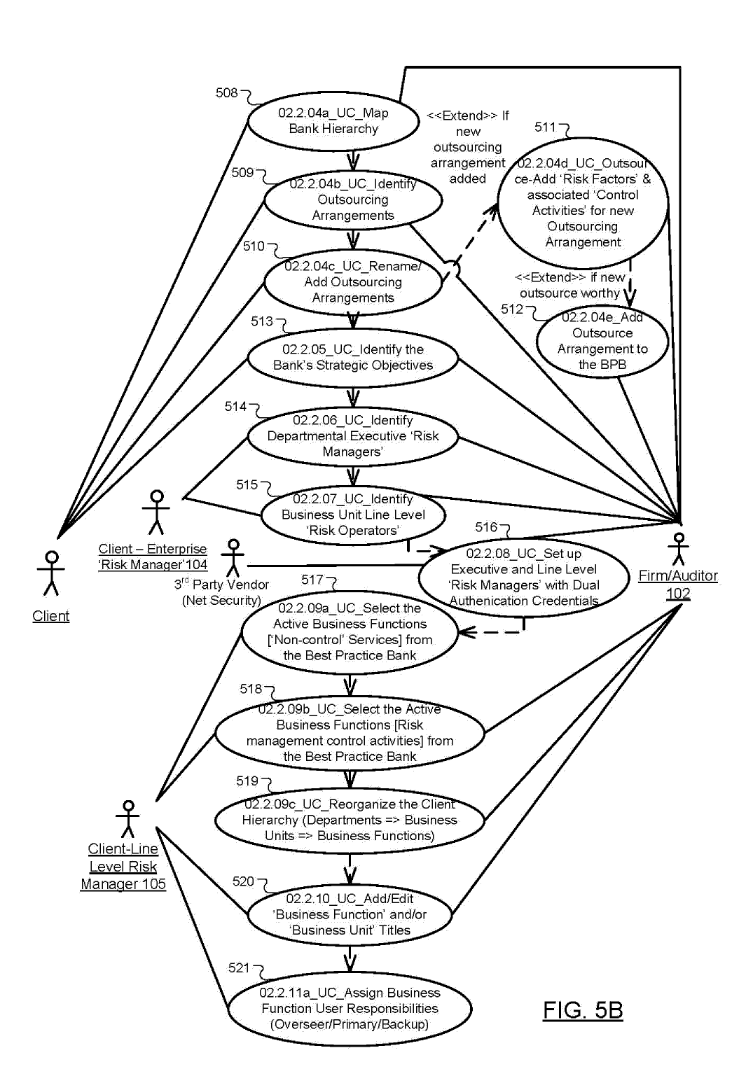

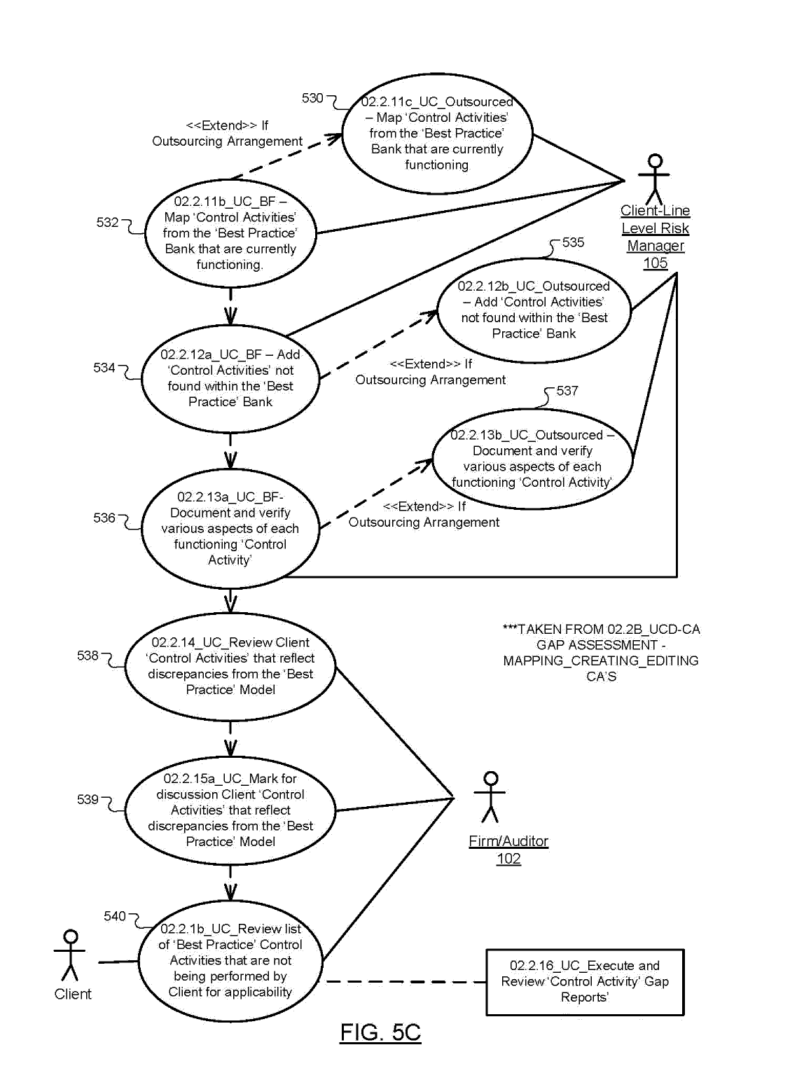

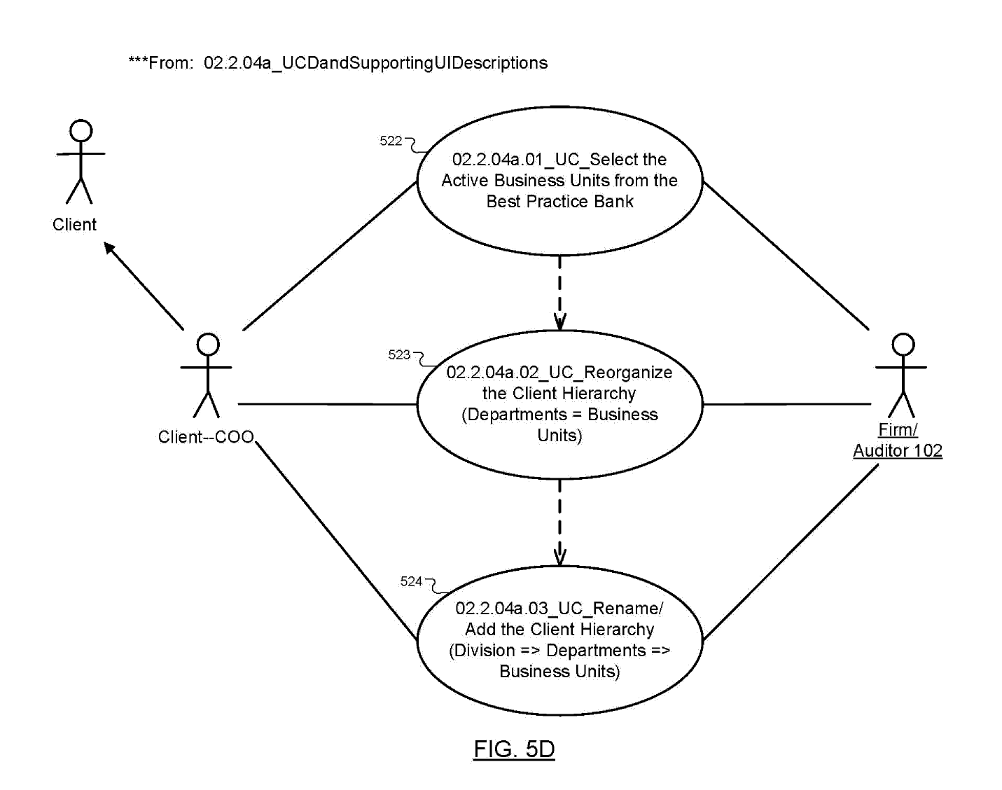

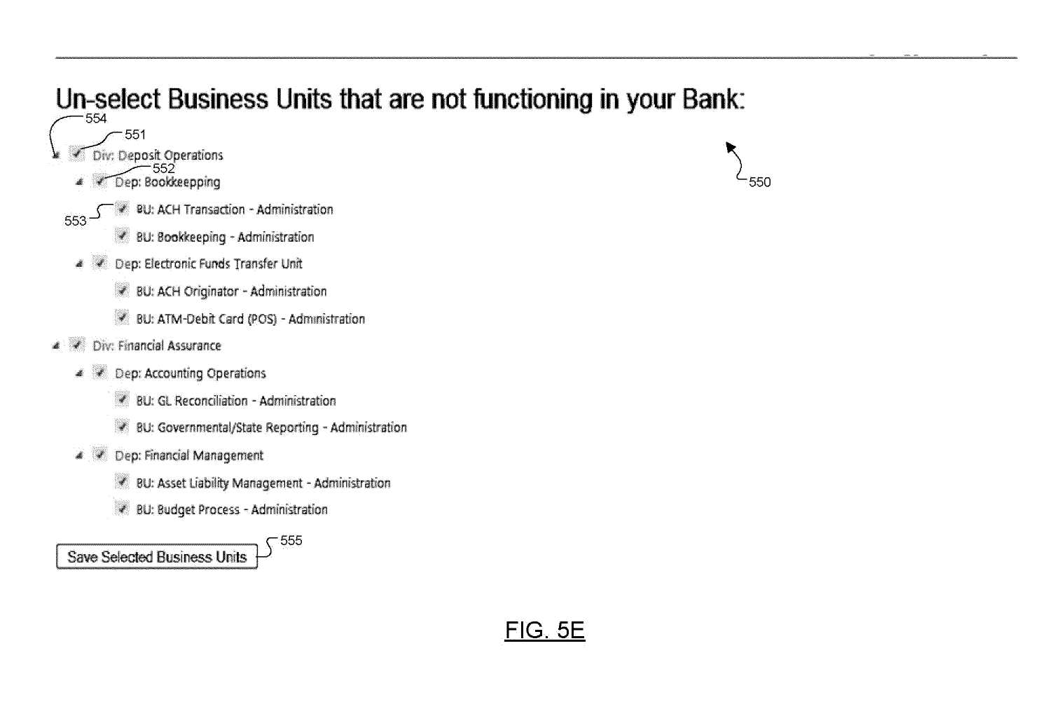

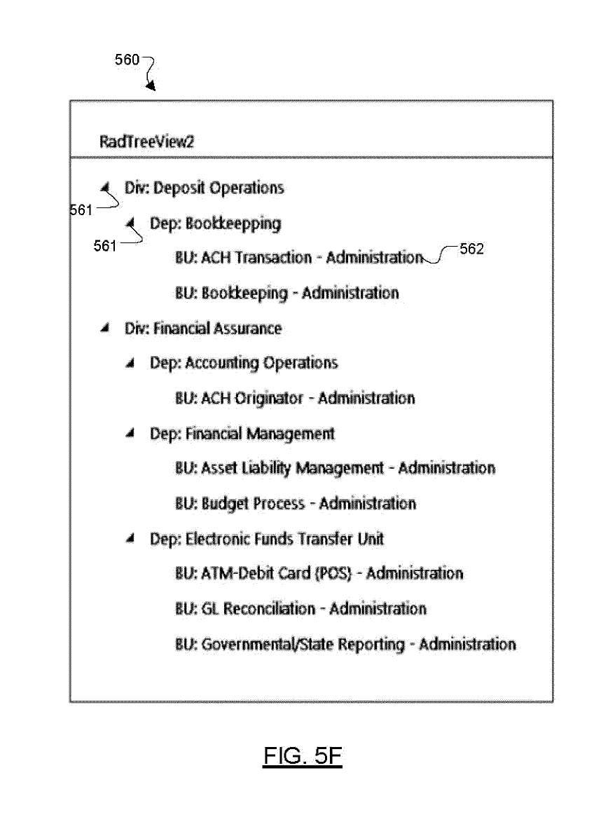

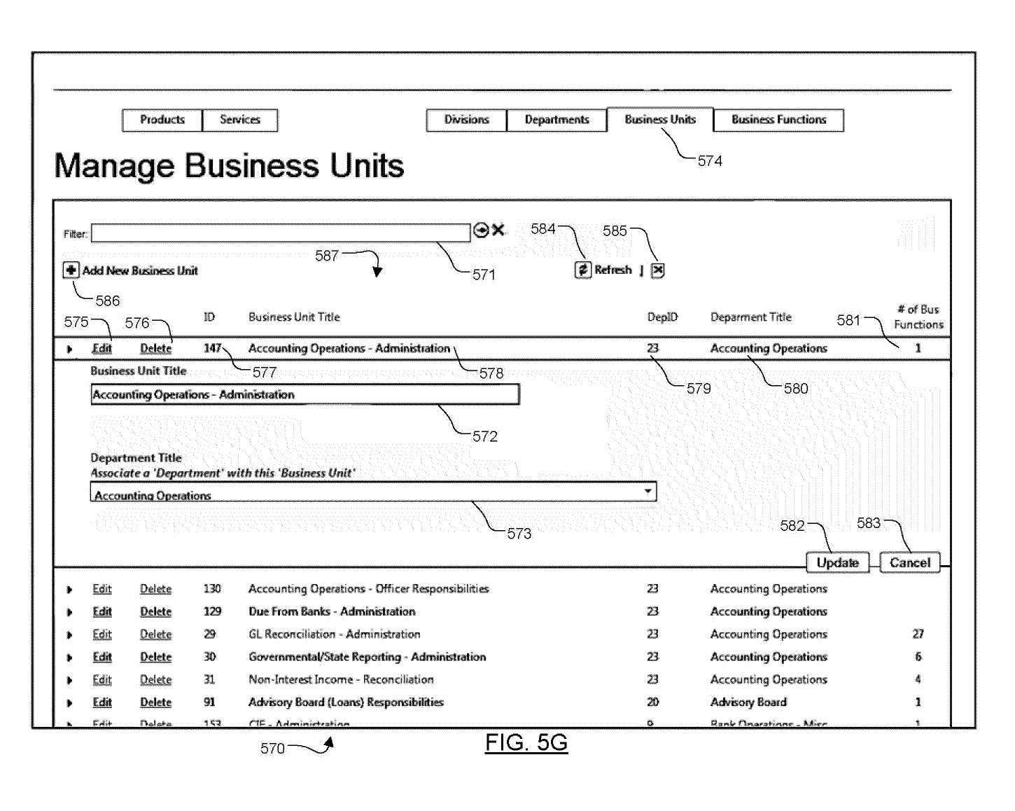

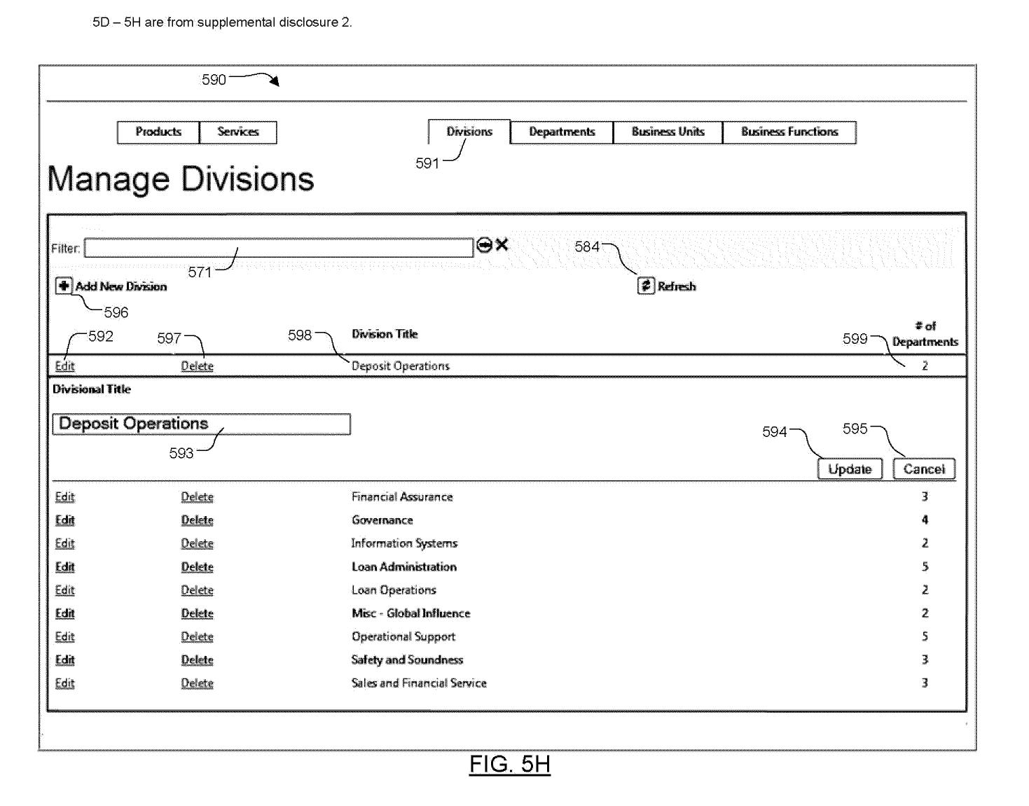

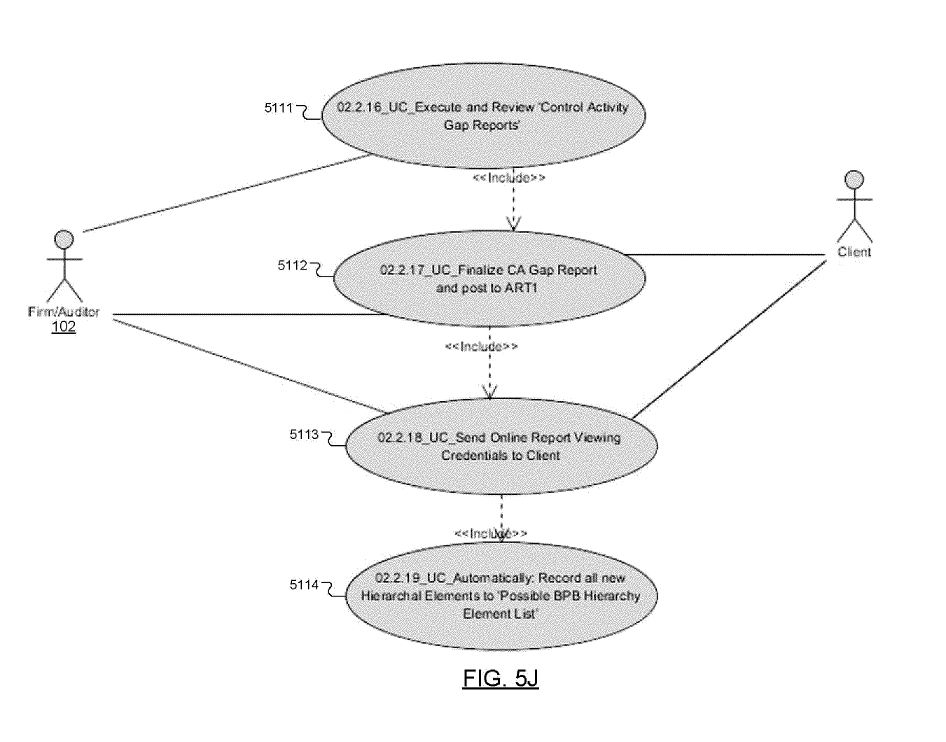

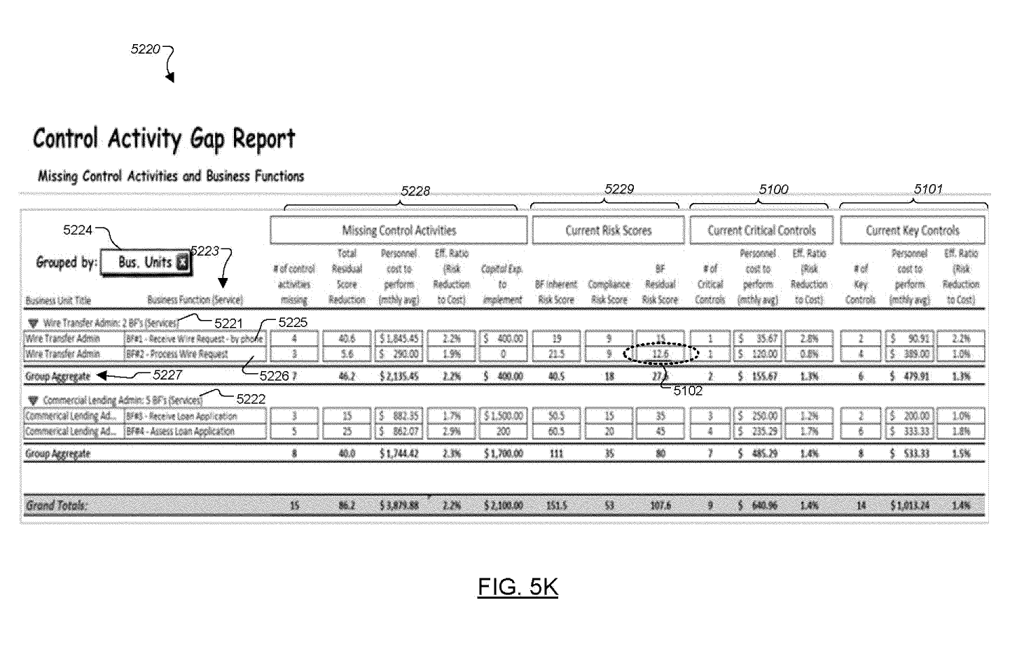

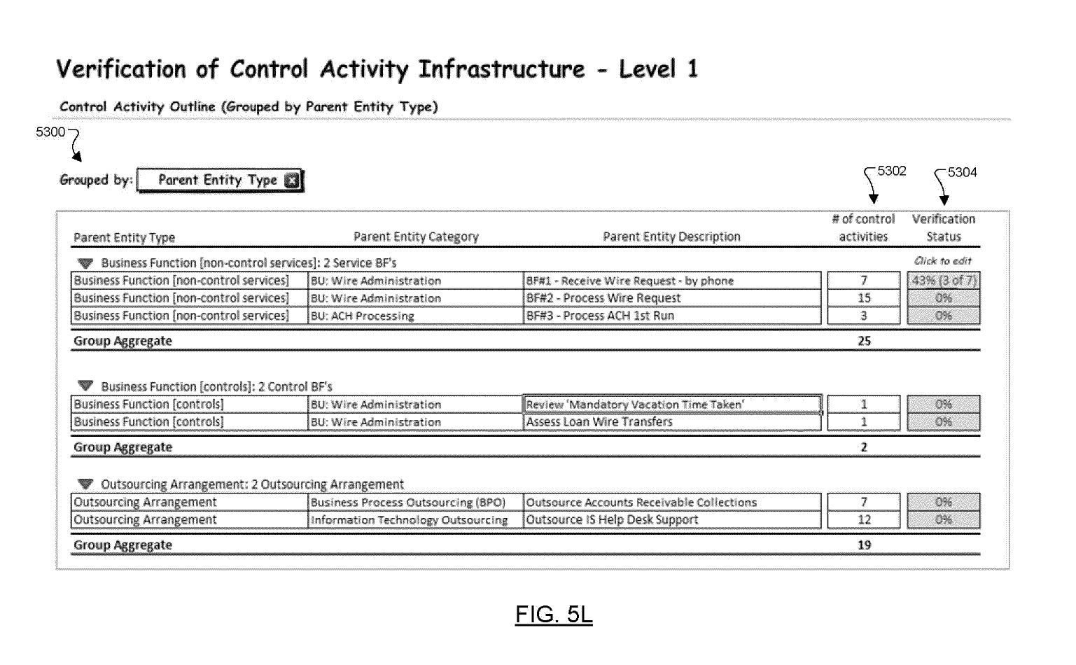

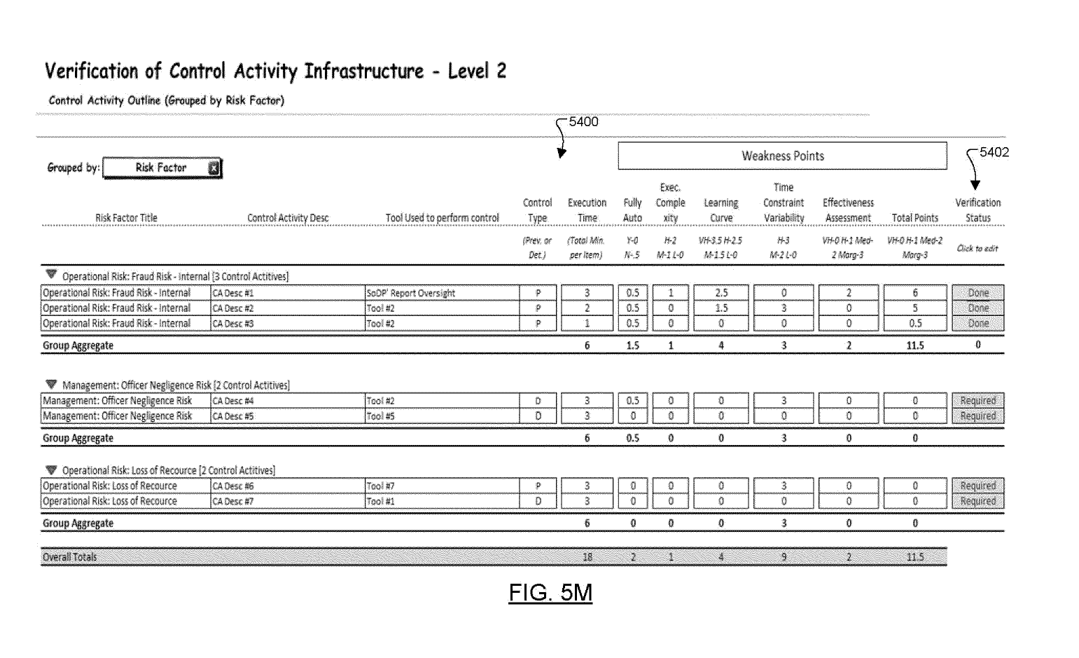

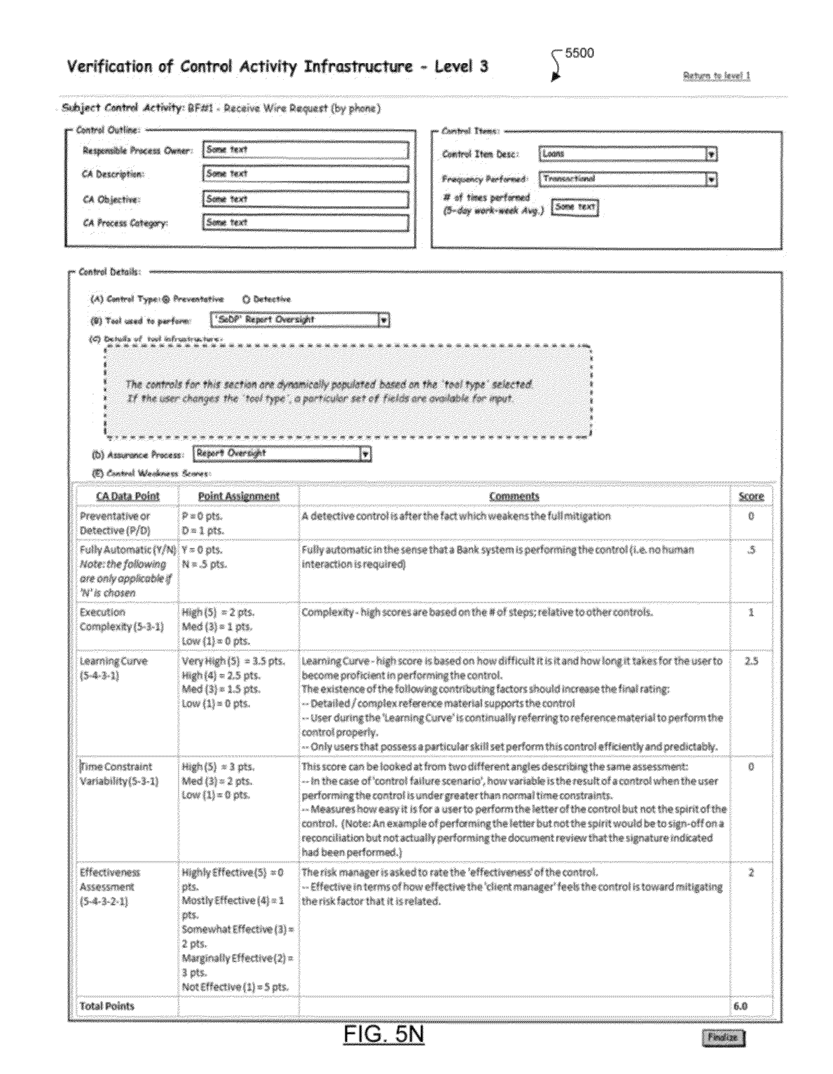

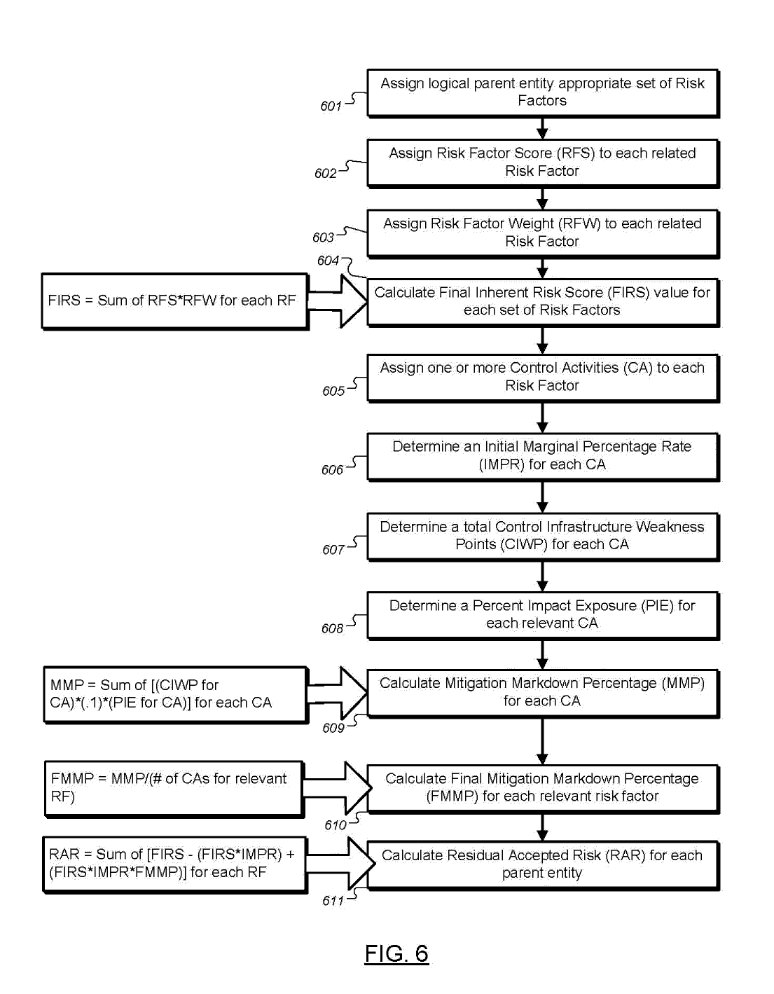

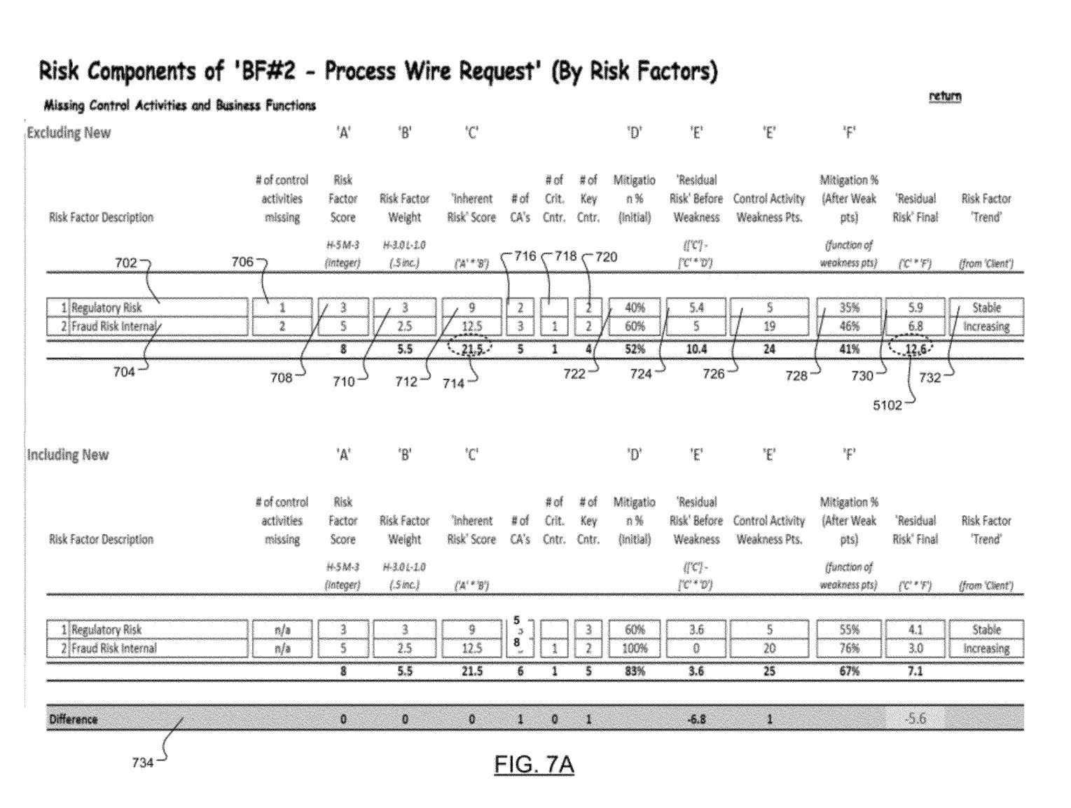

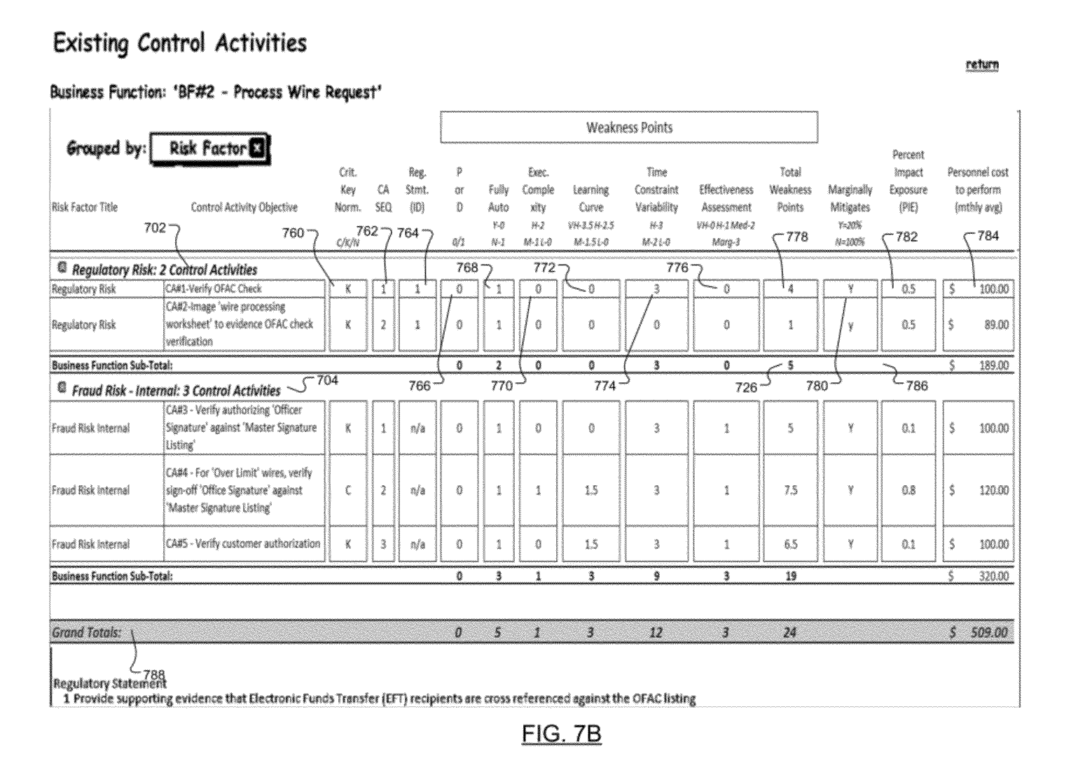

Further details of the CA-GA modules are described below with respect to FIGS. 5A-5C.

Historical Audit Mapping and Implementation Status

Next in FIG. 2A are modules 218 through 224, which perform the historical audit mapping and implementation status function. The need for this function arises in client banks because a significant percentage of time is spent by regulatory bodies (during exams) performing a thorough review of prior audit and exam findings and their corresponding implementation status. By performing this service for the client bank, comprehensive documentation for a full audit cycle of the Bank's Audit Plan is available for review. Given the time and expense typically required to conduct this service, it is expected that this service would normally only be performed by clients that intend to employ ART2 to help manage their Audit Plan and the implementation of findings. Module 218 provides functionality for the client to input required data, while module 220 provides for audit firm input. Then, a phase 3 client input module allows the client to add further data based on that requested by the audit firm. Finally module 224 performs report generation for the historical audit mapping and implementation service. This service is performed after the CA Gap Assessment has been finalized. For each Audit Area Title the report documents:
1. AUDIT ACTIVITIES: If found within the report, document:
   a. audit objectives;
   b. scope documentation;
   c. testing procedures
2. If this audit was performed by an external audit firm:
   a. Name of audit firm
   b. cost of services
   c. For each audit area title:
      i. Select the ‘Control Activities (CA)’ that were audited
      ii. Identify Recommendation/Finding issued
      iii. For each recommendation:
         Clip and paste the Recommendation/Finding issued by the report/exam
         Provide a short project statement (<85 characters) that best describes what was to be implemented
         Select the Bank Initiative ‘category’ (i.e. ‘Reduce Risk’/‘Reduce Expenses’/‘Increase Revenue’ etc.)
         Provide supplementary information from one or more of the following sources:
            Report itself (i.e. one or more sentences and/or paragraphs from the Audit report that brings clarity to the finding)
            Input User (i.e. user comments conducting the ‘Service’)
            Other source (text box for entry)
         Define the page # of the ‘Final Report/Exam PDF’ where this recommendation/finding is found
         Select the Type of Recommendation (DDL)
            if Recommendation relates to Documentation (Policy/Procedures), document the details
            if Recommendation makes reference toward changing or creating one or more ‘Control Activities’, document the details
            if Recommendation relates to a ‘non-control’ ‘Business Function’, identify which BF
            if None of the above (3) ‘Types of Recommendations’ are applicable, User Self Defines the type of Recommendation/Finding
         if This recommendation directly impacts one or more BU-BF's
            Select one or more BU/BF's that are directly referenced by the recommendation
3. An excel template is provided to bulk input the top level (flat/single row) information for each audit (i.e. Audit Title, Date Audit Performed, Formal Audit Report Date, Vendor/Audit Firm Name (i.e. Internal Audit or xyz Firm).
   1. Deliverables to Client after Historical Audit Mapping:

a. Audit Recommendation Status Matrix

XML Report with Drill Down
This report allows the user to review audit findings/recommendations and their status over a particular date range. The report is presented as a simple top level grouping of Audit Reports then their Recommendations and then SOI Tasks associated with each Recommendation. (and that can be drilled down to detailed information.
   i. The Audit Report Level provides the following Meta Data as columns:
      i. Report Date
      ii. Vendor Name
      iii. Audit Title
      iv. # of Recommendations (DRILL DOWN LINK TO ‘RECOMMENDATIONS’)
      v. Recommendations ‘% Implemented’
   ii. Recommendation Level Meta Data as columns
      i. Formal Recommendation
      ii. Supporting Information
      iii. Project Statement
   iii. SOI Task Level Meta Data as columns
      i. Officer Responsible for implementation
      ii. Date Implemented
      iii. Validation Documentation Y_N_N-A (LINK TO VALIDATION INFO)
         Target Date and reasoning for status ‘not implemented’

b. Audit Penetration of Key and Critical Controls

XML Report with Drill Down
This report allows the user to determine over a particular time frame the ‘Audit Penetration’ toward critical and key controls. The report allows the user to distinguish which control activities (entity wide and process) have and have not been audited based on risk and impact scores.

c. Audit Services Proposal toward Key and Critical Controls

XML Report with Drill Down
This report would accompany the prior report ‘Audit Penetration of Key and Critical Controls’ and would allow the Client to ‘browse’ a list of the Client's Key and Critical controls and review the ‘general objectives’ of the audits and the approximate cost to engage the audit firm for services.
   i. The Client is able to build their own ‘Audit Services Proposal’ given that the web site provides the ability to filter against any number of criteria and to deselect any particular items in the ‘result set’.
   ii. After the Audit Services are selected, the client would have the ability to select the ‘Audit Plan Cycle’ as 1 or more years.
      i. ART1 would then present the user a master ‘Audit Plan Matrix’
         Audit Services down the left side
         The columns represent the various quarters of the ‘Audit Plan Cycle’.
      ii. The Client would then select the ‘intersection’ of Audit Service and Quarter
      iii. Upon clicking ‘Update Service Cost’, the matrix updates the following
         Quarterly Total
         Yearly Total
         Overall Total

Products and Service Mapping to Bank Services and Controls

The next depicted set of modules labeled Products and Service Mapping to Bank Services and Controls provides ability for the client bank to break down their Bank (in terms of risk, costs, income, and ‘compliance elements’) into ‘Products’ and their related ‘Services’ that are offered to 3rd parties external the Bank. The Products and Services model defined herein provides more detail defining these terms. Given the time and expense to fully map the Client's products and services as well as the GL accounts, this service would normally only be requested by Clients that intend to utilize ART2 to help manage and track their Product and to implement the appropriate Control Activities. This service is performed after the CA Gap Assessment has been finalized.

ART breaks down the Bank into ‘Products’ and their related ‘Services’ offered to 3rd parties external the Bank. Services, as used in this context, includes: (1) supporting and/or establishing ‘Product’ offerings or (2) establishing ‘Goodwill’ with the 3rd party. In a preferred embodiment, each Service is related to one or more ‘Customer Interfaces’ (i.e. over the phone or face to face). Each Service is also related to one or more BF #1: Non-Control Activity 3rd Party Service'.

Module 226 provides the client input capabilities for the Products and Service Mapping to Bank Services and Controls capability. Module 228 provides the audit firm input capabilities. Finally, module 230 provides the client bank the ability to assign one or more GL's of the Bank to particular ‘Non-Control Activity 3rd Party Service’ Business Functions. After the GL is related to the Business Function, then the user is able to assign a particular dollar amount of the monthly GL average. This GL mapping is both for income and expenses.

Deliverables to Client after Product/Service Mapping:
a. Missing Business Function/Policy Statement Gap Report

Each Policy statement is related to one-or-more Business Functions. If the BF does not exist, it is placed on this report for the Client to either remove from the policy or create a Business Function toward.

b. Missing Policy Statement/Business Function Gap Report

Each Business Function that is related to one or more Key or Critical control activities is related to one or more Policy Statements. If the Policy Statement is not found then it is added to this report with the following variables related to the BF:

i. Total risk score

ii. If regulatory related,
1. Total monthly avg cost to comply with reg.

iii. If non-system,
1. Avg. complexity rating (i.e. how difficult is it to execute properly)
2. Avg. Time Constraint Variability (i.e. If the user is pressed for time, how variable/susceptible is the set of CA's to being non-compliant)

Policy Statement Mapping to Services and Controls

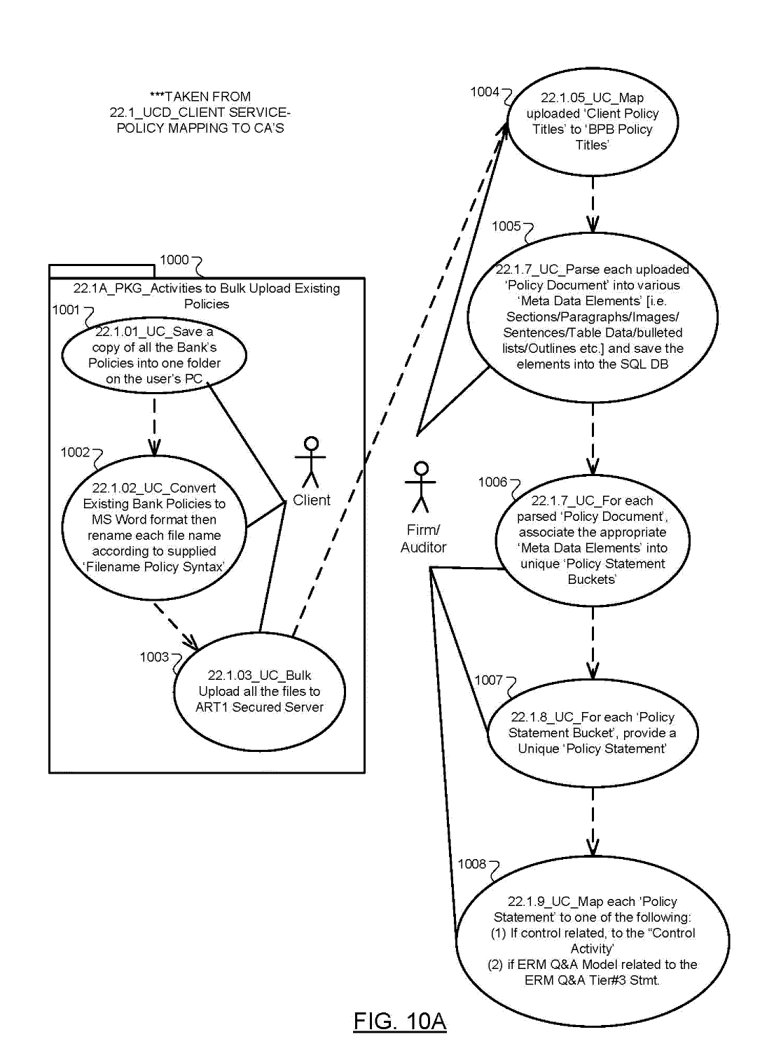

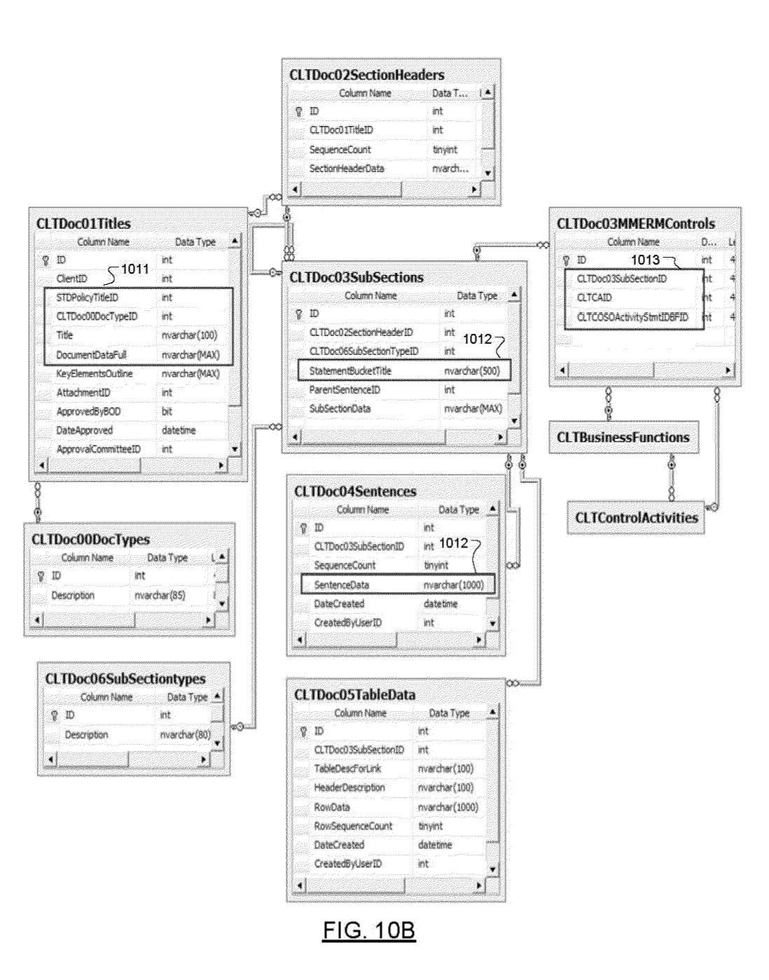

Depicted next in the drawing are the Policy Statement Mapping to Services and Controls modules, whose functionality is described further with respect to FIGS. 10A-C. Module 232 provides the capabilities for the mapping processes, and module 234 provides the assessment capabilities.

ERM Q&A Model

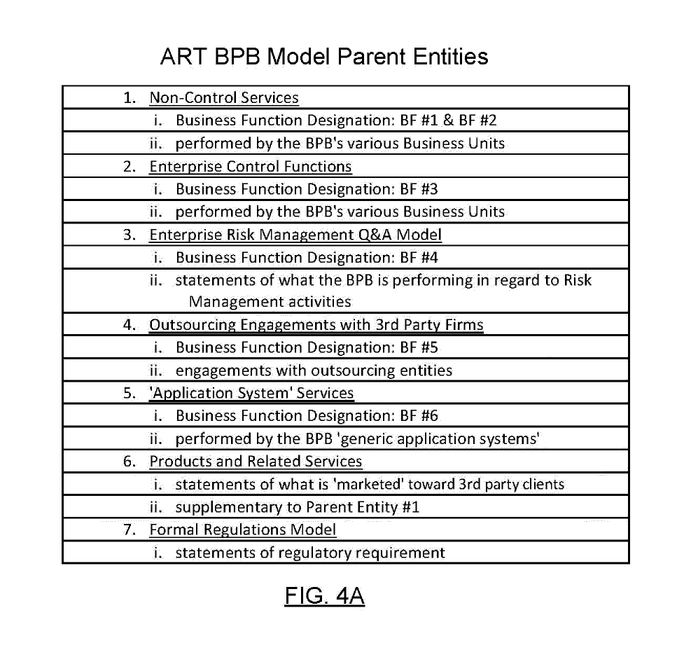

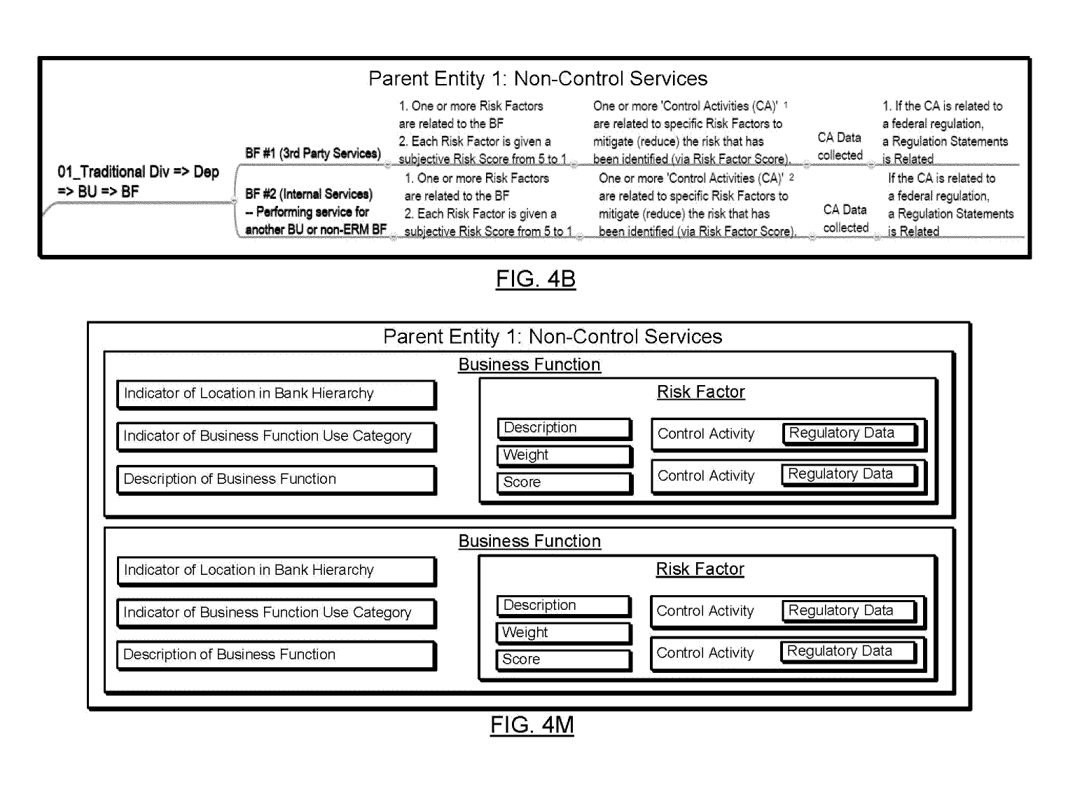

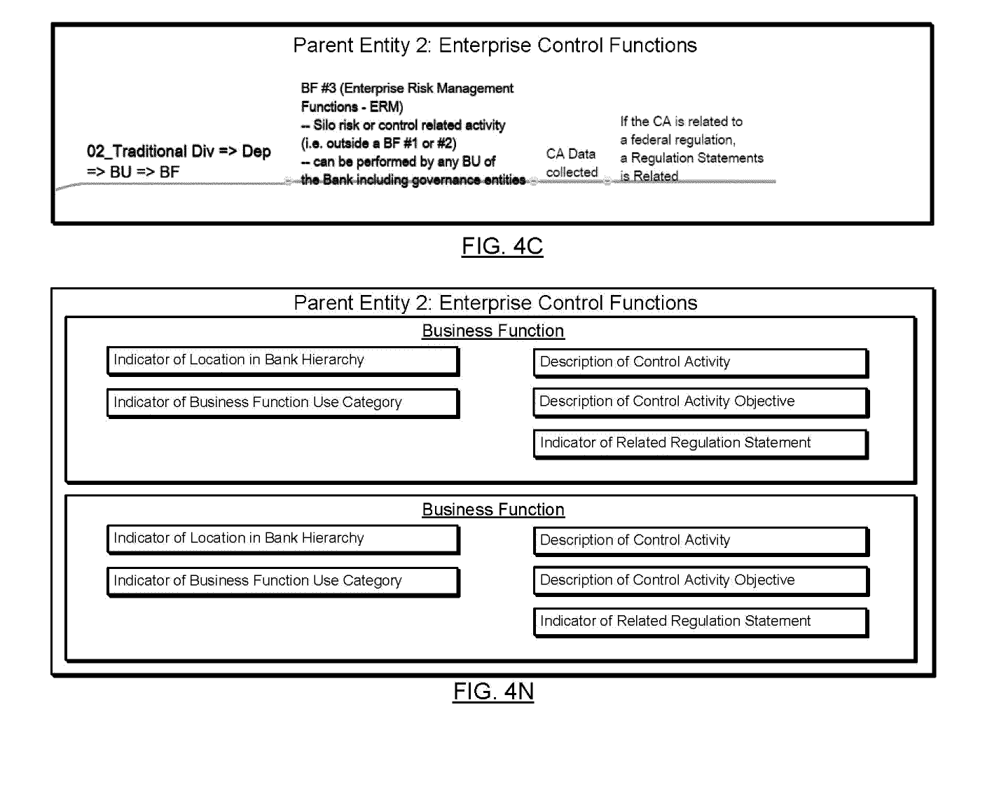

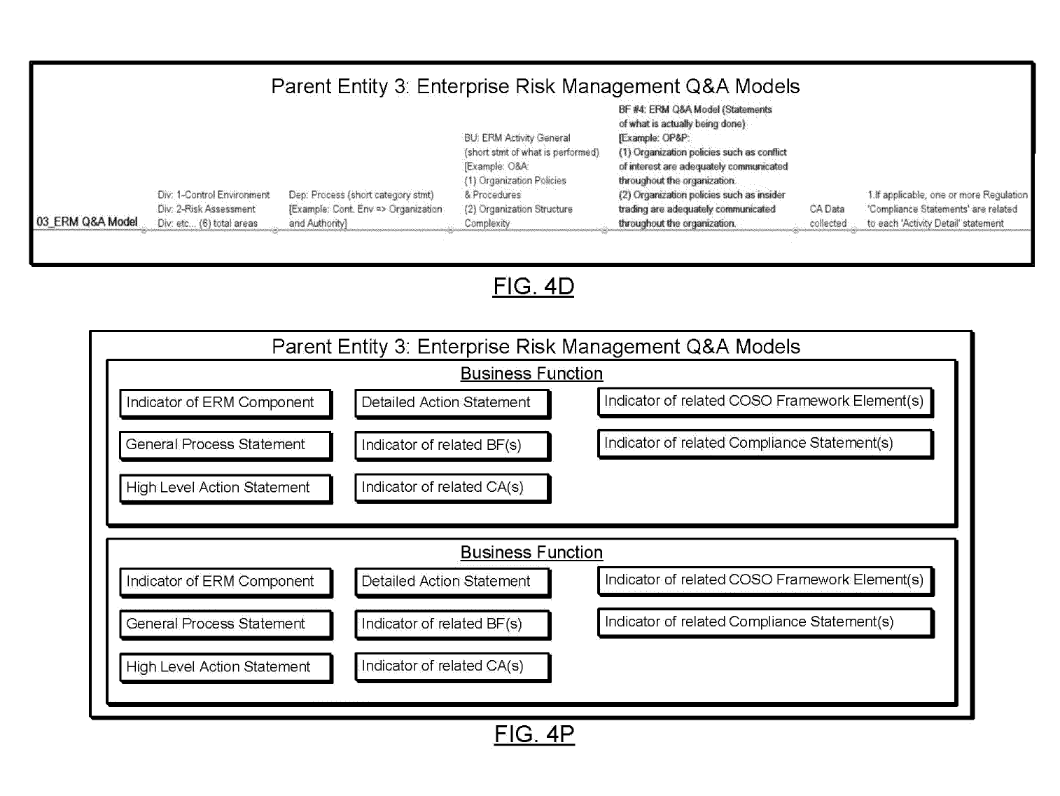

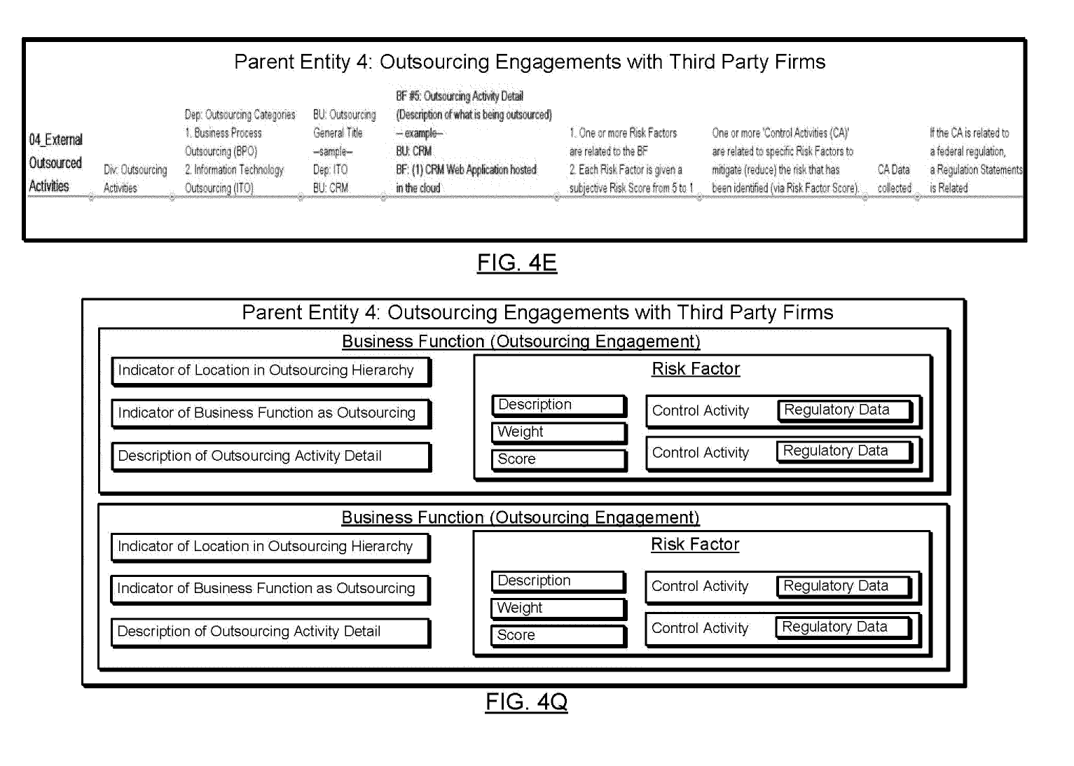

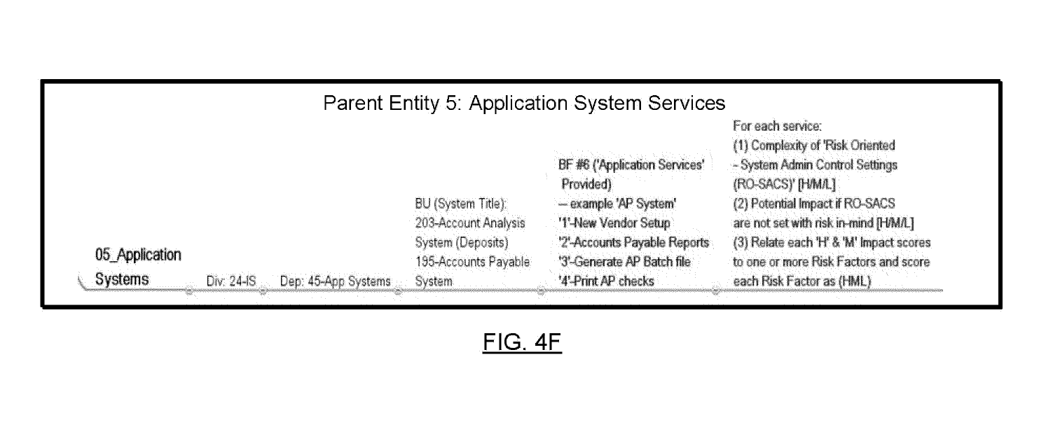

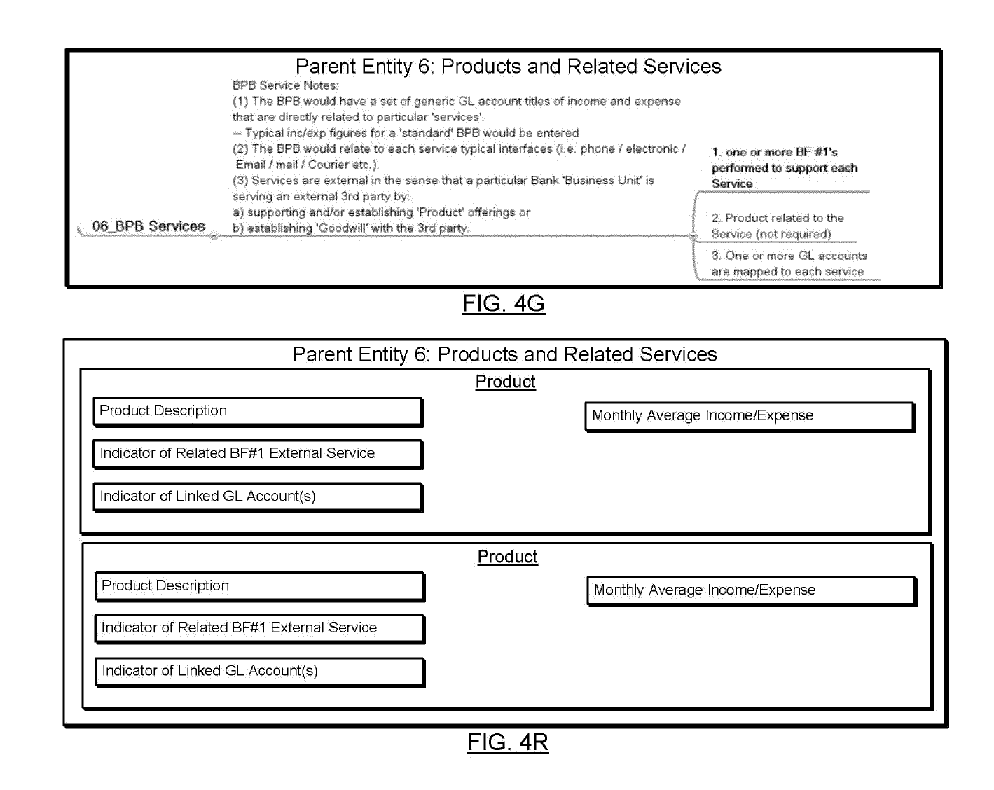

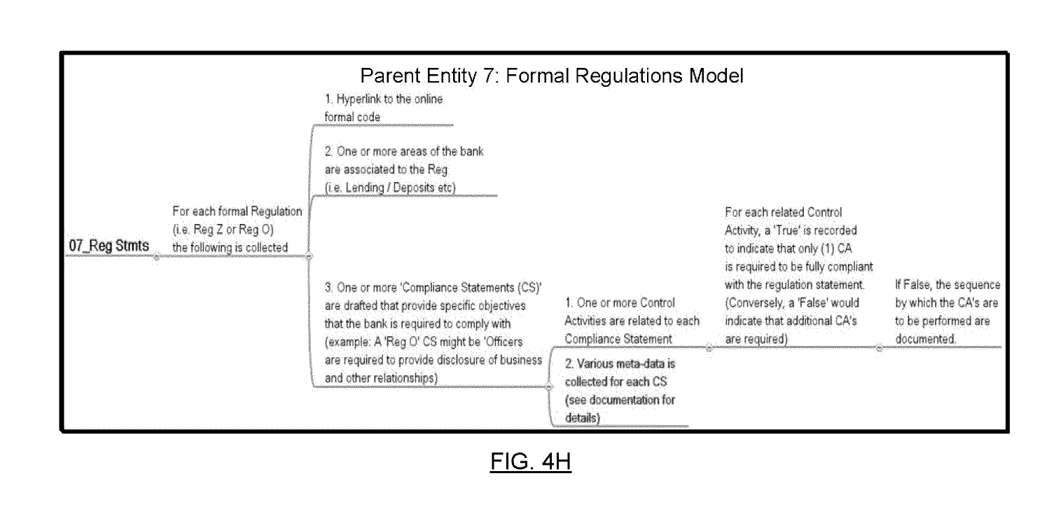

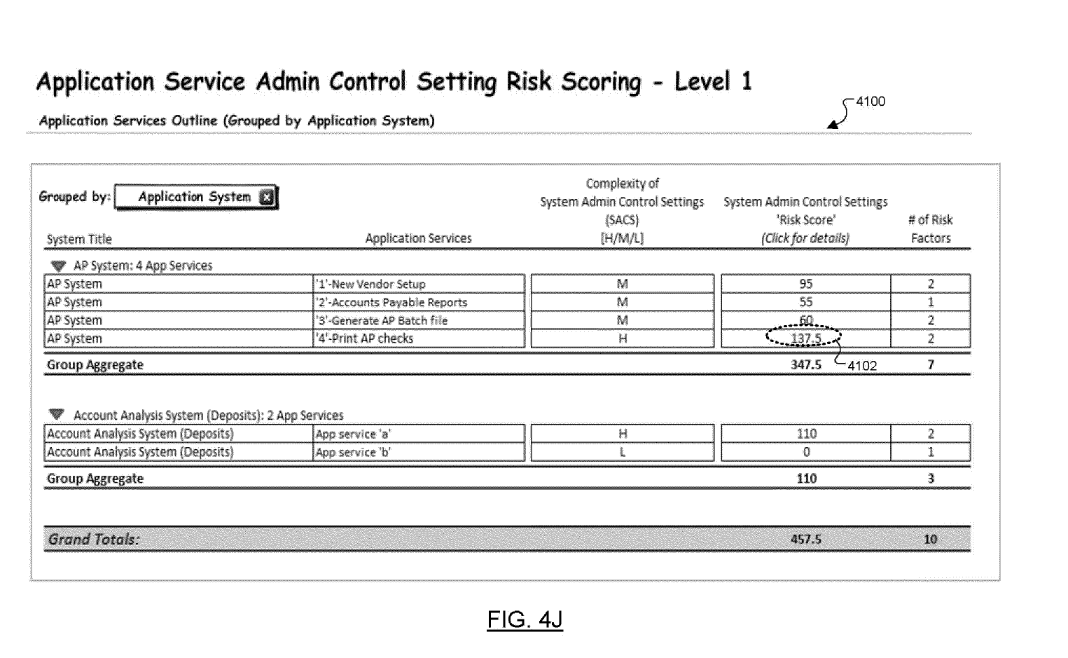

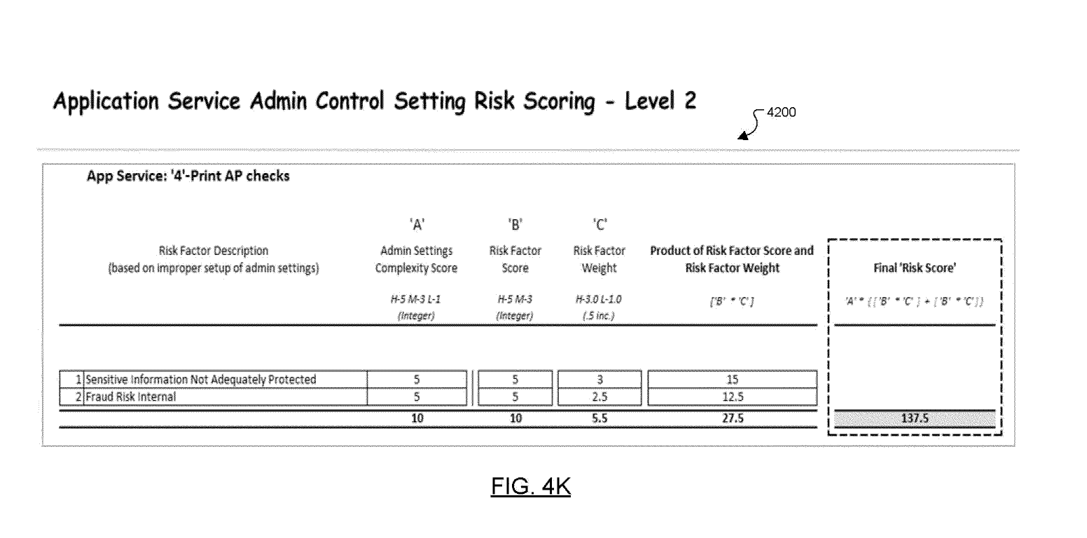

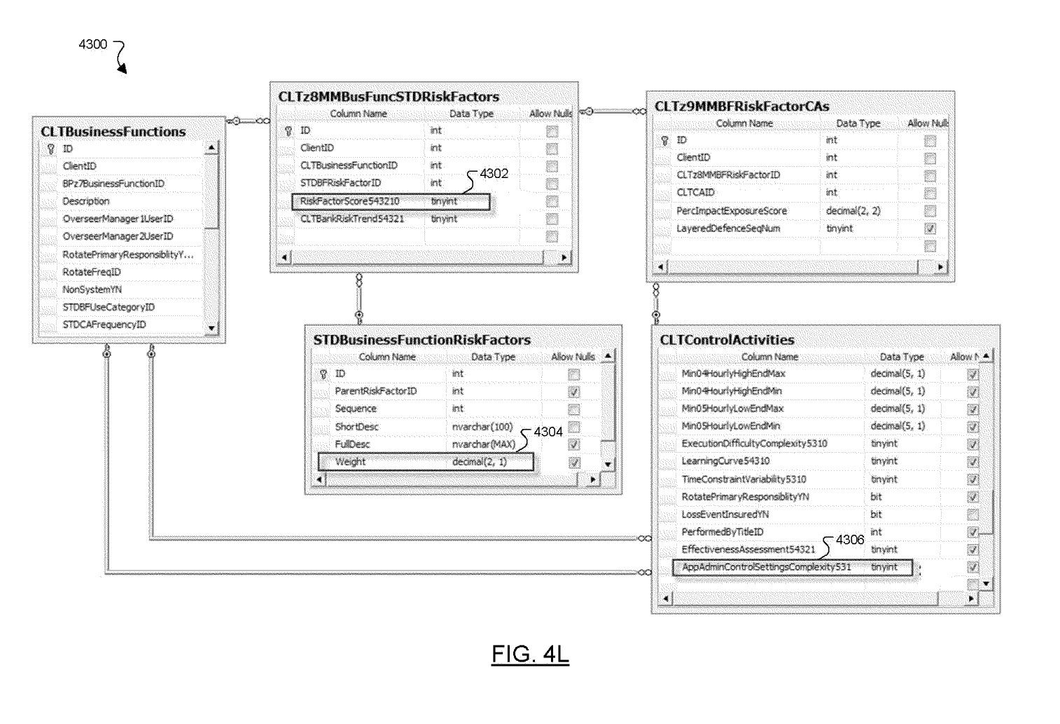

Depicted next in FIG. 2A are the ERM Q&A Model modules 236 and 238. The functionality provided by these modules is described in more detail below with respect to FIG. 4D. In general, the need for this service arises from the fact that governance entities of financial institution are burdened with the responsibility of obtaining reasonable assurance regarding the achievement of the following objectives: (1) Effectiveness and efficiency of operations, (2) Reliability of financial reporting, (3) Effectiveness of internal controls and (4) Compliance with applicable laws and regulations. This service, within the context of the ART system, helps guide the Bank in defining the Bank's Enterprise Risk Management posture which helps in achieving the above objectives. The value proposition for a Bank in executing the ERM Q&A Model is to provide management a list of ERM related principles that should be functioning within the Bank and give them a Best Practice ‘Detailed Action Statement’ of what management might consider implementing as a component of their ERM framework. Again, given the time and expense to perform, this service would normally only be performed by Clients that intend to utilize ART2 to help manage on a daily basis the results of this service.

This service is performed after the CA Gap Assessment has been finalized. The description and discussion of FIG. 4D provides a detailed discussion of how the model is implemented. Module 236 provides the capability for client data input, while module 238 provides the capability for report generation.

Deliverables to Client after Executing ERM Q&A Model:
a. ERM Statement Report
(1) What the Bank is performing against the COSO ERM Categories
(2) Direct links to the actual control structure that is supporting the statements.
b. Missing COSO ERM Statements—Gap Report
(1) Compared to the BPB model, what the Bank is NOT performing against the COSO ERM Categories as defined in the BPB model.

Best Practices Bank—Attributes

The last set of modules shown in FIG. 2A is the Best Practices Bank—Attributes modules, which provide ability to administer the BPB model within the ART1 application. Module 240 encompasses all the possible BPB Parent Entity infrastructure edits that might be performed by the audit firm. Examples of such edits include renaming, deleting, or adding the title descriptions for any of the (7) BPB Parent Entities. Regarding Module 242 titled ‘Regional Exam Scrutiny Admin’, it is common for Audit Firms, following a regulatory exam, to receive feedback from Bank Clients regarding what regulatory areas (i.e. Regulation Statements) were of ‘high focus/scrutiny’ during the exam. When a particular ‘auditor’ within the ‘Audit Firm’ receives the feedback from a particular Client or Colleague, the auditor uses Module 242 to log various data points into ART1. Examples of data-points include the individual who provided the feedback, where in terms of regional office did the examination team emanate from, and when was the feedback provided. Also, for each ‘High Regulatory Focus’ area, the auditor relates a particular ‘Parent Entity’ and what Service and/or related Control Activities were highly scrutinized. Module 244 titled ‘3.3_Misc Table Admin’ allows for various administrative duties toward the BPB including the following areas:

Generic Policy Title Admin

Regulatory Requirement Admin

Generic Strategic Obj BF Map Admin

Segregation of Duties BF Listing Admin

Rotation of Duties BF Listing Admin

Module 246 titled ‘23.1_Strategic Objectives—Input’ provides the client input and edit capabilities to define a listing of customary Board of Director sponsored ‘Strategic Bank Objectives (SBO's)’. For each SBO, ART utilizes Module 248 titled ‘Strategic Objectives—Map to Critical Parent Entities’ to relate one or more Control Activities to related strategic objectives based on the control's propensity to be stressed as the Bank moves toward achieving a particular objective. When a Control Activity Gap Assessment is performed, the client bank's objectives are mapped to these SBO's. Module 250 titled ‘Strategic Objectives—Report Generation’ allows the audit firm the ability to generate reports that outline the strategic objectives as well as their related control activities.

### ART2 Application Core Functionality

FIGS. 2B-C are a block diagram of certain software modules in the ART2 system, which, as discussed above, is preferably installed on the client bank's internal network. In general, the core construction of the ART2 application centers upon managing ‘Bank Initiatives’ (BI), which are internal business initiatives of the client bank. Typically, the bank uses a BI to create new controls to help the bank come into conformance with the BPB model recommendations provided by the control activity gap assessment process that is core to the ART1 system capabilities. BI's, generally, may be initiatives to establish control activities within the Bank but they also can be initiatives to generate revenue; such as a new product, service, or an initiative to change a particular aspect of an existing revenue generating process performed by the Bank.

Business Initiative Input

In a preferred embodiment, the BI is first created or entered in the ART2 application through the Business Initiatives Input group of modules, depicted in FIG. 2B. These modules allow Bank Initiatives to be initiated from one of four sources: (1) formal committees; (2) general employee ‘Ideation Page’; (3) audit report/exam findings issued from formal reports/exams; or (4) Best Practice Bank Change Log listing. Each of the (4) means of inputting, query the user in distinct ways to extract the appropriate information to provide a basis to assess the impact of the Bank Initiative. At another stage of the ‘Bank Initiative’ process, these initial statements are compiled by one or more appointed persons to input the ‘quantitative data’ (i.e. value and risk scores) associated with each Bank Initiative. All Bank Initiatives at this initial stage are ‘Potential’; in a sense, that the Bank has not made a final decision to implement the Initiative. The Safety and Soundness user documents 260 within ART2 include various aspects from the formal report or exam that provide clarity on where, what, when, and why the Bank Initiative is being submitted. This information will bring needed context for the BI Underwriters as outlined with respect to modules 268 and 270 below.

Module 262 comprises the web forms, or user interfaces, and associated run behind code provided by ART2 to provide any authorized ‘Meeting Admin’ of a particular meeting/committee an interface to input one or more ‘Bank Initiatives’ that originated from either a scheduled committee or a formal meeting. ART2 extracts from the user various aspects that provide clarity on where, what, when, and why the Bank Initiative is being submitted. This information will bring needed context for the BI Underwriters as outlined in the modules 268 and 270.

Module 264 comprises the web forms, or user interfaces, and associated run behind code provided by ART2 to provide authorized bank employees ability to input one or more ‘Bank Initiatives’ through an Employee Ideation Page and submit the BI for consideration by management. Preferably, employees are able to post anonymously. ART2 allows any employee of the Bank an interface to input a ‘Bank Initiative’. ART2 extracts from the user various aspects that provide clarity on what, when, and why the Bank Initiative is being submitted. This information will bring needed context for the BI Underwriters as outlined in the modules 268 and 270.

Still referring to module 264, ART2 provides ability for the bank to manage ideas that have been posted via the EMP Ideation Page. ART2 provides an interface for management to manage the following three aspects of submitted EMP ideas: (1) manage the ‘acceptance’ or ‘declination’ of submitted ideas via automatically generated event notifications and HTML email messaging templates. (2) for unique submissions, ART2 allows for the creation of a Discussion Forum (DF) where a team of users can be assembled to address how the Bank will handle ideas. Within the DF, team members can dialogue via team posts; and pose questions to the team via ‘Feedback Requests’. (3) manage the meta-data information that is associated with each ‘accepted’ EMP Idea. Information such as: (a) expected date of disbursement; (b) EOM addition to the ‘Accumulated Savings Bucket’; (c) Status changes to execute the distribution process. The EMP Ideation Page preferably uses a fully customizable ‘content management system (CMS)’, with which particular users of the Bank are given a fully customizable CMS to style and post content to the EMP Ideation Page. A particular section of ‘EMP Ideation Page’ titled ‘provides all employees the ability to review historical and current submitted ideas. Data points include:

i. Expected date of disbursement

ii. Accumulated $ in savings to the Bank; anticipated disbursement to ‘Submitting User’

iii. Encouraging comments from the ‘Employee Ideation Page Admin’

iv. Status of ‘EMP Ideation’

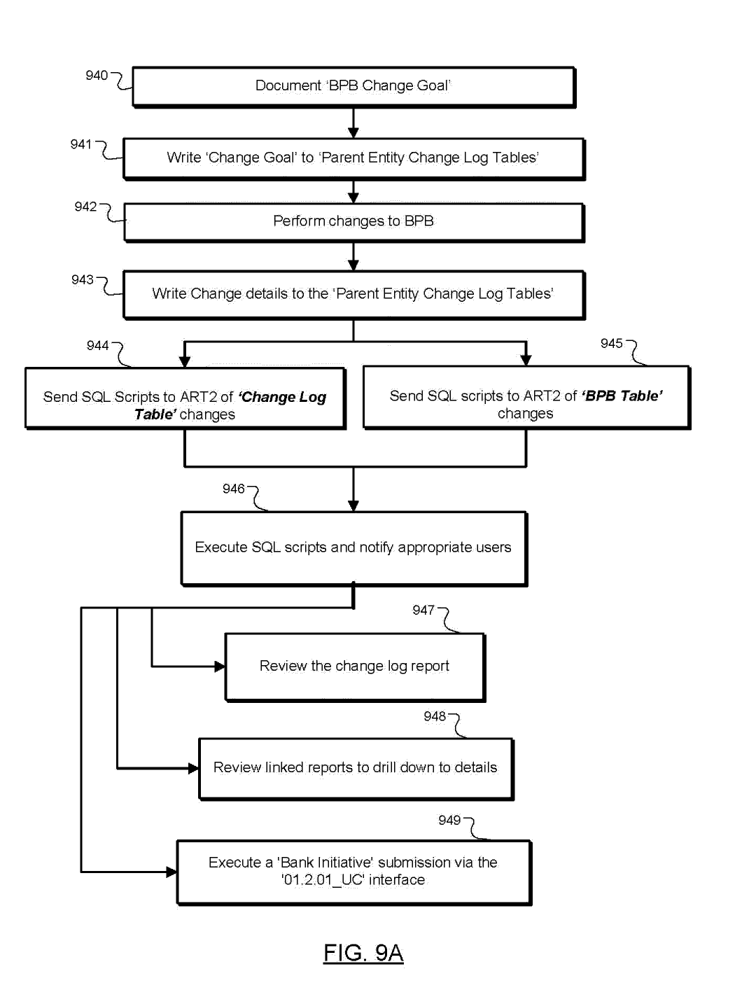

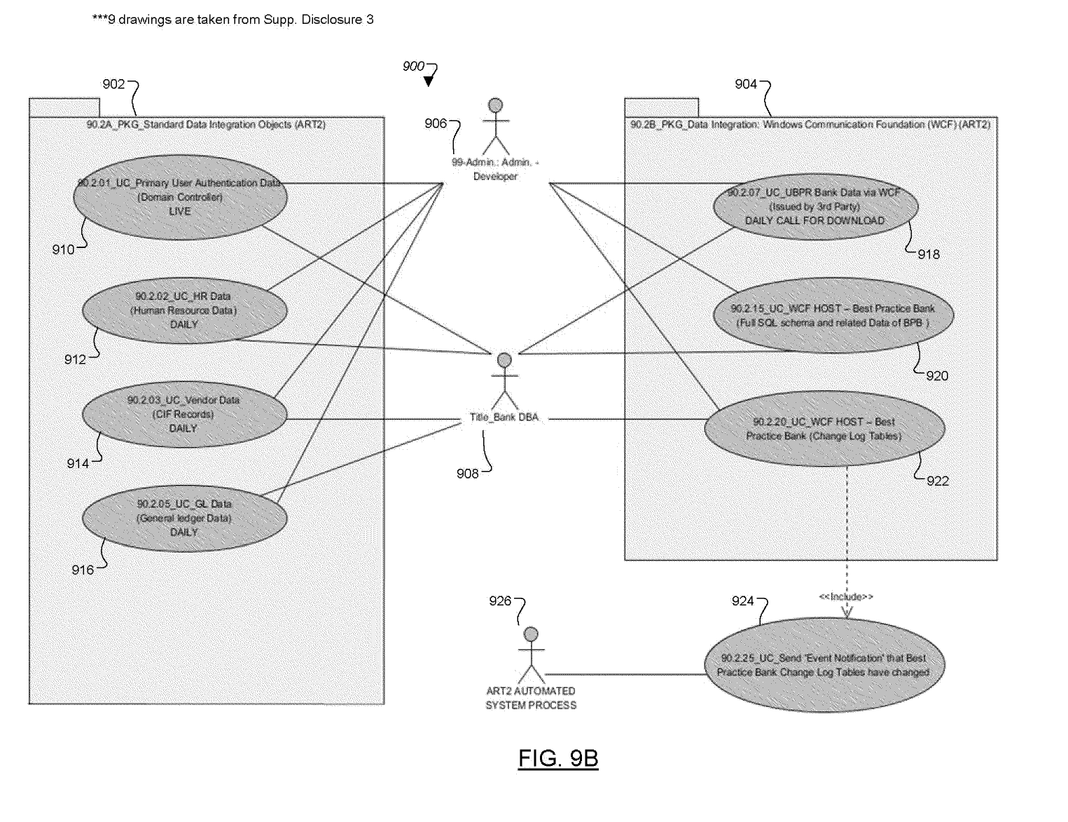

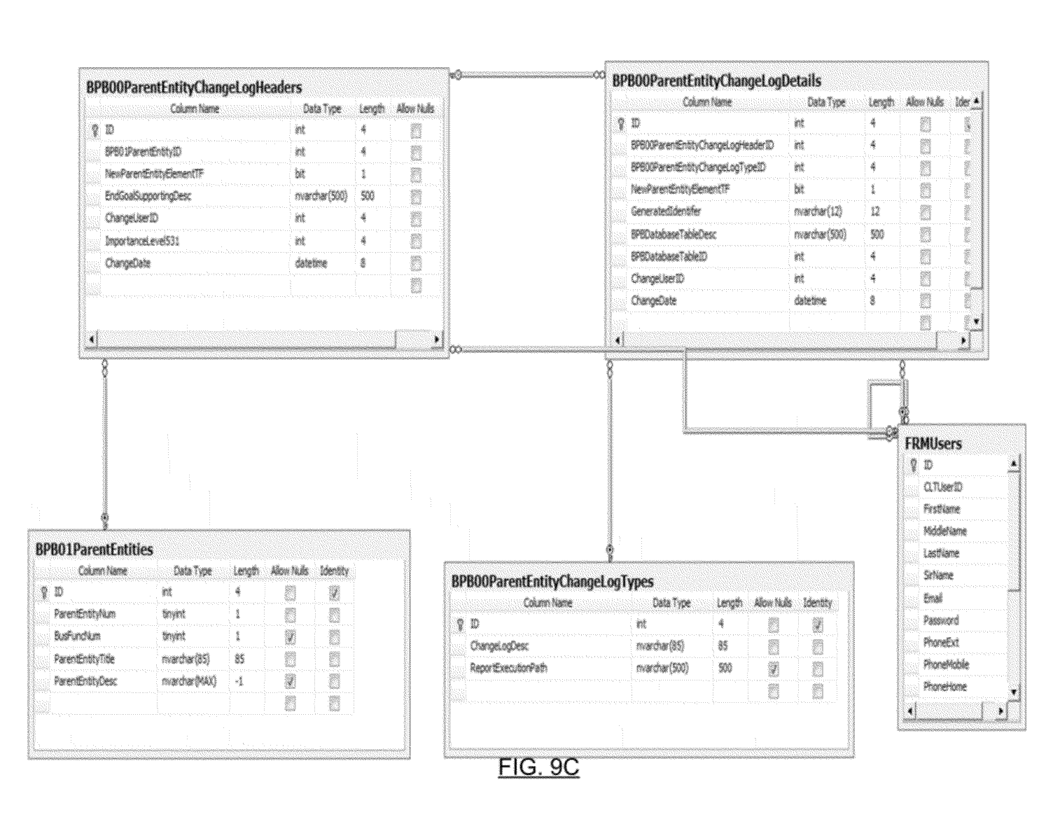

The final Business Initiative input method provided in this version of the ART2 system is the BPB Change Log input method, in which detailed information to create a new BI is extracted from the Best Practices Bank change log when updates are made to the BPB model. (The BPB change log is described in more detail with respect to FIGS. 9A-C.) Module 266 comprises the web forms, or user interfaces, and associated run behind code provided by ART2 to provide the functionality to create new BIs in the ART2 system based on the BPB change log. When a user executes use case ‘UC_Execute a ‘Bank Initiative’ submission’ (step 949, FIG. 9A), the user is taken to a Bank Initiative input interface. Various aspects are entered that provide clarity on what, when, and why the Bank Initiative is being submitted.

Business Initiative Underwriting

Still referring to FIG. 2B, the next depicted group of modules in the ART2 system is the Business Initiative Underwriting modules 268 and 270. Module 268, titled Create Expected Hierarchy and Controls, provides the ability to create the hierarchal infrastructure to support the potential Business Initiative, which represents the second phase in a preferred ‘BI Work Flow’. The building of the infrastructure is accomplished by an appointed user in the Bank and is summarized by the steps listed below: (Note that in the case that the potential BI does not require any new hierarchal infrastructure, this module is by-passed.)

i. Create Expected/Potential Hierarchy to the BF level (New Div→Dep→BU→BF)

ii. Associate Risk Factors to each ‘Potential’ BF and score Risk for each Risk Factor

iii. Associate one or more existing Control Activities to each Risk Factor

iv. Create one or more Control Activities for each Risk Factor

v. Relate one or more BPB controls to the subject BF

vi. Finalize the expected hierarchy and controls

vii. Review BPB for possible Control Activities

viii. Send ‘Event Notification’ to the ‘Business Initiative Risk Scoring Group’ that BI Expected Hierarchy is finalized.

In preferred embodiments, ART2 leverages the concept of mapping hierarchal structure from ART 1's Best Practice Bank. To assist the ‘BI Underwriter’ in creating the hierarchal infrastructure, ART2 provides access to the full hierarchal structure of ART1's Best Practice Bank. This hierarchy consists of: (1) the traditional hierarchy of ‘Division→Department→Business Unit→Business Function’; (2) the associated ‘Risk Factor’ infrastructure to each Business Function; and (3) any controls that are designed to mitigate the associated risk factors. The user can navigate through the Best Practice Bank and drag and drop any element from within the BPB hierarchy to any particular BI.

The next depicted module 270 is titled Score Various Aspects of BI. Module 270 comprises the web forms, or user interfaces, and associated run behind code provided by ART2 to provide the bank ability to assign score values to each BI. Regarding Bank Initiatives, the next phase after the general/high-level data is collected is to assign scores that will be used by ‘Bank Governance Entities’ to compare and contrast other Bank Initiatives. In a preferred version, each Bank Initiatives is assigned a ‘Residual Risk Impact Score’, an ‘Installation Cost’, ‘Operational Expenses’ and ‘Expected Revenue’.

‘Residual Risk Impact Score (RRIS)’ Context:

Residual Risk Impact Scores (RRIS) are assigned to the most granular and 4th level of the Bank's hierarchal infrastructure titled ‘Business Functions’. Within ART2, Business Function titles are high-level statements of services (both toward ‘internal personnel’ and toward ‘external 3rd parties’) rendered by either personnel within Business Units (the 3rd level of the hierarchal infrastructure) or by an ‘Application System’. Business Function titles are grammatically phrased as ‘wrapper statements’ that are action oriented; a level removed from a step-by-step process title/description. An example of a BF title is: Division: Loan Operations→Department: Lending→Business Units: Commercial Lending—Administration→Business Function: ‘Process new credit application—Commercial’.

It is possible that a particular Business Initiative does not reference or influence a Business Function as defined above; in this case, the Residual Risk Impact Score would be ‘0’. An example might be where a Business Initiative was originated by a formal audit report that recommended that a control function be implemented that had no relationship to a BF service title. However, when Bank Initiatives do reference or influence a BF service title or when the Bank Initiative is recommending that one or more new BF service titles be created, this impacts the ‘Bank Wide Risk Score’ either positively or negatively.

To summarize, the ‘Residual Risk Impact Score’ represents the anticipated change to the Bank Wide Residual Risk Score when a particular Bank Initiative is implemented. FIG. 6 and the accompanying description provide further details of how the RRIS score and the Bank Wide Residual Risk Score are produced in a preferred embodiment.

Bank Initiative ‘Installation Cost’, and an ‘Operational Cost’

The user will walk through the following prompted questions to determine the Implementation Cost:
(1) Determine In house—Hidden Labor costs (# of hrs):
   SR Officers (Hidden—i.e. divert attention toward project):
   Line officers (Hidden—i.e. divert attention toward project):
   Hourly Wage (Hidden—i.e. divert attention toward project):
(2) New Labor costs (# of hrs):
   Line officers (Expected Overtime):
   Hourly Wage (Hire new help):
(3) New FTE Hires:
Select one or more types: SR Officer/Line officer/Hrly wage
(4) Engage external firm to help:
   Existing Firm? If Yes, select Firm from DDL
   Anticipated engagement cost?
(5) New hardware:
   Capitalize?
If No, cost of hardware
If Yes, enter the appropriate data in the ‘Operational Expenses’ section
(6) New Software
   One time ‘Install Fee’?
   First year ‘License Fee’?
   Annual Maint/License fee?
Note: ART2 provides an option to defer this section to another user of the Bank

The user will walk through the following prompted questions to determine the forecasted ‘Operational Expenses’, which are preferably forecast for three years:
(1) After implementation, does this BI require ongoing expenditures outside of FTE labor to support its function?
   If Yes, document any that apply:
(1.1) Capitalized Hardware
   Amt?
   Yrs?
(1.2) Capitalized Software
   Amt?
   Yrs?
(1.3) External Firm Engagement for services?
   Y1 cost
   Y2 cost
   Y3 cost
(1.4) General Supplies?
   Y1 cost
   Y2 cost
   Y3 cost
(2) Given that ART2 determines the amount of time it takes for personnel to perform the associated Control Activities at the transactional level, does this BI require additional time in performing the BI according to the following groups? If Yes, enter the weekly avg time that will be spent for each group and provide basis and reasoning for the time allotment.
   a. Sr. Level officers weekly time/Description of time usage
   b. Line level officers weekly time/Description of time usage
   c. Hrly wage (High End) weekly time/Description of time usage
   d. Hrly wage (Low End) weekly time/Description of time usage

Bank Initiative ‘Expected Revenue’

The user will walk through the following prompted questions to determine the forecasted Revenues for the next three years:
(1) What is the item that is generating revenue?
   Type of Item (i.e. Loan Document/deposit account etc.)
(2) What is the anticipated annual revenue
   Year 1
   Year 2
   Year 3

Business Initiative Assessment

Still referring to FIG. 2B, the next depicted group of modules in the ART2 system is the Business Initiative Assessment modules 272, 274, and 276. Module 272, titled Business Initiative Stack Ranking, comprises the web forms, or user interfaces, and associated run behind code provided by ART2 to provide the bank ability to review Bank Initiatives and their corresponding details. Particular users of the Bank titled ‘Bank Initiative Staff (BIS)’ are provided access to an interface that allows each BIS user the ability to review Bank Initiatives. In a preferred embodiment, the Bank Initiative Stack Ranking functionality is accessed through a primary interface provided by module 272. The functionality of this ‘BI Primary Interface’ includes:
(1) BI's can be filtered against different ‘BI Status’:
Bank initiatives within ART2 move from a status of ‘Potential’, where the BI has not been approved for implementation; to the status of ‘Projected’, where the Bank Initiative has been committed to by the Bank but the related SOI Tasks (and corresponding ‘Target Dates’) have not been established by line level management; to the status of ‘Implemented’, where the BI has been implemented.
   The BI Stack Ranking interface allows authorized users the ability to view any one or all ‘BI Status’ status.
(2) BI's can be filtered against ‘Impact Categories’:
‘Impact Categories’ When Bank Initiatives are inputted into ART2, the initiative is placed in one or more ‘Impact Categories’ as follows:
   Reduce risk
   Reduces Expenses: Efficiency Gains
   Reduces Expenses: Lowers accounts payable spending
   New Revenue Channel (new product/service)
   Increase Existing Revenue Channel (i.e. product/service)
(3) BI's can be sorted and grouped by any of the following Column Headers:
Note: users can sort by a single column or by multiple columns
   BI Source: (1) formal committees; (2) general employee ‘Ideation Page’; (3) audit report/exam findings issued from formal reports/exams; or (4) Best Practice Bank Change Log listing
   BI Impact Categories: see above for listing
   Status: ‘Potential’, ‘Projected’, and ‘Implemented’
   BI Inception Date
   Residual Risk Impact Score
   Installation Cost
   Operational Expenses
   Expected Revenue
(4) Details of any BI can be reviewed by selecting the BI within the ‘BI Primary Interface’

What details that are available is dependent upon the user's authorization and the source of the BI.

Particular users of the Bank titled ‘Bank Initiative Staff (BIS)’ are authorized to an interface that allows the user to create a ‘BI Stack Rank Page’. The goal of creating a ‘BI Stack Rank Page’ is to:
(1) filter the full ‘Potential’ BI list down to a particular set of BI's; then
(2) ‘stack rank’ the set of BI's according to the originating user's preference; then
(3) provide comments (if warranted) as to why the ‘originating user’ stack ranked one BI above another; then
(4) send ‘action items’ with a particular target date via email and ART2's dashboard to one or more users requesting that they review the newly created ‘BI Stack Rank Page’ and order the list according to their preference.

The users that receive the ‘action item’ will click a hyperlink that will take them to the newly created ‘BI Stack Rank Page (SRP)’ that will allow for the following functionality:
(1) Details of any BI can be reviewed by selecting the BI . . . what details that are available is dependent upon the user's authorization and the source of the BI.
(2) Reorder the ‘stack ranked’ list according to the user's preferences by dragging and dropping the rows (rows in the table represent BI's) to the appropriate order; then
(3) Create a new comment thread (if warranted) under a particular BI as to why the user stack ranked one BI above another; or
(3.1) respond to any existing comment in a thread; then
(4) Save/Finalize the ‘Action Item’

A preferred embodiment also provides an interface for a ‘BI SRP Originator’ to manage outstanding ‘SRP's’. The purpose of creating a ‘BI Stack Rank Page’ is to get feedback from any number of users as to the Stack Ranking of a particular set of BI's. Within this interface, ART2 extracts the Stack Ranking selections and comments of each user that completed the ‘BI SRP—Action Item’ and provides ‘Cross Tab’ reporting on any number of variables to help the ‘BI SRP Originator’ determine which ‘Bank Initiatives’ are to be ‘Implemented’.

The next depicted module in FIG. 2B, module 274, is titled Manage Business Initiative Status, and comprises the web forms, or user interfaces, and associated run behind code provided by ART2 to provide the bank ability to review Bank Initiatives and their corresponding details. The modules gives particular users of the ‘Bank Initiative Staff (BIS)’ titled ‘BIS Decision Makers’ an interface to take a ‘Bank Initiative’ from the status of ‘Potential’ to ‘Declined’. ‘Declined’ status: one of the ‘BIS Decision Makers’ has elected to not move forward with the BI. The ‘BIS Decision Maker’ is required to provide reasoning for the declination and is able to upload any supporting documentation. From this interface, when the ‘BIS Decision Maker’ changes the status to ‘Declined’ the following events occur: Events after BI Status moves from Potential to Declined:

(1) A predetermined set of users are notified of the ‘Declination’ (various indicators effect whether the Declination Notice is sent, including: the BI's source and importance scores that have been related to the BI). The module also gives particular users of the ‘Bank Initiative Staff (BIS)’ titled ‘BIS Decision Makers’ an interface to take a ‘Bank Initiative’ from the status of ‘Potential’ to ‘Projected’. ‘Projected’ status: the Bank Initiative has been committed to by the Bank but the related SOI Tasks (and corresponding ‘Target Dates’) have not been established by line level management. From this interface, when the ‘BIS Decision Maker’ changes the status to ‘Projected’ the following events occur: Events after BI Status moves from Potential to Projected:
(1) The ‘BIS Decision Maker’ selects a ‘Formal Responder’ (see module 276 Formal Response Duties' for details on the responsibilities of the ‘Formal Responder’). Note: the ‘BIS Decision Maker’ can assign themselves as the formal responder.

The next depicted module in FIG. 2B, module 276, is titled Formal Response Duties, and comprises the web forms, or user interfaces, and associated run behind code provided by ART2 to provide the bank ability to manage and assign the formal response to Bank Initiatives. For all Audit/Exam Recommendations, the BIS staff is responsible to provide a formal response within a specified number of days. This number of days will contract or expand based on the importance/risk level assigned by the S&S staff. Normally, the ‘BIS Decision Makers’ will be changing a Bank Initiative ‘Status’ from ‘Potential’ to ‘Projected’ and in this case the module 278, BI Implementation—Formal Responder Duties' will provide the formal response.

Business Initiative Assessment

The next depicted group of modules in FIG. 2B is the Business Initiative Implementation group, modules 278, 280, and 282. This group of ART2 modules provides the interface and functionality to implement BIs within the client bank. The first of these modules is module 278, titled Formal Responder Duties, which comprises the web forms, or user interfaces, and associated run behind code provided by ART2 to provide the bank ability to manage the formal response to Bank Initiatives. The modules include an interface to Accept or Decline formal response assignments. When a BI status moves from ‘Potential’ to ‘Projected’ from within the module 274 ‘Manage BI Status’, the user who receives the request to perform the formal responder duties is titled a ‘Formal Responder’. The Formal Responder is typically someone with the following attributes: (1) a Senior Officer within the Bank; (2) comprehensive understanding/knowledge of the area of the Bank that the Business Initiative deals with. The Formal Responder has several Assignment Options:
(1) Decline the request by re-assigning the request to another user; a reason is required.
(1.1) The declining user's manager as well as the ‘BIS Decision Maker’ will receive notifications via dashboard; and via email (if particular variables are met).
(2) Accept the request.
(2.1) The accepting user's manager as well as the ‘BIS Decision Maker’ will receive notifications via dashboard.

The ‘Formal Responder’ is given a target-date to accept the Formal Responder Assignment. If the target-date elapses, then the ‘Formal Responder’ can extend the target-date (up to a pre-defined # of days ahead of the original target date). If the ‘Formal Responder’ fails to provide an acceptance or declination by the ‘extended target date’, then the Formal Responder's manager receives a detailed notification via dashboard and email of the tardy ‘action item’.

Module 278 also provides an interface to manage Formal Response Assignments. After a ‘Formal Responder’ accepts the ‘Formal Response Assignment’, the formal responder is required to perform the following initial duties.
(1) Document via a ‘rich text editor’ a Formal Response and provide an expected target date for the BI to be implemented; (Note: the Formal Response is intended to document in high level/abstract terms what the bank will accomplish.)
(2) Assign a Statement of Implementation Leader (SDI Leader); then
(3) Send SOI Leader ‘Request for Acceptance’; this ‘Finalizes’ the Formal Responder Assignment
(3.1) Upon sending the SOI Leader Assignment, the Formal Responder's manager as well as the ‘BIS Decision Maker’ will receive notifications via dashboard; and via email (if particular variables are met).

The ‘Formal Responder’ is given a target-date to ‘Finalize’ the Formal Responder Assignment. If the target-date elapses, then the ‘Formal Responder’ can extend the target-date (up to a pre-defined # of days ahead of the original target date). If the ‘Formal Responder’ fails to ‘Finalize’ by the ‘extended target date’, then the Formal Responder's manager receives a detailed notification via dashboard and email of the tardy ‘action item’. The Subsequent Duties of a ‘Formal Responder’ then include SOI Task Language Approval: Sign off on a list of SOI Tasks that the SOI Leader has asked for a “Language Approval”. The target date and SOI task language is provided at this step.

The next depicted module 280 is titled SOI Leader Duties, and provides an interface to Accept or Decline ‘Statement of Implementation Leader (SDI Leader)’ Assignments, and an interface to manage the Statement of Implementation Leader Assignment Duties. The user whom receives the assignment to perform the ‘Statement of Implementation Leader’ duties is titled an SOI Leader. The SOI Leader is typically someone with the following attributes: (1) Officer rank; (2) possesses management skills; (3) strong logistical and technical understanding/knowledge of the area of the Bank that the Business Initiative deals with. The accept/decline interface provides the SOI Leader Assignment Options:
(1) Decline the request by re-assigning the request to another user; a reason is required.
(1.1) Three users will receive a notification via dashboard and via email (if particular variables are met): (a) the declining user's manager; (b) the original ‘BIS Decision Maker’; and (3) the Formal Responder
(2) Accept the request.
(2.1) Three users will receive a notification via dashboard and via email (if particular variables are met): (1) the declining user's manager; (2) the original ‘BIS Decision Maker’, and (3) the Formal Responder

The ‘SOI Leader’ is given a target-date to accept the SOI Leader Assignment. If the target-date elapses, then the ‘SOI Leader’ can extend the target-date (up to a pre-defined # of days ahead of the original target date). If the ‘SOI Leader’ fails to provide an acceptance or declination by the ‘extended target date’, then the SOI Leader's manager receives a detailed notification via dashboard and email of the tardy ‘action item’.

Concerning the interface to manage the Statement of Implementation Leader Assignment Duties, after a ‘SOI Leader’ accepts the SOI Leader Assignment', the SOI Leader is required to perform the following initial duties:
(1) Draft one or more ‘Statements of Implementation (SOI-Task)’ toward each formal response (FR) and provide an expected target date for the SOI-Task to be implemented;
Note: the SOI-Task is intended to document in a precise manner what the bank will implement; the language should be styled in such a manner that it is clear when the SOI Task has been implemented. It also should be in an action/verb language and the scope of the SOI Task should be narrow enough to remove any dependence to other SOI Tasks. Therefore, it is encouraged that the SOI Leader establish multiple SOI Tasks to keep this independence.
(2) Send the SOI Tasks to the Formal Responder for their sign-off.
(3) Following ‘sign-off’ from the Formal Responder, assign SOI Team Members to each SOI Task
(4) Finalize the SOI Leader Duties
(4.1) Upon finalizing the SOI Leader Duties, the SOI Leader's manager as well as the Formal Responder, and the ‘BIS Decision Maker’ will receive notifications via dashboard; and via email (if particular variables are met).

The ‘SOI Leader’ is given a target-date to ‘Finalize’ the SOI Leader Assignment. If the target-date elapses, then the ‘SOI Leader’ can extend the target-date (up to a pre-defined # of days ahead of the original target date). If the ‘SOI Leader’ fails to ‘Finalize’ by the ‘extended target date’, then the SOI Leader's manager receives a detailed notification via dashboard and email of the tardy ‘action item’.

The next depicted module is 282, titled Implementation Forum Activities. This module provides a Review/Oversight Platform for Bank Initiative Implementation. The Implementation Forum has a Review/Oversight page that provides each user a unique top level listing of Bank Initiatives. Unique in that the scope of available BI's to review is based on the user's authorization level. ART2 provides granular access based on several variables: including title, rank, and BI. Once the list is populated for the user they can filter the list by Keyword, ‘Active’ or ‘Historical’.
LEVEL 1: From this top level listing the user can perform the following functionality:
   (1) Review various data-points regarding each Bank Initiative: (a) The Bank Initiative objective; (b) The overall BI target date; (c) # of SOI Tasks; (d) the SOI Leader; (e) the # of unanswered ‘Feedback Requests’; (f) if a formal ‘audit report’ or exam was the source of the BI, then the user would have a link to view the source report.
   (2) Select one of the BI Rows within the BI listing, allowing drill down to LEVEL 2 the ‘Manage SOI Tasks Page’
LEVEL 2: From the ‘Manage SOI Tasks Page’ the user can perform the following functionality:
   (1) Review additional information regarding the Bank Initiative: (a) The Bank Initiative objective; (b) details regarding the source of BI [i.e. who and when]; (c) if the BI originated from an audit report or exam, details regarding the recommendation/finding; (d) the formal response date drafted;
   (2) From a distinct section of the page, review all the recent ‘Progress Posts’ and ‘Feedback Requests’ that are related to this Bank Initiative. The information is provided in a tabular list with the posts being the rows and the columns headers as follows: (a) SOI Task #; (b) Type of Post; (c) Post Subject—Description; (d) Name—Title of the person whom posted; (e) # of Replies; (f) Feedback Request Satisfied (Y/N); (g) Date Posted
   (2.1) User is able to click any of the rows and go directly to the threaded discussion and reply or review the thread.
   (3) From yet another distinct section of the page, a listing of the SOI Tasks is provided in a tabular list with the SOI Tasks being the rows and the columns headers as follows: (a) SOI Description; (b) # of Un-answered Feedback Requests; (c) Due Date of SOI Task; (d) # of Workdays Including Today until Due Date; (e) Select one of the BI Rows within the BI listing, allowing drill down to the ‘Manage SOI Tasks Page’
   (3.1) User is able to click any particular SOI Tasks (i.e. row), allowing drill down to LEVEL 3 the ‘SOI Task Details Page’
LEVEL 3: From the ‘SOI Task Details Page’ the user can perform the following functionality:
   (1) Review additional information regarding the SOI Task: (a) The team members assigned to the SOI Task;
   (2) From a distinct section of the page, review all the recent ‘Progress Posts’ and ‘Feedback Requests’ that are related to this SOI Task. The information is provided in a tabular list with the posts being the rows and the columns headers as follows: (a) SOI Task #; (b) Type of Post; (c) Post Subject—Description; (d) Name—Title of the person whom posted; (e) # of Replies; (f) Feedback Request Satisfied (Y/N); (g) Date Posted
   (2.1) User is able to click any of the rows and go directly to the threaded discussion and reply or review the thread.
   (3) From yet another distinct section of the page, a listing ‘Actions’ are provided with hyperlinks titled as follows:
   (3a) New Progress Post: this link takes the user to a typical forum post entry screen where the user can post comments as general Info for team or personal or significant milestone toward implementation or a post indicating ‘Completion’ of the SOI Task;
   (3b) the next hyperlink title is a New Feedback Request: this link takes the user to a similar data entry screen as the ‘New Progress Post’ but here the user is able to post a question for the team.
   (3c) the final hyperlink title is a New Sub SOI Task(s): this link allows any team member to request a Sub SOI Task. It is used when an SOI Task needs to be further broken down. The user requesting the Sub SOI Task defines the SOI Sub Task objective, its target date and any team members. All the Sub SOI Task information is sent to the SOI Leader for sign-off before it is available to team members. The SOI Sub Task target date must fit within the target window of the parent SOI Task.

Module 282 also provides a Bank Initiative Implementation Forum—Collaboration Platform. Through this module, ART provides users an Implementation Forum (IF) where teams of users are created/assembled to address actionable implementation statements that came forth from Bank Initiatives. These teams are assembled by the SOI Leader within the module ‘04.2_BI Implement—SOI Leader Duties’. Within the IF, team members can perform the following:
(1) Dialogue via the IF with the SOI Team or SOI Sub Team via ‘General’ or ‘Milestone’ posts
(2) Pose questions to the team via ‘Feedback Requests;
(3) Create ‘Sub SOI Tasks’ to further break-down a particular SOI Task into more specific action steps. These ‘Sub Tasks’ have their own teams and are administrated within the timeline of their ‘Parent Task’.

Event Notification

Depicted next in FIG. 2B are three modules concerning event notification. The structure and function of these modules is described below organized by the unique title of each module.

### 05.1_Event Notification—Governance

a. Adverse Event Notifications (AEN)—Board of Directors/Executive Staff

ART2 allows for email messages to be sent external the Bank to appropriate users (i.e. Board members) notifying the users that a particular type of event (adverse) that has occurred toward Bank Initiatives. Language within the ‘notification email’ would be non-sensitive; however, an ‘SSL-hyperlink’ would be provided allowing the Board member the option to log-in to ART2 and review a full ‘Subscription Report’ to see the details of the adverse event.
i. Particular users have the ability to set various variables that limit the sending of the AEN. Examples of variables include: ‘Minimum Bank Initiative Risk Score’ or particular SOI Tasks that have tagged as ‘AEN Tasks’.
ii. A predefined set of authorized users (typically Executive and Safety and Soundness) would also receive AEN's but would receive a direct link within the email to view the ‘Subscription Report’ directly.

### 05.2_Event Notification—General

a. Bank Initiative—Event Driven Notifications (Bank Employees)

As particular pre-defined events occur during the implementation of Bank Initiatives, ART2 delivers to the appropriate Bank employee either ‘Action Items’ that a particular user is to perform or ‘Notifications’ of what transpired.

b. Notifications and Action Items Delivered Via Dashboard and Email Interface

Each ART2 user is provided a dashboard where the user can administrate ‘Action Items’ and review ‘Notifications’. Hyperlinks transport the user to the appropriate web pages.
i. Dashboard Content is segmented by importance level and ‘target dates’
ii. Particular ‘events’ trigger emails that provide textual details of the ‘event’ as well as hyperlinks that allow the user to interact with ART inside the Bank's trusted network as well as outside the bank via an ‘SSL-hyperlink’.

### 05.3_Event Notification—Subscriptions

a. Daily or Weekly Subscription Reports

ART2 allows for email message reminders to be sent to the appropriate users (i.e. Board members) notifying the users that activity has occurred toward a particular Bank Initiative. Language within the ‘notification email’ would be non-sensitive; however, an ‘SSL-hyperlink’ would be provided allowing the Board member the option to log-in to ART2 and review a full ‘Subscription Report’ to see the details of the events.
i. Users have the option to opt-out of receiving ‘Subscription Reports’; also, the user has the option to receive non-sensitive ‘daily’ or ‘weekly’ emails delivered to their inbox that provide ‘SSL-hyperlinks’ to detailed reports.
ii. Which users receive the ‘opt-out’ email is based upon various variables that limit the sending of the opt-out email. Variables are user specific (toward all officer ranks of Executive and higher) allowing granular minimum scores (Risk/Value) needed to trigger an ‘opt out’ email.
iii. Based on the Business Units impacted by any Bank Initiative, ‘Opt-out’ emails are sent to all ‘line level managers’ with a set of minimum scores (Risk/Value) needed to trigger the email.

Vendors

Depicted next in FIG. 2B are four modules labeled 06_Vendors which provide functionality for outside vendor management. The structure and function of these modules is described below organized by the unique title of each module.

06.1_Vendors—User Actions toward ‘Personal Vendors’
a. Officer functionality toward ‘Personal Vendors’

Within ART2, ‘Personal Vendors’ are vendors that users within the Bank have personally engaged for services or are in the process of engaging the vendor for services. Users with an ‘Officer’ rank are given the ability to perform the following within ART2's Vendor Platform:

Personal Vendor Options:
(1) Create a New ‘Personal Vendor’
(2) View ‘Personal Vendors’ in a List Format
(3) Edit Personal Vendor Group Titles
(4) Edit Contact Info for ‘Personal Vendor’
(5) Update VDDI Items for ‘Personal Vendors’
(6) Assign one or more User(s) to have edit authority
(7) Assign a ‘Personal Vendor’ to another Officer
(8) Request a new Vendor Category

### 06.2_Vendors—Annual Vendor Review Activities

a. Vendor ‘Annual Review’ Management

Banks are required to conduct annual vendor reviews of vendors that are assessed as critical because of the nature of information available to them and/or their role in providing critical 3^{rd} party services to the Bank.

The Bank (via the module ‘06.3_Vendors—Vendor Due Diligence Activities’) is able to define Vendor Category Groups and their associated ‘Vendor Categories’ that match the Bank's understanding of what is critical. Also within module 06.3, the compliance officer is able to determine which Vendor Categories are required ‘Annual Vendor Reviews’. Examples of possible Vendor Categories that would require annual vendor reviews are given in the following table:

TABLE 1
Vendor Categories Requiring Review

| | Vendor Category Group | Vendor Category |
|---|---|---|
| 1 | 01-Sensitive Information Handler | Physical Information Handler |
| | | (non-outsource) |
| 2 | 01-Sensitive Information Handler | Electronic Information Handler |
| | | (non-outsource) |
| 3 | 01-Sensitive Information Handler | Network Technician |
| 4 | 01-Sensitive Information Handler | Outsource - IT Services |
| | | (Information Handler) |

The next step is to have particular users (typically the compliance director) of the Bank relate ‘Active’ vendors to particular Vendor Categories. After the Bank's ‘active’ vendors are related to Vendor Categories, the following options are available to the Bank:

Annual Vendor Review Options:
(1) Assign responsible users per Vendor Category
(2) Assign ‘Renewal Window’ per each Vendor Category (i.e. annual/bi-annual etc.)
(3) Manage/assign the ‘Vendor Review’ target month
(4) User interface to review key Vendor Due Diligence items
(5) User interface to produce oversight reports that demonstrate compliance with the ‘Annual Vendor Review’ requirements
(6) List and sort all ‘Assigned’ Vendor Reviews and bulk re-assign to another user
(7) List and sort all ‘Assigned’ Vendor Reviews then re-assign target date by drag and drop and multi select; re-assigned target dates require the user to document the reasoning.
(8) List and sort all ‘Assigned’ Vendor Reviews then manage the vendor management requirements.

### 06.3_Vendors—Vendor Category and Vendor Due Diligence Activities

a. Vendor Category and Vendor Due Diligence Management

This module allows particular users (typically the Compliance Director) of the Bank the ability to manage the Vendor Category and the associated Vendor Due Diligence requirements for each Vendor Category.

A Vendor Category Interface is Provided that Allows Authorized Users to:
(1) Create/edit Vendor Categories
(2) Assign a ‘Risk Level’ (5-high to 1-low) for each Vendor Category
(3) Assign an ‘Annual Vendor Review’ Status (True/False).
(4) Assign ‘Annual Vendor Review’ Responsible User for each Vendor Category
(5) Copy Existing VDD Items (Only for empty Vendor Category) by importing a set of ‘Vendor Due Diligence Items (VDDI's)’ from an existing Vendor Category to a newly established Vendor Category. This helps in quickly associating a set of Vendor Due Diligence Items to a new Vendor Category.

A Vendor Due Diligence Interface is Provided that Allows Authorized Users to:
(1) Change Children of Vendor Category Parent: Add or remove Vendor Due Diligence items related to a given Vendor Category. Note: Any changes to the Vendor Due Diligence ‘set of items’ are automatically related to new vendors upon relating that new vendor to a particular Vendor Category.
(1.1) ART2 allows the user the option for changes to cascade toward any existing Vendors (i.e. vendors that are related to the Vendor Category being altered). Item Detailed Description
(2) Change Parents of VDDI Child: This interface allows the Compliance officer to manage from bottom up; i.e. starting with a VDD item and defining which Vendor Categories are related to it.
(2.1) Add a VDD item to a selected set of Vendor Categories. This will generate notifications (email and Dashboard) to the responsible personnel as defined at the Create/Edit VDD Items page. This will also change what VDD items are related to a newly created Vendor upon assigning a particular Vendor Category to a new vendor.
(2.2) Remove VDD item related to a selected set of Vendor Categories. This will not remove the VDDI item from the user's VDDI edit page but rather remove any ‘Action Items’ that have been assigned to personnel. Going forward, no newly created Vendors will have the VDD item assigned to a particular Vendor Category.
(3) Manage Due Diligence Items by performing the following:
   ‘Add’, ‘Edit’, ‘Bring out of inactive status’, and ‘Move to Inactive’
   Assign default Responsible User
   Assign ‘Response Window Max Days’ that defines when the Due Diligence item become past due.
   Define Renewal Period for when or if the VDDI is to be renewed (can be set to 0, indicating that the VDD Items is only required once)
   Risk (5-high 1-low)
   This interface allows the compliance officer to assess: (a) how many Vendors are related to each VDD item and; (b) how many Vendor Categories are related to each VDD item.

### 06.4_Vendors—Vendor Engagement Activities

a. Vendor Engagement Management

This module allows Officers of the Bank to compare key ‘Vendor Engagement Data Points’ for multiple vendors. The benefit of this is to document how and why the Bank chose a particular vendor over another.

The user would begin the comparison by selecting from a dropdown list a predefined ‘Personal Vendor Group’ or multi-selecting a set of vendors from the vendor data-base (Note: this latter option requires the appropriate credentials). After the vendor selection, the user is presented with a table layout the first column providing a list of Vendor Due Diligence items (aka ‘Vendor Variables’) with the successive columns being the particular vendors that were selected.

Data is displayed at the intersection, with hyperlinks and text boxes allowing the user to:
(1) drill down to details;
(2) Add/Update documents or text to any of the Variables
(2.1) Add supporting info at the footer of the page allowing the user to summarize the information and conclusions made.
(3) Manage the ‘completion status’ for each ‘Vendor Variable’
(4) Provide an Option to add an existing or new due diligence item/vendor variable
(5) Option to finalize the ‘engagement justification’ and export as a final PDF document. This finalized document would be on file for regulatory review.

Internal Audit Assessment

Depicted next in FIG. 2B are three modules labeled 07_Internal Audit Plan, which provide functionality for assessing the history of bank audits, and planning audits based on the assessment. The structure and function of these modules is described below organized by the unique title of each module.

### 07.1_Internal Audit Plan—Historical Audit Assessment Activities

a. Review and Export Various Reports on Audit Penetration

Following the completion of a ‘Historical Audit Mapping’ procedure, ART2 is able to assist in creating the Bank's comprehensive Audit Plan Matrix by providing appropriate information such as:
(1) Audit penetration toward key and critical controls;
   The list of un-audited controls are made evident (via an indicator) within the module ‘07.2’ when building the audit plan.
(2) Which non-key or non-critical control activities (entity wide and process/line level) have been audited;
   This list provides an opportunity to transfer resources to other controls. These items are made evident (via an indicator) within the module ‘07.2’ when building the audit plan.
(3) Audit coverage of High Scrutiny Regulatory Areas;
   During the initial ‘Control Activity Gap Assessment’ the client identifies particular ‘Regulation Statements’ that were given high levels of regulatory scrutiny. The reason for the scrutiny can be of ‘client origin’ or just shifts in regulatory exam practices. The date of the exam and regulatory body is recorded.
(4) Audit coverage of controls that are related to high ‘Regional Regulatory Focus Scores;
   It is common for Audit Firms, following a regulatory exam, to receive feedback from Bank Clients regarding what regulatory areas (i.e. Regulation Statements) were of ‘high focus/scrutiny’ during the exam. When a particular ‘auditor’ within the ‘Audit Firm’ receives the feedback from a particular Client or Colleague, the auditor logs what Regulations and their corresponding controls into ART1. This information is downloaded from ART1 to ART2 via WCF technology on a daily basis.
(5) Audit coverage of controls related to actual losses of the bank as documented at module ‘09.1_Loss Tracking—Input’. These items are made evident (via an indicator) within the module ‘07.2’ when building the audit plan.

### 07.2_Internal Audit Plan—Manage/Create Internal Audit Cycle

a. Manage the Bank's Audit Plan Matrix from a Control Activity Basis Vs. Audit Area Title Basis

(1) Build Audit Plan from Controls: ART2 allows the Safety and Soundness staff to develop a master Audit Plan Matrix from the Bank's ‘Control Activities’ up vs. ‘Audit Area Titles’ down. In other words, the various calendar quarters of the Bank's ‘Audit Plan Cycle’ are populated (via drag-and-drop functionality) by a pre-selected list of control activities (both Process and Entity Wide). The controls can be grouped by their Parent Entity risk meta-data (i.e. inherent risk scores). Then, after all the control activities are mapped to the ‘Audit Plan Cycle’, an interface is provided to group similar control activities and to give each group an ‘Audit Area Title’. This process assures a complete coverage of the key and critical controls of the Bank.

### 07.3_Internal Audit Plan—Manage Oversight Reporting Requirements

a. Produce Audit Schedule Status Reports for Board Committees or Examiners

ART2 provides the Safety and Soundness staff standardized reporting to bring clarity to the budget and status of the Bank's audit plan. It also allows for the exporting of an electronic XML file that provides the appropriate users drill-down reports to access the details of the various scheduled and historical audits. This is ideal to present to the Bank's regulatory agencies and external audit firms.

Compliance Audit Plan

Depicted next in FIG. 2B are three modules labeled 08_Compliance Audit Plan which provide functionality for managing audits to assure compliance with various federal and state regulations and standards. The structure and function of these modules is described below organized by the unique title of each module.

### 08.1_Compliance Audit Plan—Historical Audit Assessment Activities

The same functionality that is offered to the Internal Audit Plan module ‘07.1’ is provided to the Compliance Department.

### 08.2_Compliance Audit Plan—Manage/Create Internal Audit Cycle

The same functionality that is offered to the Internal Audit Plan module ‘07.2’ is provided to the Compliance Department.

### 08.3_Compliance Audit Plan—Manage Oversight Reporting Requirements

The same functionality that is offered to the Internal Audit Plan module ‘07.2’ is provided to the Compliance Department.

Loss Tracking

Depicted next in FIG. 2B are three modules labeled 09_Loss Tracking which provide functionality for documenting and tracking loss events within the bank. The structure and function of these modules is described below organized by the unique title of each module.

### 09.1_Loss Tracking—Input

a. Loss Event Tracking—Interface for Management at the Line Level to Enter ‘Short Form Loss Reports’

ART2 places the management of loss tracking upon the user titled ‘Risk Manager’; however, after loss events occur in the Bank, ART2 provides an interface for officers to assist the Risk Manager in documenting the appropriate ‘loss metrics’ after loss events occur. This interface is titled the ‘Short Form Loss Report (SF-LR)’.

The concept is that when the Bank determines that a loss event has occurred, there normally is a fair amount time and expense dealing with the after effects of the loss event and normally one officer in the Bank is quite familiar with the details of what transpired. The goal of the SF-LR is to bring efficiency in documenting loss metrics.

The following data-points are collected for each loss; which allows for reporting and trend analysis.

Metrics Requested Via the ‘Short Form Loss Report’:
(1) categorization of the Loss Events (user selects from a Drop-down-List or free-form ‘text box’)
(2) categorization of Loss Effects (user selects from a Drop-down-List or free-form ‘text box’)
(3) approximate time devoted to manage Loss Event
   The user is presented (4) user groups and is asked to document the ‘# of hours’ spent toward managing the loss event:
a. Sr. Level officers
b. Line level officers
c. Hrly wage (High End)
d. Hrly wage (Low End)
(4) if monetary losses are at issue, the ART2 prompts the users for the appropriate information (i.e. GL accts, amount, when etc.);
(4.1) the user is prompted for the amount and timing of any additional expected losses.
(4.2) the user is prompted for the amount and timing of any additional expected expenses to be incurred by the Bank.
(5) ART2 allows the user to identify one or more Business Functions and their corresponding CA's that led to the Loss Event due to control failures; and finally
(6) a rich text box is provided that allow for detailed explanation of the Loss and contributing factors.

### 09.2_Loss Tracking—Management

a. Loss Event Tracking—Interface for the Bank's Risk Manager to Manage Loss Events

ART2 provides an interface for the Bank's Risk Manager to manage Loss Events.
(1) Formalize newly submitted ‘Short Form Loss Report (SF-LR)’:
   After a ‘Short Form Loss Report (SF-LR)’ is filed within ART2 [see module 09.1 section ‘a’] the system issues an ‘action item’ to the Risk Manager via email notification and via the Risk Manager's dashboard. The purpose of formalizing the SF-LR is as follows:
   a. Allows the Risk Manager to underwrite the content of the SF-LR for accuracy
   b. Allows the Risk Manager to carry forward and edit the current loss info from the SF-LR;
   c. Allows the Risk Manager to carry forward and edit the ‘expected future losses’;
      If appropriate, the RM is able to document a ‘high’, ‘medium’, and ‘low’ expected loss and accompany these figures with each ‘probability of occurrence’.
   d. Associate the appropriate ‘tags’ to the Loss Event
      The concept of associating tags to a loss event is to aid Bank Officers. ART2 provides a set of tags that might be used but would also allow the RM to add ‘free form’ tags.
(2) Create a Discussion Forum:
   Risk Manger is able to invite one or more users into a ‘Discussion Forum’ from this interface.
(3) Close a particular Formalized Loss Event (i.e. removing all ‘expected future losses’)
   b. Loss Tracking—Interface for Authorized Users to Update ‘Formalized Loss Events’

ART2 provides an efficient interface for authorized users to quickly input cost and/or recent events regarding the Bank's ‘Active Formalized Loss Events’. By utilizing intuitive filtering techniques and edit forms, the goal of this interface is to minimize the time a user takes in performing the following meta-data objectives:
(1) Associate an expense with a ‘Formalized Loss Event’:
   This would be accomplished by the A-P Department or by particular Financial Officers that receive expense vouchers.
(2) Provide a ‘Recent Events’ update to a Loss Event:
   Any officer that is aware of the ‘Formalized Loss Event’ list can provide substantive updates.
(3) Log any ‘extraordinary’ officer time spent on a particular loss event:

### 09.3_Loss Tracking—Assessment

a. Loss Tracking—Reporting

Reporting is available to help governance entities assess various aspects of Loss Events as follows:
(1) Trend analysis on Monetary Cost of Loss Events (by category);
   Cost Component: Extraordinary Officer Time Spent
   Cost Component: Loss due to control failure (GL impact)
   Cost Component: Cost of legal expense
   Cost Component: Other expenses
(2) Analysis of ‘Reputation Loss Events’;
   Chart the total # of Reputation Loss Events per the Risk Manager's impact assessment (H/M/L)
   Chart the Risk Manager's ‘Reason Categorization’ for High and Medium ‘Impact Assessment’ events;
Note: the general goal of the loss tracking functionality is to identify trends and provide supporting details (i.e. which controls might be failing or which processes are weak etc).

Committees and Formal Meetings

Referring now to FIG. 2C, which continues the block diagram in FIG. 2B, depicted next are three modules labeled 12_Committees and Formal Meetings which provide functionality for documenting and tracking loss events within the bank. The structure and function of these modules is described below organized by the unique title of each module.

### 12.1_Committees and Formal Meetings—Manage Infrastructure (Who/What/Where/When)

a. Manage the Bank's Committee and Formal Meeting Schedule

ART2 allows the appropriate personnel the ability to document various aspects of the Bank's committee and formal meeting infrastructure.

ART2 Functionality Provided:
(1) ART2 roles assigned to manage infrastructure for each meeting and committee:
a. ‘Committee Chair’/‘Formal Meeting Chair’
   Note: only users provided the role of ‘Admin-Full Access’ can set up the chair users.
b. ‘Meeting Admin’ to administrate all aspects of the committee (void assigning the chair person)
   Note: the Committee Chair and Formal meeting chair is able to temporarily transfer their title to another user and they are able to manage who are the ‘Meeting Admins’ for their meeting/committee.
(2) Edit/Add ‘Committee Titles’/‘Formal Meeting Titles’
(3) Manage Committee Membership (add/remove users from committee or formal meeting)
(3.1) If a particular user is not found in the ART2 user listing, the ‘Meeting Admin’ can request a new user via the ‘New User Creation Short Form’
   Note: New User Process: Data required regarding the new user: (1) First and Last Name; (2) Title; and (3) Brief description of why the new user should be added. After submission, the user is immediately available and is given the appropriate ‘role’; a ‘Notification Event’ is sent via email to the submitting user's manager outlining the name and reasoning for the new user.
(4) Manage ‘Historical Meeting’ meta-data (when/who/upload supporting docs etc)
   Note: this interface allows for a Bank to back-fill prior meeting information for reporting purposes.

### 12.2_Committees and Formal Meetings—Manage Agenda and Documentation Access

a. Manage ‘Real Time/Next Meeting’ Admin—Committees and Formal Meetings

Meeting Administrators and Meeting Chairs are assigned via module ‘12.1’. ART2 gives these users the ability to perform the following:

Functionality Provided to the ‘Meeting Admin’/‘Meeting Chair’:
(1) Manage Future Meeting Meta-data:
   Date of meetings (for particular meetings)
   Edit Expected Agenda (for particular meetings)
   Edit expected attendees (for particular meetings)
   Upload pertinent docs (for particular meetings)
(2) Finalize the pre-meeting package of information provided to scheduled attendees:
   The ‘Meeting Chair’ or ‘Meeting Admin’ can send an email alerting the scheduled meeting attendees that a ‘pre-package’ for the meeting has been posted.
Pre-package notes: (1) Content of pre-package web page: ART2 builds a custom unique ‘SSL secure’ web page for each user that receives the ‘pre-package alerting email. The information on the page includes the when, where, and agenda items etc. The sending user would have the option to edit the content of the pre-package web page by adding comments or removing elements. Based on which documents have been uploaded, the sending user can select which user receives which documents. (2) Interaction with receiving user: ART2 builds a non-sensitive email alerting the user of the meeting title, time, and date. A link is provided in the email allowing the user to view the meeting agenda and supporting documentation via an SSL encrypted connection. The receiving user is also asked to click an ‘I will attend’ link or a ‘I will not attend’ link within the email; this allows the Meeting Admin to keep track of who has ‘confirmed’ that they will be at the meeting;
(3) Document meeting directives via module ‘01.2_BI Input—Committee or Formal Meeting’ ART2 provides any authorized ‘Meeting Admin’ of a particular meeting/committee an interface to input one or more ‘Bank Initiatives’ that originated from either a scheduled committee or a formal meeting. ART2 extracts from the user various aspects that provide clarity on where, what, when, and why the Bank Initiative is being submitted. This information will bring needed context for the BI Underwriters as outlined in the modules 268 and 270.

### 13.1_Audit Outsourcing—ART1 Audit Firm Engagement Activities

a. ART2 Interfaces with ART1 Providing Access to ART1's ‘Audit Services’

Depicted next in FIG. 2C is module 13.1_Audit Outsourcing—Audit Firm Engagement Activities, which provides the bank a set of ART2 interfaces with the Audit Firm that performed the initial Control Activity Gap Assessment to the Best Practice Bank. Particular ART2 authorized users would have access via an SSL secured web page on the Audit Firm's site that would present the full breadth of what could be audited by the Audit Firm as well as pricing and Audit Objectives.

The audit services would first be grouped by Audit Areas then by the details of the Business Functions to be audited. The content/information provided at this granular level allows the client to determine the value of the audit service; such as:
1) Audit Objectives
2) Estimated cost
3) Audit Sample size (if applicable)

The ART2 user is given the option to select (or de-select) any audit services; upon each selection of a service the page provides a total ‘Estimated Bid’.

The ART2 user would have the ability to ‘Save’ the selections for a later visit or ‘Export’ the Selections in a ‘PDF’ file.

### 14.1_Best Practice Bank Activities—Manage BPB Infrastructure Changes

a. Manage New Best Practice Bank Infrastructure Changes that have been Initiated by the ART1 Audit Firm

Finally in FIG. 2C is module 14.1_Best Practices Bank Activities—Manage BPB Infrastructure Changes. This module allows the audit firm to continually update their Best Practice Bank to mirror the ever changing risk and regulatory environment, and provides the client bank an interface to review, assess, and manage the BPB changes. The module provides the following functionality:
(1) Review the change log report:
   Authorized Users are able to review within the ART2 application the list of BPB changes. The changes are presented in a ‘nested/collapsible’ fashion within a table where the parent entity is the ART1 Auditors defined an ‘end goal’ justification for performing a particular ‘set of changes’. Also associated at this parent entity level is a subjective selection of the ‘BPB Change Importance Level’ of ‘High’, ‘Medium’, or ‘Low’.
   For each BPB change that is performed relative to the parent entity, the ART2 user is presented with a detailed listing of what was changed. Data points include: (1) Change Log Type—this is short descriptive title of what was performed; (2) New Element Identifier—‘TRUE’ indicates a new ‘element’ addition to the Parent or that it is a change to the existing BPB data points; (2.1) Active In Bank—An additional column is provided indicting whether the ‘New Element—Change’ is currently active in the ART2 client bank.
(2) Review linked reports to drill down to details:
   Each ‘Change Log Type’ is associated with an appropriate report that allows the ART2 user to see the changes in context with other BPB elements.
   This functionality allows the user to review in detail the BPB changed infrastructure.
(3) Execute a ‘Bank Initiative’ submission:
   The appropriate ART2 user is provided in the header row of the ‘Change Log Report’ a clickable ‘link button’ to start the process of creating a new ‘Bank Initiative’. This option would be executed when the user would like to move forward in adopting/implementing any or all aspects of a particular BPB change.
   After clicking the link button, the user is presented a bank Initiative ‘input template’ similar to that which is outlined in module ‘01.2_BI Input—Committee or Formal Meeting’. ART2 saves references to the particular ‘Change Log—Header ID’ within the ‘input template’. The user is able to provide a detailed description of the new Business Initiative. This description sets up the second phase in the ‘BI Work Flow’, namely, to create the hierarchal infrastructure to support the potential Business Initiative. See module ‘02.1_BI Underwrite—Create Expected Hierarchy and Controls’ for details on this second phase.

### Control Activity Gap Assessment (CA-GA)

FIG. 5A is a use-case block diagram of the CA-GA pre-assessment activity process performed by module 212 (FIG. 2A). The assessment is performed via a web browser interface through web forms presented by module 212. The personnel performing various steps or use-cases shown in the block diagram are connected with a line. As shown in step 502, the audit firm personnel 102 activate the client for a CA Gap Assessment. In this step the firm auditor goes to the appropriate System Menu activating a particular client for the CA Gap Assessment. This action causes the following client users to be defined and given a User Role to display the appropriate documents to be managed (i.e. filled out or uploaded). This User Role gives the client users a Dashboard Menu Item allowing the Client to navigate to the page and see the list of documents that need to be managed. The client bank personnel are given log-in credentials to perform various aspects of the assessment (i.e. Download templates/Upload documentation etc).

Next in the use-case at step 504, the appropriate client bank personnel upload or input required documentation to capture client bank personnel that will be involved in the CA-GA process such as (1) key client bank personnel names and email addresses that will be involved in the CA-GA and (2) various supplemental background information to establish a baseline. Examples of background information include verifying active Application Systems and Product/Service Offerings. In a preferred version, at this step the client user clicks a Dashboard Menu Item allowing the Client to navigate to the page and see the list of documents and information requests that need to be managed. The client user performs one of the following for each required item/document: a) downloads an excel template to be filled out then ‘upon completion’ uploaded to ART1; b) Walks thru Data Entry Wizards as indicated by the web forms; or c) verifies functioning/active elements or activities via multi-select web form controls or via drag and drop functionality. Upon completing the required items/documents, a notification is sent to the firm auditor that the documents are finalized. At the use-case depicted at step 506, the firm auditor 102 converts and processes Data from the various documents. Any missing data is collected from the Client.

FIG. 5B is a use-case block diagram of certain CA-GA assessment data gathering activity process performed by module 214, and in particular the activities for gathering data to describe the various business functions active at the client bank. At the use-case in step 508, the client bank's hierarchical structure is mapped. The firm auditor 102 and client personnel contribute to this process as depicted on the diagram. Such functionality is preferably performed through an application interface presenting web forms for the client and firm auditor to perform the following.
1. Map over from the Best Practice Bank ‘Business Units’ that are active within the client Bank.
2. Reorganize, rename, and add the client bank hierarchy in the hierarchical structure employed by the BPB hypothetical model used herein (Division→Department→Business Unit). This step allows the client to have their bank mapped and titled to mirror their current title phrasing/language from ‘Division’ thru ‘Business Unit’.
   The functionality to accomplish such steps is further described with respect to FIGS. 5D-H. Next, the process in FIG. 5B proceeds to the use case in step 509, where the ART1 application presents web forms providing an Application Interface where the client and firm auditor map over from the Best Practice Bank ‘Outsourcing Arrangements’ that are active within the client Bank. At step 510, web forms through which the client and firm auditor Rename or Add ‘Outsourcing Arrangement’ titles. This step allows the client to have their Outsourcing arrangements mapped and titled to mirror their current title phrasing/language. If the BPB does not have the appropriate outsourcing arrangement titles to choose from, the firm auditor is given an ‘Action Task’ of assigning a set of Risk Factors and appropriate Control Activities to the new client originated ‘Outsourcing Arrangement Title’ at step 511. Step 512 adds the new outsourcing arrangement to the BPB model.

The process at step 513 next involves module 214 presenting Application Interface where client and firm auditor perform the following via one or more specific User Interfaces:
1. One or more ‘Strategic Objective(s)’ are selected from a typical list of ‘Strategic Objective(s)’ (via the Table View).
2. After saving the selections:

a. One or more Client defined ‘Strategic Objective(s)’ can be added the list

b. The list is then edited to reflect the verbiage that the Client would prefer.
3. For each ‘Strategic Objective’ the following is obtained:

a. One or more ‘Responsible Client Users’ are assigned to help implement.

b. The ‘Event or Decision Forum’ is determined
i. If via a ‘Bank Committee’, the appropriate pre-defined ‘Bank Committee’ is selected.

c. The Date the ‘Strategic Objective’ was originated is recorded.

d. The current target date for implementation is recorded:
i. If the original target date has elapsed, this date is also recorded
ii. If Client would like to establish a target Date, an interface is provided to accomplish this.

At step 514, the process identifies departmental risk managers. Module 214 here presents an Application Interface where client and firm auditor associate, for each department in the Bank, one or more Client Users that have been assigned the responsibility to manage/oversee the risk at the department level. The user interface content for his functionality preferably includes a Left Panel with a treeview list of Departments sorted by Division (Division title concatenated by appending to Department title). On the Right Panel in this view is a treeview list of Sr. Officers and a dropdown list (DDL) or other selection input that defaults to Officer rank of ‘SVP and above’. The DDL allows for users to lower the rank to include more officers. The User multi selects the Departments and drags them to the appropriate ‘Officer Name’, then saves the information.

A similar use case is carried out at step 515 to identify the business unit line level Risk Operators for each client bank business unit entered. Specifically, at step 515 the module 214 presents an Application Interface where client and firm auditor enter data for each Business Unit in the bank associating one or more Client Users that have been assigned the responsibility to manage/oversee the risk at the Business Unit level. The User Interface content for this function is summarized below.

### UI Content:

i. Left Panel: Treeview list of Division, then Department, then Business Unit (BU)
   1. Sorted by Division
   2. Defaults to fully expanded
   3. BU's multi selectable
ii. Right Panel: Treeview list of Officers
   1. DDL that allows the users to select a department to view the officers in that department

### Action:

i. User multi selects the BU's and drags them to the appropriate ‘Officer Name’
ii. Click Save

The process then, at step 516, sets up executive and line level risk managers with dual authentication credentials, enabling them to participate in the assessment process for their respective business functions. This step may involve a third party vendor. Next at step 517, the line level managers work with the firm auditors to select business functions from the BPB bank model that are presently active at the client bank. Note that the only Business Functions that are selected here are the ‘Non-control’ Service BF's (i.e. NonCA-BF3rd & NonCA-BFInt). The User Interface content for this function is summarized below.

### UI Steps:

1. Given that the user is a Client-Line Level Risk Manager only the BU's as defined in 02.2.07_UC_Identify Business Unit Line Level ‘Risk Operators’ are presented to the Client-Line Level Risk Manager
2. A tabled grid displays a hierarchal listing of BU→BF where each of the BF's (2nd layer of hierarchy are presented with a ‘selected’ checkbox.)
3. User goes through the BF listing un-selecting the BF's that do not pertain to the client's bank.
   a. Here the Client and Firm Auditor together are de-selecting only the business functions that do not have any similarity to what is being performed.
   b. Any BF description that somewhat describes what is being performed should be left checked. In steps to follow, the user will have the opportunity to alter the BF description to mirror the client Bank's activities.

Still referring to FIG. 5B, now at step 518, the line level risk manager is provided ability to select the Active Business Functions at the client bank, which fall under risk management control activities, from the BPB model. Note: the only Business Functions that are selected here are the Risk management control BF's (i.e. EntWide-CS BF's). The User Interface content for this function is summarized below.

### UI Steps:

1. Given that the user is a Client-Line Level Risk Manager only the BU's as defined in 02.2.07_UC_Identify Business Unit Line Level ‘Risk Operators’ are presented to the Client-Line Level Risk Manager
2. A tabled grid displays a hierarchal listing of BU→BF where each of the BF's (2nd layer of hierarchy are presented with a ‘selected’ checkbox.)
3. User goes through the BF listing un-selecting the BF's that do not pertain to the client's bank.
   a. Here the Client and Firm Auditor together are de-selecting only the business functions that do not have any similarity to what is being performed.
   b. Any BF description that somewhat describes what is being performed should be left checked. In steps to follow, the user will have the opportunity to alter the BF description to mirror the client Bank's activities.

The process then requires the audit firm personnel 102 to review at step 519 to confirm that the entered functions are properly mapped to the BPB model. Preferably, at this step the user is presented with one ‘TreeView’ and using this view is able to reorganize the client hierarchy (Departments→Business Units→Business Functions) by drag and drop BF's under the appropriate BU. The User Interface content for this function is summarized below.

### UI Content:

1. One master Panel: Treeview list of Division, then Dep, then BU, then BF

a. Defaults to fully collapsed

b. only BF's are multi selectable

2. User multi selects the BF's and drags them under the appropriate BU

### 3. Click Save

At step 520, the process allows the line level risk manager 105 or audit personnel to, based on the selected Business Function(s) from the BPB that are currently functioning, change the existing description to more closely match the Client's environment. The user at this step is also provided the option to add a Business Function to one or more Business Unit(s). The User Interface content for this function is summarized below.
1. User is presented with a ‘tabbed’ page allowing the User to review any one of the (2) categories (BU/BF) by clicking the corresponding tab.
   a. Note: only the BU's that this user manages based on the user assignments are available.
2. After arriving at the appropriate tab the user can (edit the language and/or add a new BF or BU title).
   a. If a new BF or BU title is added, the user is required to relate the appropriate parent to the new children elements.
3. After new hierarchal elements (i.e. BU or BF) are added, the User is presented a linkbutton to go back to 02.2.09c_UC_Reorganize the Client Hierarchy (Departments→Business Units→Business Functions) to reorganize the structure as appropriate. This is preferably accomplished through an ART1 web form interface such as that shown in FIG. 5G and FIG. 5H, which show example web form interfaces through which a user may edit and add business units and divisions

At step 521, the process allows the line level risk manager 105 to assign business function user responsibilities for each Business Unit to various client bank users. Preferably the system allows a ‘Batch Assign’ (within each Business Unit) process to map particular Client users to the appropriate set of Business Function User Responsibilities, and also to identify which Business Function User Responsibilities are rotated amongst the Client users and at what frequency. The User Interface content for this function is summarized below.

### Batch Assignment:

1. Select a Business Unit where Business Function User Responsibilities have not been assigned. Note: The number of BF's to be processed are shown in the drop down list. After all the BF's in a particular BU are assigned responsible users, the number is brought to ‘0’.
2. After a BU is selected, select via Drop Down List which ‘Assignment Types’ you are assigning:
   a. ‘Overseer’ (i.e. manager over the BF),
   b. ‘Primary’ (i.e. Client users whom have been given the duty of performing the BF), or
   c. ‘Back-up’ (i.e. Client users that are cross trained to perform if the ‘Overseer’ and/or ‘Primary’ is not available).
3. Next, select one or more users that you would like to ‘Batch Assign.’ Note: if the client user is assigning the ‘Overseer’ role, it would be rare that more than one client user is selected; max available selections for an ‘Overseer’ role is 2.
4. Select one or more BF's that the selected client users perform.
5. Repeat Steps 1 thru 4 until the full complement of ‘Assignment Types (i.e. Overseer etc)’ have been worked. Notes: (1) There must be an ‘Overseer’ and at least (1) primary; (2) it is possible that the ‘Overseer’ is also the ‘Primary’, (3) ‘Back-up’ assignments are optional.

Rotation of Responsibilities:
1. Select a Business Unit where the Rotation of Business Function Responsibilities have not been assigned. Note: The number of BF's to be processed are shown in the drop down list. After all the rotation schedules in a particular BU are assigned, the number is brought to ‘0’.
2. After the BU is selected, a list of BF's are presented in a table form with the following attributes available to select:
   a. Header: Rotate Primary Responsibility?—A set of Check boxes (one true and the other false) that defaults to ‘False’.
   b. If ‘True’ is selected, then a dropdown list is presented for the user to select the frequency of the rotation (i.e. Daily, Weekly etc).
3. Repeat steps 1 thru 2 until all ‘rotation schedules’ have been assigned.
4. Click the ‘Finalize’ button.

FIG. 5C is a use-case block diagram of further CA-GA assessment activity performed by module 214 to document client bank control activities (CA) for the client bank's various business functions. The process generally takes place after that in FIG. 5B, and starts at step 532. Again with regard to this process, the CA-GA module with its associated web forms preferably performs this functionality. In this step 532, the application interface presents web forms where client line level risk manager 105, the typical user for this functionality, is able to map the control activities functioning in the bank to control activities in the BPB model bank, by performing the following via specific User Interface(s):
1. User signs into ART
2. User navigates to the System Menu allowing them only and exclusively to view a presentation of the Bank's Business Units that they have been assigned as a ‘Line Level Risk Manger’.
   a. The information presented to the user shows the client Bank's hierarchal structure; starting at the Business Unit (BU) level then the non-control related Business Functions (BFInt/BF3rd).
      i. This list is grouped by the ‘Overseer’ (i.e. manager over the BF)
         1. This grouping by Overseer can help in scheduling meetings to perform the steps as follows.
      ii. Each BF row within the table has a clickable link titled ‘Map CA's’ that opens a new window providing the following information that is directly related to the subject BF:
         1. A table is presented that lists the BPB ‘Risk Factors’ and each risk factor's associated control activities; also provided at the control activity level are two ‘check boxes’: (1) titled ‘Active?’ that defaults to ‘Selected’ indicating that this CA is functioning/active in the Client Bank; (2) titled ‘Similar?’ that when clicked it de-selects the ‘Active’ CB.
3. The goal at this stage is to de-select any BPB Control Activities that are not functioning within the client Bank to mitigate the risk factors of the subject BF. What follows are some options presented to the User:
   a. User can deselect any particular CA. (De-selection indicates that this CA is not functioning in the Bank and will not be mapped to the Client tables.)
   b. The user is given the option to expand the ‘Control Activity’ and is presented an HTML template of the pertinent CA details (i.e. ‘Objective of CA’, Preventative or Detective, and the basic mechanism to perform the CA).
      i. This additional CA information helps the user decide if the stated control is functioning in their Bank.
   c. If the CA is similar to what is being performed, the user is given the option of clicking the ‘Similar’ CB. Preferably, upon selecting ‘Similar’, three text boxes are dynamically presented to the user asking them to define: (1) What is similar; (2) What is different; and (3) Provide a short Control Activity Title that describes the ‘actual’ CA more precisely.
   d. At a later stage, the Client will be able to fully define what is being performed.

Next, in the case where the Client Bank has one or more Outsourcing Arrangements, the client line level risk manager 102, the present user, may proceed to step 530 to map the Client Bank's existing control activities (related to outsourcing arrangements) to control activities in the BPB model. This step is conditional based on whether outsourcing arrangements are present as indicated by the <<Extend>> labels in the use case diagram (which indicate similar dependencies wherever they appear in the drawings herein). The user interface steps for a preferred version are as follows:
1. User signs into ART
2. User navigates to the System Menu allowing only and exclusively to view a presentation of the Bank's Outsourcing Arrangements that they have been assigned as a ‘Line Level Risk Manager’.
   a. Each Outsourcing Arrangement row within the table has a clickable link titled ‘Map CA's’ that opens a new window providing the following information that is directly related to the subject outsourcing arrangement:
      i. A table is presented that lists the BPB ‘Risk Factors’ and each risk factor's associated control activities; also provided at the control activity level are two ‘check boxes’: (1) titled ‘Active?’ that defaults to ‘Selected’ indicating that this CA is functioning/active in the Client Bank; (2) titled ‘Similar?’ that when clicked it de-selects the ‘Active’ CB.
3. The goal at this stage is to de-select any BPB Control Activities that are not functioning toward mitigating the risk factors of the subject Outsourcing Arrangement. What follows are some options presented to the User:
   a. User can deselect any particular CA. (De-selection indicates that this CA is not functioning in the Bank and will not be mapped to the Client tables.)
   b. User is given the option to expand the ‘Control Activity’ and is presented an HTML template of the pertinent CA details (i.e. ‘Objective of CA’, Preventative or Detective, and the basic mechanism to perform the CA). This additional CA information helps the user decide if the stated control is functioning in their Bank.
   c. If the CA is similar to what is being performed, the user is given the option of clicking the ‘Similar’ CB. Preferably, upon selecting ‘Similar’, three text boxes are presented to the user asking them to define: (1) What is similar; (2) What is different; (3) Provide a short Control Activity Title that describes the ‘actual’ CA more precisely.
   d. At a later stage, the Client will be able to fully define what is being performed.

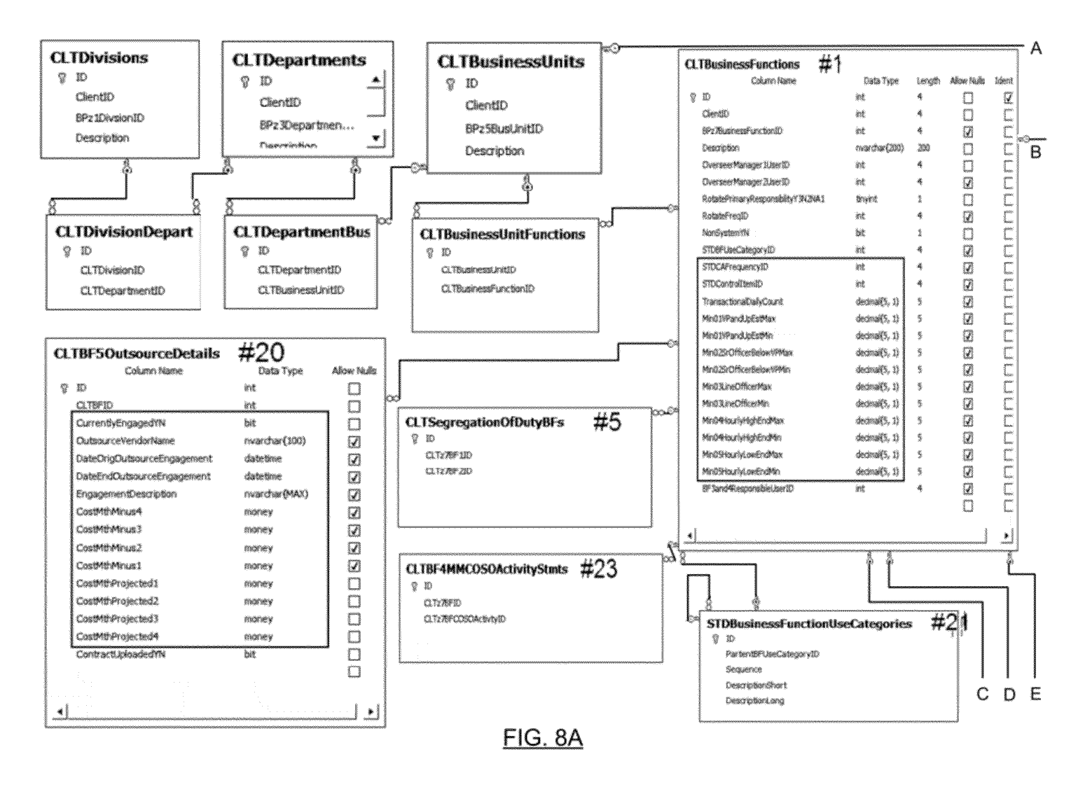

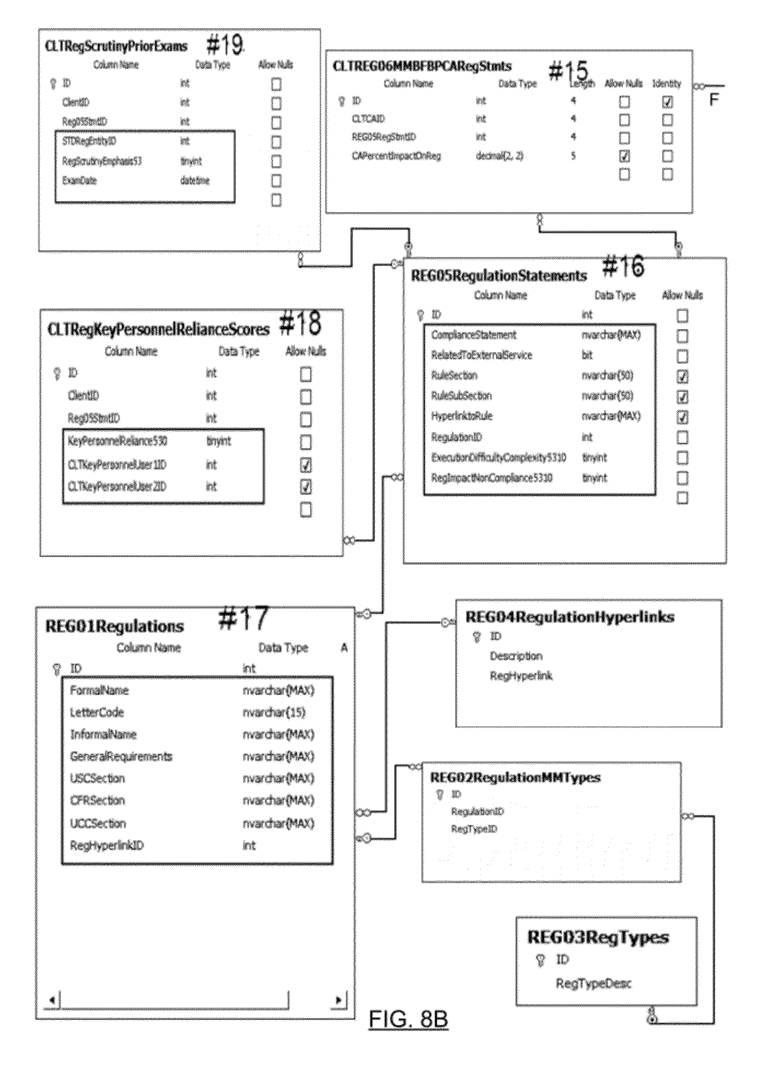

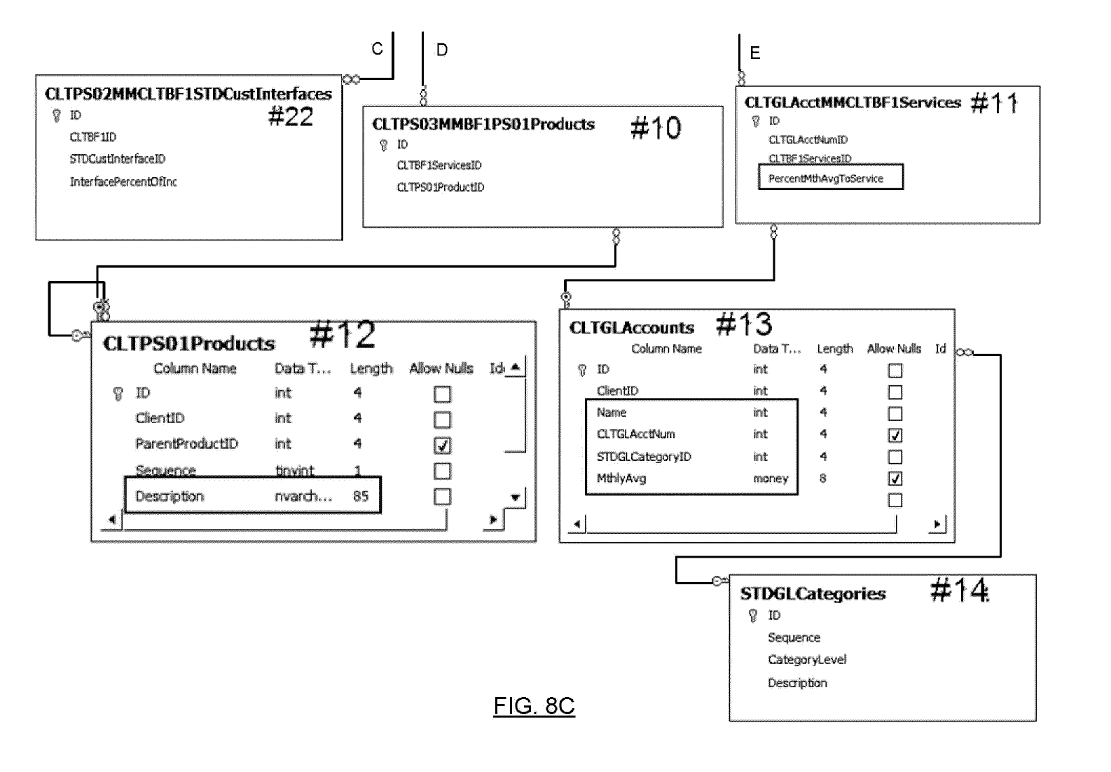

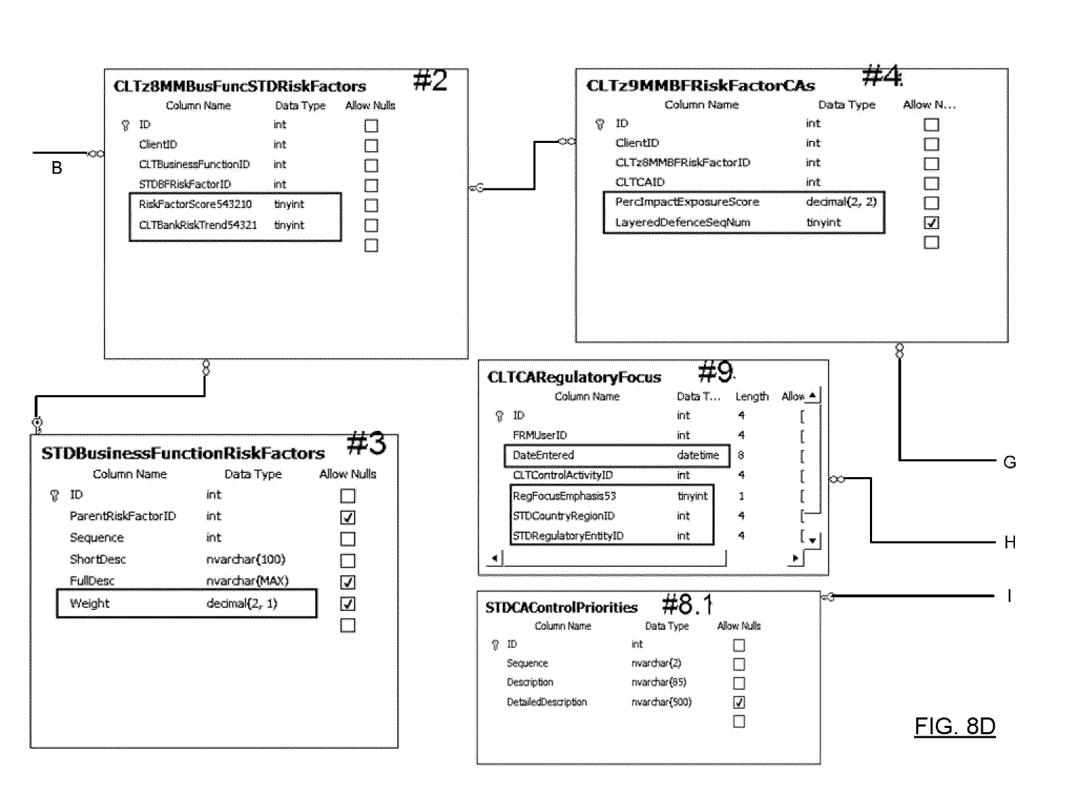

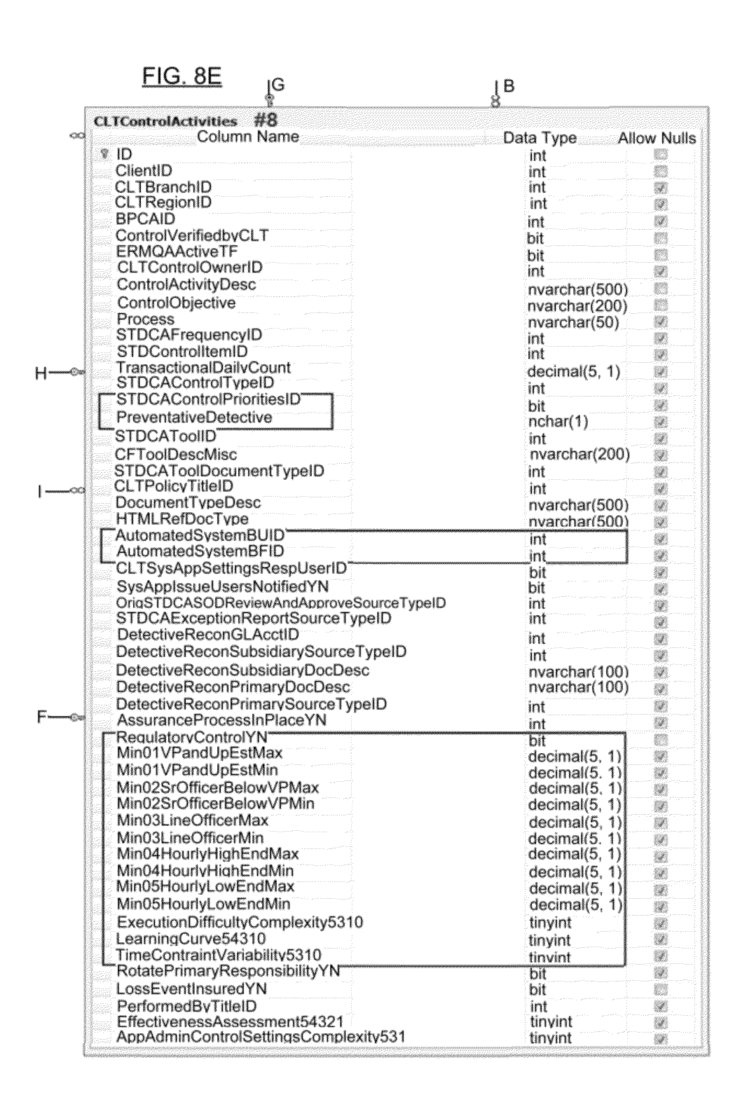

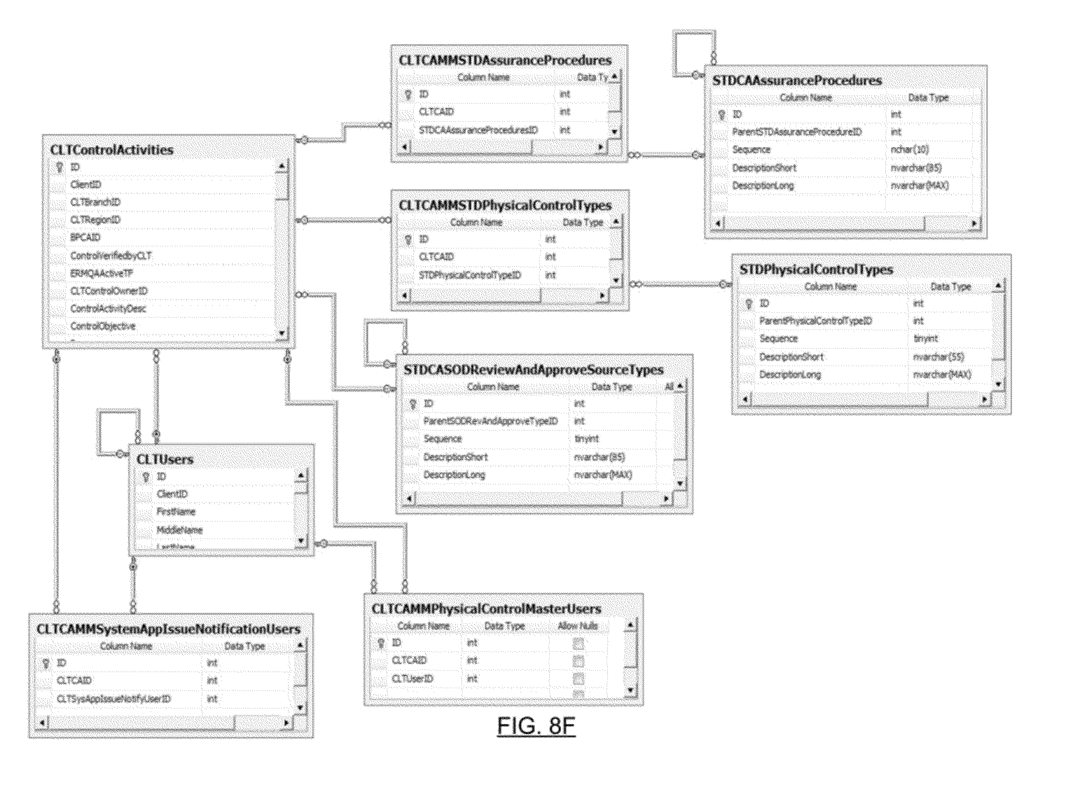

After selecting the active or similar CA's, here at step 534, the client line level risk manager 105 is provided the ability to Add Control Activities that are not modelled within the Best Practice Bank. The user interface functionality for a preferred version is described below.
1. After a keyword filter on BU and BF titles, the User selects from the resulting Drop Down List a Business Function that the Control Activity is to be related (either existing or to-be-created).
2. The user selects an appropriate Risk Factor (from the BPB standard ‘Risk Factor’ listing) that the subject ‘missing control activity’ is to be associated with. In a preferred embodiment, indicators of the selected risk factors are stored in the STDBusinessFunctionRiskFactors table (FIG. 8D) and linked or associated by the Firm Auditor to entries in the appropriate ‘Risk Factor Score’ at table CLTz8MMBusFuncSTDRiskFactors.
3. The user enters the following characteristics of the new control activity through the form(s) presented:
   3.1. CA Description (via text box allowing the user to hover over Text Box Label to see a tool-tip list of examples). This description is preferably a sharp statement of sufficient detail to define what is performed to provide the control. In a preferred embodiment, this data is stored in the ControlActivityDesc field for the associated entry in the Control Activity Table (FIG. 8E) in the ART system.
   3.2. CA Objective (via Editable DDL—Upon focus the DDL provides all the CA Objectives related to the various BF's within the subject BU. User would have the option to select an existing Objective or Type in a new Objective). This description is a General ‘Control Statement’ using control language that describes what the objective is regarding the control. Examples: Invoices are paid timely/Proper segregation of duties exists in correspondent bank account processes etc. In a preferred embodiment, the CA Objective is stored in the ControlObjective field of the Control Activity database table (FIG. 8E).
   3.3. CA Process Category (via Editable DDL—Upon focus the DDL provides all the CA Processes related to the various BF's within the subject BU. User would have the option to select an existing Process or Type in a new Process). This is a general (3-5 word) statement that categorizes the BF in terms of what is being performed by the BF users. The Process Category language is not necessarily related to the Control Activity. Two examples: (1) Control Objective=‘Interest expense is properly authorized’, the corresponding Process Category=‘Borrowed Funds—Interest Expense’; (2) Control Objective=‘Proper approval is obtained on all fixed asset purchases’, the corresponding Process Category might be ‘Additions’. In a preferred embodiment, the CA Process category is stored in the Process field for the related entry in the Control Activity Database Table (FIG. 8E).
   3.4. Frequency the CA is performed (via a DDL—Upon focus the DDL provides a list of frequency terms (i.e. Transactional/Daily/Weekly etc)). This indicator of frequency is stored in the STDCAFrequencyJD field (FIG. 8E).
   3.5. Control Item (via Editable DDL—Upon focus the DDL provides all the Control Items related to the various BF's within the subject BU. User would have the option to select an existing Control Item or Type in a new). This is the root ‘item/service’ that is being brought under the scrutiny of the subject CA (i.e. Loan Documents/Deposit Account/wire/issued checks etc). In a preferred embodiment the item is stored in the STDControlItemID field.
   3.6. Transactional Daily Count (via Editable DDL—If the frequency is transactional, then upon focus the DDL provides all the CA Descriptions related to the various BF's within the subject BU. Columns to the far right would be ‘Control Items’ then ‘Transactional Daily Count’. The User would have the option to select an item ‘Daily count’ or type in user defined value.) In a preferred embodiment, this item is stored in the TransactionalDailyCount (FIG. 8E).
   3.7. The user is asked if this control is Preventative—if not, the process skips to next item. In a preferred embodiment this indicator is stored in the PreventativeDetective field (as a variable type nchar(1)—‘P’ or ‘D’). Preventive Controls focus on preventing errors or exceptions. Here are a few examples of preventive controls: (1) Standards, policies and procedures are the most basic type of preventive control. (2) Segregation of duties also acts as a preventive control against fraud. (3) Authorization/Approval levels also prevent the risk of an illegal act and are thus preventive in nature. The user selects one of the following ‘tools’ to perform the Preventative control (via Editable DDL—Upon focus the DDL provides all the available control tools. The user would have the option to select an existing tool or Type in a new tool description), which selection is preferably stored in the FK STDCAToolID or ToolDescMisc field of the related entry in the Control Activity database table.
      3.7.1. Tool #1: Existence of ‘Documented Practices/Processes’ (via Editable DDL—Upon focus the DDL provides all the available control tools. Examples: type of document as either Policy/Industry Standard/Internal Procedure. The user would have the option to select an existing tool or Type in a new tool description). In a preferred embodiment, this indicator is stored in the STDCAToolDocumentTypes field for the related entry in the Control Activity database table.
         3.7.1.1. If Policy, select from DDL the Policy Document Title. This provides the ability to add/edit a policy title. In a preferred embodiment, this title is stored in the CLTPolicy01Titles 1.1.1. field for the related entry in the Control Activity database table.
         3.7.1.2. If Industry Standard,
            (1) provide ‘HTML text box’ to cut and paste the standard. In a preferred embodiment, this text is stored in the DocumentTypeDesc field for the related entry in the Control Activity database table.
            (2) as well as a ‘Web site’ address for an external reference, preferably stored in the HTMLRefDocType field for the related entry in the Control Activity database table.
         3.7.1.3. If ‘Internal Procedure’,
            (1) Provide the ability to upload a word doc
         3.7.1.4. Jump to: ‘Step 4’
      3.7.2. Tool #2: CA is automated by a ‘System Application’. If the DDL selection ‘System Application’ and the ‘Services Provided by the application’ is made, this result is stored in the AutomatedSystemBUID and AutomatedSystemBFID fields.
         3.7.2.1. Who is responsible for managing the appropriate settings within the ‘System Application’?(DDL) In a preferred embodiment, this indicator is stored in the CLTSysAppSettingsRespUserID field.
         3.7.2.2. Are users notified when the ‘System Application’ identifies an issue? (Radio Button) In a preferred embodiment, this indicator is stored in the SysAppIssueUsersNotifiedYN field.
            If Yes is selected, the system provides a multi select DDL of users—filterable by BU Title and Rank. This information is stored in the many-to-many table titled CLTCAMMSystemAppIssueNotificationUsers (FIG. 8F).
         3.7.2.3. Jump to: ‘Step 4’
      3.7.3. Tool #3: Does the CA restrict physical access (Multi select DDL of Type of Physical Access control)? This response is stored in the CLTCAMMSTDPhysicalControlTypes and STDPhysicalControlTypes fields.
      (1) Which users can change the physical or electronic ‘keys’ (select one or more)? This selection is stored in the CLTCAMMPhysicalControlMasterUsers and CLTUsers fields.
      (2) Jump to: ‘Step 4’
      3.7.4. Tool #4: CA utilizes ‘Separation of Duties’ via ‘Review and Approve’ documentation Note: Separation of Duty procedures involving ‘Review and Approve’ centers upon ‘source documentation’ that the ‘Reviewer’ reviews. The ‘First Party’ is the person that originated the transaction/event that is to be ‘Approved’. The ‘Second Party’ is the person that performs the review and issues the ‘Approved’ status. A set of questions and answers are required in terms of the item that is being reviewed then approved:
      (1) What is the ‘source’ of the item being brought by the ‘First Party’ to be reviewed by the ‘Second Party’? (DDL select box) This data is stored in the OrigSTDCASODReviewAndApproveSourceTypelD field in the STDCASODReviewAndApproveSourceTypes table (FIG. 8F).
      Source Examples include: Report Generation: Printed directly from ‘System Application’
      Report Generation Received from 3rd Party (external Bank)
      Report Generation Manually Compiled (First Party)
      Report Generation Manually Compiled (Third Party-Internal)
      Original Document Signed by Vendor
      Original Document Signed by Client
      Original Document Signed by First Party
      3.7.5. Jump to: ‘Step 4’
   3.8. Is this control Detective? This data is stored in the PreventativeDetective field (nchar(1)—‘P’ or ‘D’) (FIG. 8E). Detective controls are designed to identify an error or exception after it has occurred.
      3.8.1. Detective Tool #1: This control is automated by a ‘System Application’ (DDL Select ‘System Application’ and the ‘Services Provided by the application’). This data is stored in the AutomatedSystemBUID and AutomatedSystemBFID fields (FIG. 8E).
         3.8.1.1. Who is responsible for managing the appropriate settings within the ‘System Application’?(DDL Select) This data is stored in the CLTSysAppSettingsRespUserID field.
         3.8.1.2. Are users notified when the ‘System Application’ identifies an issue? (Radio Button). This data is stored in the SysAppIssueUsersNotifiedYN field.
            If Y, the system provides a multi select DDL of users—filterable by BU Title and Rank. This data is stored in the table CLTCAMMSystemAppIssueNotificationUsers (many-to-many table, FIG. 8F).
         3.8.1.3. Jump to: ‘Step 4’
      3.8.2. Detective Tool #2: This detective control utilizes Exception reports (DDL of Exception Report source). This data is stored in the STDCAExceptionReportSourceTypelD field in the STDCASODReviewAndApproveSourceTypes table (FIG. 8F).
      Source Examples include: Report Generation: Printed directly from ‘System Application’
      Report Generation Received from 3rd Party (external Bank)
      Report Generation Manually Compiled (First Party)
      Report Generation Manually Compiled (Third Party-Internal)
      Original Document Signed by Vendor
      Original Document Signed by Client
      Original Document Signed by First Party
         3.8.2.1. Jump to: ‘Step 4’
      3.8.3. Detective Tool #3: This detective control utilizes Reconciliations
         3.8.3.1. If Y, is the Reconciliation of a GL account—YN?
            (1) If Y, select the GL account from the (searchable DDL). This data is stored in the DetectiveReconGLAcctID field.
            (1.1) Select the source of the subsidiary documentation (DDL—Note: same field is used if not GL) DetectiveReconSubsidiarySourceTypelD in the STDCASODReviewAndApproveSourceTypes table.
            (1.2) General Description of subsidiary document (100 char text box—Note: same field is used if not GL). This data is stored in the DetectiveReconSubsidiaryDocDesc field.
            (1.3) Jump to: ‘Step 4’
         3.8.3.2. If N, Primary Document to be reconciled:
            (1) Primary General Description (100 char text box). This data is stored in the DetectiveReconPrimaryDocDesc field (note: only used if DetectiveReconGLAcctID is NULL and if the ‘Detective Tool ID’ refers to the Recon Tool).
            (1.1) Primary Document Source
            This data is stored in the DetectiveReconPrimarySourceTypelD field in the STDCASODReviewAndApproveSourceTypes table (FIG. 8F).
            (2) Subsidiary Document to be compared to the primary document (100 char text box).
            This data is stored in the DetectiveReconSubsidiaryDocDesc field.
            (2.1) Subsidiary Document Source
            This data is stored in the DetectiveReconSubsidiarySourceTypelD field in the STDCASODReviewAndApproveSourceTypes table (FIG. 8F).
            (3) Jump to: ‘Step 4’
4. Is there an ‘Assurance Process’ in place that would verify that the CA functioned as intended Y/N? This data is stored in the AssuranceProcessInPlaceYN field.
   4.1. If ‘Y’, select one or more ‘Assurance Processes’. This data is stored in the STDCAAssuranceProcedures table and mapped through the many-to-many table CLTCAMMSTDAssuranceProcedures.

Next, referring again to FIG. 5C, if there is an outsourcing arrangement with outsourced control activities not present within the BPB, as depicted in the drawing the user is given a chance to add such control activities at step 535. These may be control activities that are not modelled within the Best Practice Bank. The entry process for step 535 is similar to that of step 534. After any new control activities are added at steps 534 and 535, the process goes to step 536 where the client line level risk manager 105 documents and verifies various aspects of each functioning control activity that has been identified as actively functioning in the client Bank. This step preferably adds all characteristics available at the user 105 level that are helpful in conducting a control activity assessment. The User Interface content for this function is summarized below:

1. User navigates to an appropriate web form, in this embodiment titled ‘Verification of Control Activity Infrastructure—Level 1’, such as the form shown in FIG. 5L.
a. The user is presented a tabular interface 5300 that provides a global outline of ‘parent entities’ and the associated number of control activities to each parent entity (column 5302). The list is preferably limited to only parent entities that a particular line level risk manager is to document and verify.
b. The last column 5304 titled ‘Verification Status’ provides a status indicator of what needs to be verified. The data fields in column 5302 are preferably hyperlinked and takes the user to a Level 2 view (see below).
   2. Based on selecting the Level 1 ‘Verification Status’ column 5304:
a. The user is presented a tabular Level 2 interface, such as interface 5400 depicted in FIG. 5M, which provides a summary of control activities related to a particular parent entity. In this view, the control activities are grouped by the risk factor to which they are associated.
b. The last column 5402 titled ‘Verification Status’ provides a status indicator of whether the control activity has been verified. The fields in column 5402 are hyperlinked and takes the user to Level 3 (see below).
   3. Based on selecting the Level 2 ‘Verification Status’ column:
a. The user is presented a Level 3 data input form interface (5500 in FIG. 5N) which provides various web form controls that allow for the review and editing of control activity data-points.
b. The user is required to verify and/or edit all fields within the data input form.
c. In the depicted preferred version, the following sections are presented to the user:
   Control Outline 5502: this section provides textual details of the control namely the control's ‘Description’, ‘Objective’, and ‘Process Category’
   Control Items 5504: this section provides details of the associated ‘Control Item’ namely the ‘Description’ and ‘Frequency Performed’
   Controls Details 5506: The web form controls for this section are dynamically populated based on the ‘control type’ and ‘tool type’ selected. If the user changes the ‘tool type’, a particular set of fields are available for review and/or input. In addition, various Control Weakness Assessments are presented to the user for review and/or edit.
d. The User finalizes the verification by clicking the button control titled ‘Finalize’. This causes the ‘Verification Status’ at Level 2 to reflect the status of ‘Done’.

Referring again to FIG. 5C, a similar process takes place at step 537 if the client bank has one or more outsourcing arrangements. While the above activities are shown as being conducted by the client bank personnel, this is not limiting and of course the audit firm personnel or third parties may be retained to perform such activities.

After the client bank personnel enter the control activity data discussed above, the audit firm or auditor personnel 102 use the system to continue the control activity assessment process. As shown at step 538, the auditor 102 is presented with a set of web forms by which they can review the client control activities that reflect discrepancies from the BPB model. At step 539, the auditor 102 is enabled to electronically mark or select certain control activities to discuss with the client bank, such as those that reflect discrepancies from the BPB model. Next at step 540, the auditor 102 and client bank personnel review the list of ‘Best Practice’ control activities that are not being performed by the client bank for applicability to the control activity gap assessment report process.

FIG. 5D is a flow chart of a process for mapping a client banks hierarchical structure. FIG. 5E is an example screenshot of a web form allowing selection of active business units such as that done in step 522. FIG. 5F is an example screenshot of a web form allowing reorganization of business units entered into the ART system, such as the reorganization performed in step 523. FIG. 5G is an example screenshot of a web form allowing the user to view and edit business units already entered into the ART system, or add new ones. FIG. 5H is an example screenshot of a web form allowing users to edit client bank divisions already entered into the ART system, or add new ones.

Referring to FIG. 5D, which shows a process for mapping a client bank's hierarchical structure, at step 522 the audit firm personnel 102 and client personnel preferably cooperate to identify and select the business units active in the bank that match or nearly match business unit functionality in the BPB bank model. Preferably someone at the level of the client chief operating officer (COO) participates with the audit firm at to perform the function. This may be accomplished through an interface such as the web form screenshot shown in FIG. 5E. The depicted interface in FIG. 5E is preferably achieved with an ASP.NET grid control such as the Telerik Radgrid® available in the Telerik RadControls for ASP.NET AJAX. The depicted grid control displays a hierarchal listing of the BPB bank model enabling the user to browse with expansion arrows 554 to expand the levels of hierarchy in each division of the BPB. The prompt 550 tells the user to Un-select those BPB business units in the depicted hierarchy that are not functioning in their bank. The depicted units are preferably grouped by the highest level Division (Div), selectable by the checkboxes 551, the second level Department (Dep), selectable by the checkboxes 552, and the lowest level Business Unit (BU), selectable by the checkboxes 552. This organization of course represents only the preferred versions and other organizations may be used, including ones with more levels of hierarchy. Preferably, to accomplish step 522 in FIG. 5D, the user(s) goes through the BU listing (not being concerned that the DIV and DEP do not align with their bank) un-selecting the BU's that do not pertain to the client's bank. When the selections are made, the button control 555 is clicked to save the remaining selected business units. The original BPB ID's for Div/Dep/BU are saved to the Client hierarchal tables, allowing for mapping of future BF's and related risk factors and Control Activities.

Next at step 523 in FIG. 5D, the same personnel reorganize the client bank's captured hierarchy to match what is actually functioning at the bank. This is preferably accomplished through a control such as the Telerik Radgrid tree view control 560 shown in FIG. 5F, which provides ability for the user to drag and drop business units into their appropriate departments and divisions. The user activates dropdowns 561 to see more of the hierarchy under each division and department. At that point, the user is able to reorganize (by drag and drop). The business units 562 may be multi-selected in the drag-drop process. The departments may also be dragged and dropped including all business units underneath them.

Referring again to FIG. 5D, next at step 524, the user(s) may rename the various business units, divisions, and departments documented through the above process, and may add business units, divisions, and departments. This is preferably accomplished through an ART1 web form interface such as that shown in FIG. 5G and FIG. 5H, which show example web form interfaces through which a user may edit and add business units and divisions.

Referring to FIG. 5G, the interface 570 shown in FIG. 5G is displayed when a user clicks on the “Business Units” tab 574. The interface 570 allows a user to rename, edit, and add business units. Preferably, the depicted interface is implemented using Editable Telerik Radgrids, but a custom UI or other suitable commercial modules and libraries may be used.

A business unit menu 587 includes a number of lines, each line including an edit option 575. A user may click on edit option 575 to cause a Business Unit Title entry field 572 and a Department Title selection field 573 to appear. The user can then enter the name of the new business unit in Business Unit Title entry field 572. The user is required to use Department Title selection field 573 to select a Department Title under which the newly added Business Unit operates. The user may confirm the update by pressing an update button 582 or cancel the addition by pressing a cancel button 583. The user may also add an additional business unit to a specified department by clicking on a new business unit button 586.

Each line of business unit menu 587 further includes a delete option 576, a business unit ID 577, a business unit title 578, a department ID 579, a department title 580, and a number of business functions 581. A user may click on the delete option 576 to delete a desired business function. Business unit ID 577 is a number that uniquely corresponds to a particular business unit, and business unit title 578 is a title that uniquely corresponds to a particular business unit. Department ID 579 is a number that uniquely corresponds to the particular department associated with the business unit on a same line of business unit menu 587, and department title 580 is a title that uniquely corresponds to said particular department. The number of business functions 581 indicates a number of business functions associated with the business unit on the same line of business unit menu.

It should be noted that business units are child entities to department entities. For example, as may be seen with respect to the business unit menu 587 in the lower portion of FIG. 5G, multiple business units correspond to the “Accounting Operations” business. The corresponding business units have the following business unit IDs 577: 130, 129, 29, 30, 31.

Interface 570 further includes the following: a filter 571, which allows the user to enter a keyword in order to find a desired existing business unit or department associated with that keyword; a new business unit button 586 that allows a user to add an additional business unit to a specified department; a refresh button 584 that allows a user to redisplay interface 570 to reflect updated information. A spreadsheet export button 585 exports the information in business unit menu 587 to a file in a spreadsheet program, preferably Microsoft Excel.

Referring to FIG. 5H, an interface 590 shown in FIG. 5G is displayed when a user clicks on the “Divisions” tab 591. The interface 590 is similar to interface 570, except interface 590 allows a user to rename, edit, and add divisions instead of business units.

A division menu 591 includes a number of lines, each line including an edit option 592. A user may click on edit option 592 to cause a Divisional Title entry field 593 to appear. The user can then enter the name of the new business unit in Divisional Title entry field 593. The user may confirm the update by pressing an update button 594 or cancel the addition by pressing a cancel button 595. The user may also add an additional business unit to a specified department by clicking on a new division button 596.

Each line of division menu 591 further includes a delete option 597, a division title 598, and a number of departments 599. A user may click on the delete option 597 to delete a desired business function. The division title 598 is a title that uniquely corresponds to a particular division. The number of departments 599 indicates a number of departments associated with the division on the same line of division menu 591. It should be noted that division entities are parent entities to department entities, and department entities are parent entities to business unit entities.

Interface 590 further includes the following: a filter 571, which allows the user to enter a keyword in order to find a desired existing division; a new division button 596 that allows a user to add an additional division; and a refresh button 584 that allows a user to redisplay interface 590 to reflect updated information.

FIG. 5J is a flowchart of a use-case diagram showing the process of executing and delivering the CA-GA report to a client. The depicted process happens after the data gathering steps previously described, as can be determined by the use-case numbering in each flowchart such as, for example, the “02.2.16_UC” shown on step 5111. After the assessment data has been collected and edited as previously described, the audit personnel 102 executes and review the CA-GA report (step 5111), preferably using web form functionality provided in the ART1 application. Next at step 5112, the audit personnel make the report available for viewing by the client bank personnel by activating or posting the report in ART1. At step 5113, the audit firm sends credentials to the client for them to view the online report. This preferably involves using the ART1 controls to produce a digital access code of some form to allow designated client personnel to access the gap report posted on ART1. Next, at step 5114, the ART1 system automatically records all new hierarchical elements that appeared in the assessment of the client bank's control structure. These elements are saved for later analysis, and maybe used as the basis to make adjustments or changes to the BPB model.

FIG. 5K is a screenshot of an example view of a portion of a control activity gap report (CA-GA report). The depicted report screenshot 5220 shows a high-level report for a sample bank. The current view is shown in FIG. 5K is grouped by business unit. For example, as shown in the drawing is the Wire Transfer Admin business unit 5221, and the Commercial Lending Admin business unit 5222. Within each of the business units are listed business functions, which are listed in the column 5223. The depicted view is currently grouped by business units, as shown by the group indicator 5224. Preferably, the report may be grouped by any desired column using web forms such as the Telerik Radgrid. Such functionality is implemented by dragging the column header on to the Grouped By indicator 5224.

As shown, each particular row in the report represents a business function, such as the BF#1, “Receive Wire Transfer Requests—by phone” business function 5225, or the BF#2 “Process Wire Request” business function 5226, both shown grouped underneath the wire transfer admin business unit 5221. A group aggregate row, such as row 5227, aggregates the depicted metrics for each group of business functions. In a typical complete report, each business unit of the bank might have more than 15 individual business functions within the unit. However, the depicted control activity gap report, as indicated, shows only missing control activities and business functions. That is, those functions that are present in the BPB model bank but have not been found in the assessment of the client bank. Therefore, the depicted report contains a group of data elements 5228 directed toward the missing control activities. A standard hierarchical services report would contain the other groups of data elements, such as the Current Risk Scores group 5229, the Current Critical Controls group 5100, and the Current Key Controls group 5101.

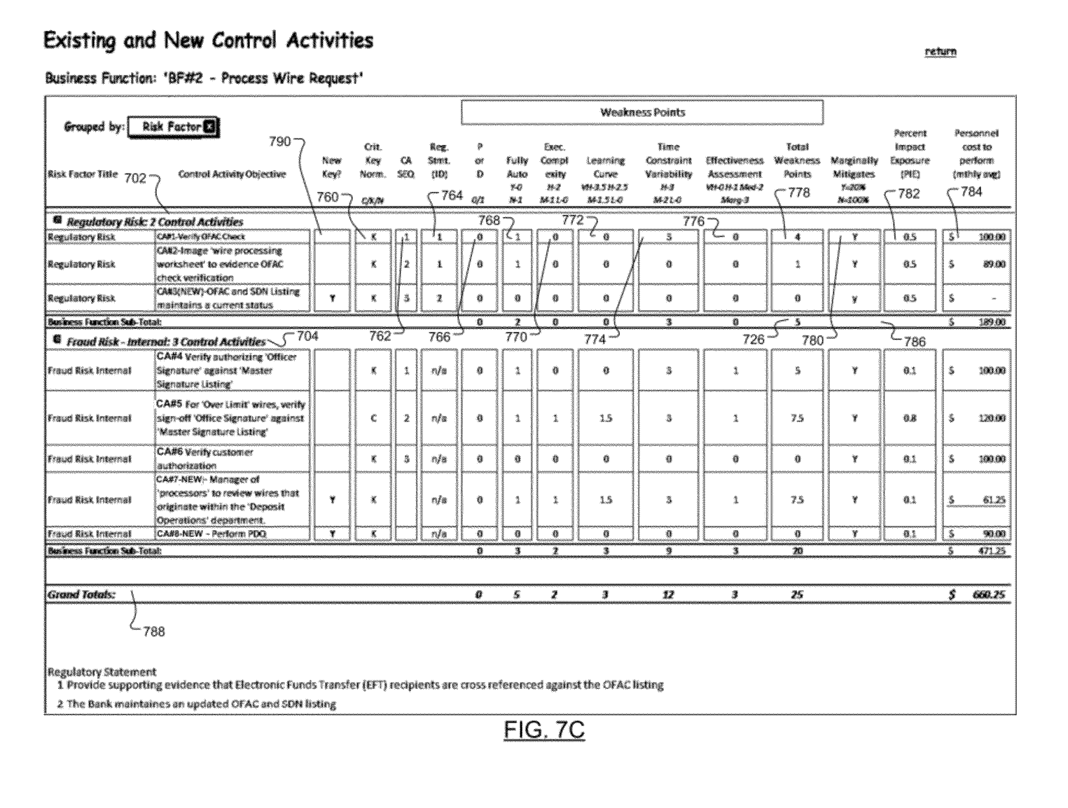

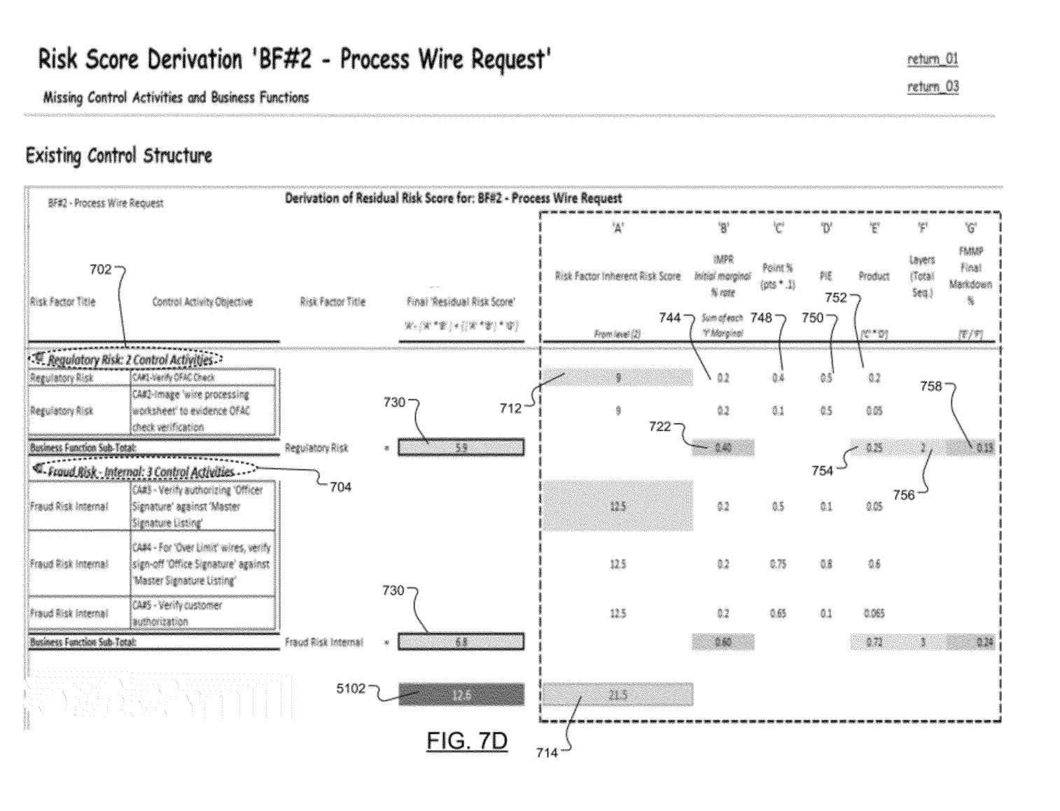

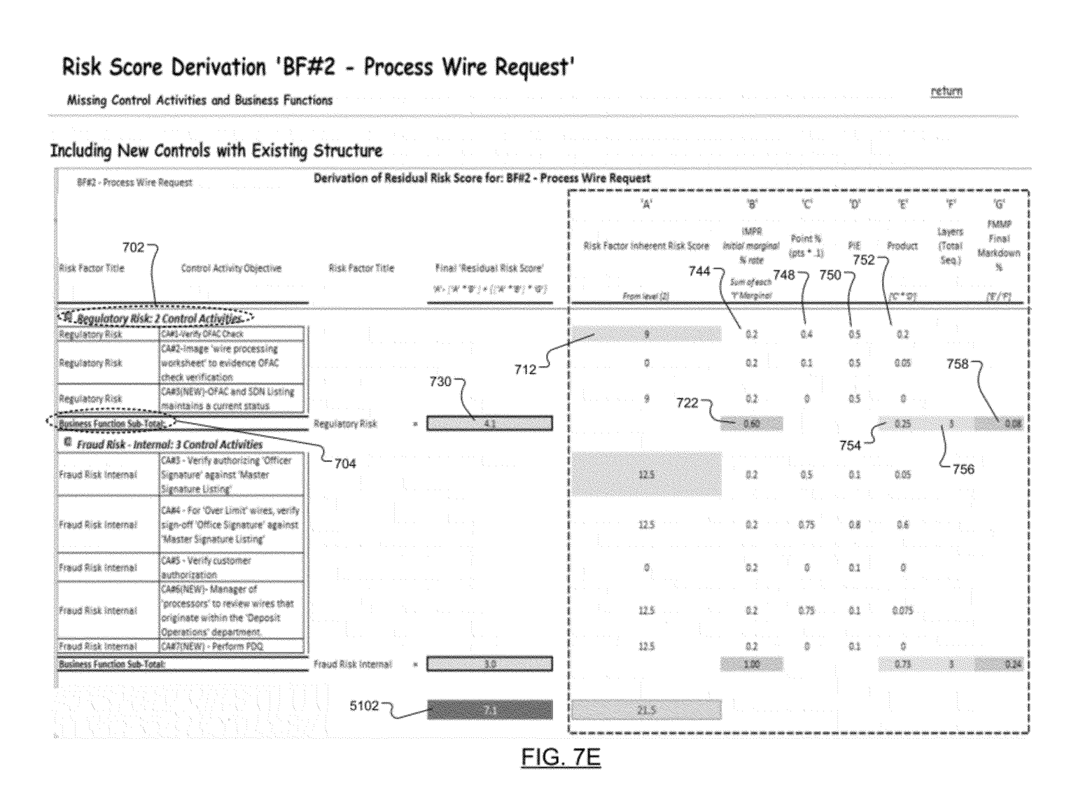

Another feature of the depicted report 5220 is the ability to drill down or browse into the various risk assessment scores provided and determine the basis, or supporting data values and calculations, of the score. For example, an important metric provided in the report is the Residual Risk Score for a particular business function. This is found in the Current Risk Scores group 5229. For example, the BF Residual Risk Score for business function 5226 is shown circled and labeled 5102. Each BF Residual Risk Score, and the other metrics and scores shown in the report, is presented as an active link which takes the user to a web form showing the basis of the score calculation and the variables and values that go into the score calculation. In this example, the risk score 5102 is an active link that leads to the form shown in FIG. 7D, which shows a second level breakdown of the scores depicted here. A third level breakdown and other breakdowns are also available in many of the report views, as will be further described with respect to FIGS. 7A-F. The basis of the reported metric at each level can be seen by clicking into the metric or score. While any deliverable reported to the client through ART1 can be exported to PDF, Word, or Excel; however, the drilldown interface preferably can only be utilized while logged-in. Another embodiment may provide the ability to drill down in an exported report by using internal links such as links inside of a PDF document.

Another feature of the depicted report 5220 is the ability to stack rank, or sort, various business functions by the metrics provided. In particular, stack ranking is a useful analytical tool when the abilities provided to stack rank by one of the Current Risk Scores, and especially the BF residual risk score. Stack ranking may also be provided by the number of control activities missing (the first column in group 5228), or the other depicted metrics. The report 5220 is also shown in a grid view that is not only sortable, but provides ability to filter by the various metrics, and still retain the drill down capability.

After the control activity mapping process described herein, the ART system is preferably able to deliver to the client a variety of useful control activity assessments. Given that the Audit Firm has access to varied and comprehensive Control Documentation as well as knowledge of the actual control structure of various sized Banks, the Client is able to gain the following after the gap assessment is performed:

1. Assess Missing Control Activities and Business Functions (i.e. Services):
For each control that is not being performed by the client Bank but is being performed by the BPB, the following two ‘Stack Rank reports are provided’
#1—Hierarchal Services Performed
#2—Outsourced Activities
Note: the figures displayed in the reports are preferably only based on controls not functioning in the Client bank.

2. Assess Extra Control Activities:
List of control activities that are being performed by the Client but are not found on the BPB control list. For each of these controls the following two ‘Stack Rank reports are provided’
#1—Hierarchal Services Performed
#2—Outsourced Activities
Note: (1) the figures displayed in the reports are only based on controls functioning in the Client bank but not in the BPB;

3. Assess Automation Gap:
List of controls being performed where there is a ‘Control Implementation Automation Gap (CIAG)’ between the Best Practice Bank and the Client Bank. Regarding these CIAG tagged controls, the following is provided:
   a. Residual Risk score decrease given the various weakness factor changes
   b. Cost factors to implement the automation
      i. Systems cost
      ii. Employee time cost to implement (Sr. Officers/Officers/Hourly)
      iii. Employee time cost saved (Sr. Officers/Officers/Hourly)

4. Assess Cost/Risk Products Services:
List of the Client's Products and their related Services offered to 3rd parties external the Bank mapped to particular Business Functions. This allows the following to be provided to the Client:
   a. Stack Rank Report titled ‘Products/Services Toward External 3rd Parties’

5. Bank Wide Strategic Objective/Control Activity Matrix:
Drill down report (XML) that allows management the ability to see which controls of the bank can be stressed for each ‘Strategic Objective’ of the Bank. Each Control Activity is given the following scores:
   a. Total risk score
   b. Client is able to click a link and review the various data points regarding the control activity.
   c. If regulatory related,
      i. Total monthly avg cost to comply with reg.
   d. If non-system,
      i. Avg. complexity rating (i.e. how difficult is it to execute properly)
      ii. Avg. Time Constraint Variability (i.e. If the user is pressed for time, how variable/susceptible is the set of CA's to being non-compliant)

6. Regulatory Requirements to Control Activity Matrix:
Drill down report (XML) that is grouped by ‘Formal Regulatory Titles’ and provides a number of key data point for each ‘Formal Regulatory Title’:
   1. # of ‘Regulation Statements (RS)’
   2. Monthly avg. cost of personnel time to perform the control activities associated with the RS's.
   3. High Regulatory Scrutiny During Past Exams Score
   4. Complexity Score
   5. Impact of Non-Compliance
   6. Key Personnel Reliance Score
   7. Regional Regulatory Focus (National)
   8. Regional Regulatory Focus—if applicable (State)
   9. Control Weakness Score

7. Regulatory Hot-Buttons that have been Communicated Back to the Audit Firm from Other Banks that have been Examined in Recent Months.
a. This report is not tied to the Client bank in any manner but rather allows the Client bank that ability to compare historically (by quarters) which ‘Regulation Statements’ have received high scrutiny levels.

8. Business Function/User Responsibilities Matrix (Overseer/Primary/Backup)
For ‘non-system performed’—Business Functions that are identified either as being (1) a typical rotation of duties BF or (2) have high inherent risk scores, the following ‘Assignment Types’ are provided:
   a. ‘Overseer’ (i.e. manager over the BF),
   b. ‘Primary’ (i.e. Client users whom have been given the duty of performing the BF), or
   c. ‘Back-up’ (i.e. Client users that are cross trained to perform if the ‘Overseer’ and/or ‘Primary’ is not available). [Notes: (1) There must be an ‘Overseer’ and at least (1) primary; (2) it is possible that the ‘Overseer’ is also the ‘Primary’; (3) ‘Back-up’ assignments are optional.]
   d. If the BPB is recommending ‘Rotation of Duties’ and the client has indicated that Rotation occurs, the frequency of the rotation is requested (i.e. Daily, Weekly etc.).
      The above-listed information is preferably embedded in each of the ‘stack rank’ reports and an ad-hoc query can be created to provide the information in any manner the client sees fit.

### Benefits of ‘Client Initiated’ Control Mapping Model

Given that the ART utilizes a client initiated control identification and control assessment, the following benefits are achieved:

Note: ART utilizes an SSL encrypted connection to provide a Web Application interface between the line level departmental Risk Managers and their assigned Business Units that they manage. ART (via this user interface) provides the appropriate tools to bring efficiency and automation to the identification and assessment of the control activities.
Limited On-site Costs: Significant cost savings is passed on to the client, given that the identification and assessment phase does not include the time and travel expenses that customarily are logged by the Audit Firm auditors during a full control activity gap assessment. Note: Interaction with the Client during the identification and assessment phase can be performed via a ‘remote desktop program’ like ‘GoToAssist’ by Citrix.
Flexible Client Schedule During CA Mapping: Less work disruption toward the client's work schedule, given that the client is able to conduct the control identifications and assessments according to their schedule.

### Overview of Hierarchal Structure of Best Practices Bank Model and Collected Client Bank Assessment Data

FIG. 4A shows a table with a list of BPB model parent entities as employed in one preferred embodiment. In this embodiment, ART maintains seven logical ‘Parent Entities’ which represent various functions of a theoretical ideal bank that employs all known best practices in its internal controls. The parent entities are logical divisions, or an abstract model, and typically do not correspond directly to the organized and functioning business divisions within a bank. As such, the parent entities are modeled through their functional distinctions as described below.

Before discussing the BPB model parent entities, it is helpful to provide a hierarchical standard nomenclature for use in describing a bank's organizational hierarchy. In general, the ART system utilizes a 4-level hierarchal structure to map the various services and control activities that function at the operational/line level of a bank. The titles used to describe the four levels are ‘Divisions’, ‘Departments’, ‘Business Units’, and then ‘Business Functions’. Of course, this is not limiting and other embodiments may use hierarchical systems with more of fewer levels and different names or designations.
Division titles attempt to mirror the top level goals of the bank.
Example: ‘Deposit Operations’, ‘Financial Assurance, Safety and Soundness’, and ‘Misc.-Global Influence’ etc.
Department titles mirror traditional banking segments and are children of their parent ‘Divisions’.
Example: ‘Deposit Operations’→‘Bookkeeping’ or ‘Deposit Operations’→‘Electronic Funds Transfer Unit’
Business Unit (BU) titles are grammatically subject/noun based and attempt to provide a descriptive bucket to place the 4th level. Personnel are ‘loosely held’ in each BU; given that personnel are often cross trained to perform the various duties in each BU.
Example: ‘Deposit Operations’→‘Electronic Funds Transfer Unit’→‘Wire Transfer—Administration’
   Note that in use of the ART system, these three tiers provide a funneling effect and aid greatly in keyword searches to identify the most import tier namely Business Functions.

The most granular and 4th level is the hierarchal element titled ‘Business Function’.
Business Function titles are high-level statements of services rendered by either personnel within Business Units or by an ‘Application System’.
Business Function titles are preferably grammatically phrased as ‘wrapper’ statements that are action oriented; not step-by-step process descriptions of what is being performed.
Example: Loan Operations→Lending→Commercial Lending—Administration→BF: ‘Process new credit application—Commercial’
Business Functions are primarily mapped to only one Business Unit but ART allows for BF's to be mapped to multiple Business Units.

In terms of the hierarchal structure (Div→Dep→BU→BF), there are three (3) distinct (mutually exclusive) ‘Business Function—Uses’ that are mapped to the Business Function titles as used in the BPB model parent entities shown in FIG. 4A:
BF #1: ‘Non-Control Activity 3rd Party Service’—Business Functions (NonCA-BF3rd). This is a functional statement of what the Business Unit is performing or providing (i.e. service) toward an external 3rd-party. Note: Each NonCA-BF3rd is either:
   1. Directly related to a ‘Service/Product’ that is provided to external 3rd-parties; or
   2. A child of a ‘Service’ that is provided to external 3rd-parties.
BF #2: ‘Non-Control Activity Internal Service’—Business Functions (NonCA-BFInt). This is a functional statement of what the BU is performing or providing (i.e. service) toward internal users, ‘Business Units’, or ‘Departments’.
BF #3: ‘Enterprise Control Functions’—(EntWide-CS). This represents risk management controls or functions performed by particular business units of the Bank including governance entities.

For each Business Unit of the bank, the ART system documents the activities that are performed within them. First by ‘services’ provided (external and internal the Bank) then by ‘risk management’ or ‘control related’ activities. The table below provides a sequence of questions, preferably provided during the assessment process described above, that categorize each activity/'line level process' that is performed by the various Business Units of the Bank:

TABLE 2
Questions to properly categorize ‘Line Level Processes’

| Q # | Question | If ‘Yes’ . . . | If ‘No’ . . . |
|---|---|---|---|
| 1 | Does the BF title describe a service that is provided | BF #1: | Ask |
| | toward a 3rd party external the Bank? | ‘Non-Control Activity 3rd Party | Q #2 |
| | | Service’ -- Business Functions | |
| | | (NonCA-BF3rd) | |
| 2 | Does the BF title describe what BU is performing or | BF #2: | Ask |
| | providing (i.e. service) toward internal users, ‘Business | ‘Non-Control Activity Internal | Q #3 |
| | Units’ or ‘Departments’? | Service’ -- Business Functions | |
| | | (NonCA-BFInt) | |
| 3 | Does the BF title describe what one or more BU's are | BF #3: | n/a |
| | performing or providing in terms of ‘risk management’ | Enterprise Control Functions | |
| | or ‘control related’ activities? | (EntWide-CS) | |

These questions help categorize the business function or control activity that is under consideration into the proper logical parent entity, as described below.

### Parent Entity 1: Business Function—Scoring Non Control Activity (BF #1 & BF #2)

As shown in the list in FIG. 4A, and in more detail in the diagram of FIG. 4B, the first logical parent entity in the BPB is the Non-Control Services entity. The logical parent entity is used in breaking down and analyzing the risk assessment and reporting in the ART system. Generally, each parent entity model is comprised of the database entries for the business functions, controls, and risk factors that are deemed associated with that entity. However, some of the logical parent entities, such as 6 and 7, are structured differently. Together, they form the logical entity model of the Best Practices Bank in a preferred embodiment. It should be understood that while the preferred embodiment uses seven logical parent entities as described herein, this is not limiting and other embodiments may use fewer or more entities which may be structured differently.

The Non-Control Services entity (Parent Entity 1), consists of, or represents, all of the business functions within the bank that operate non-control services such as loans or deposit taking, for example. The data structure for Parent Entity 1 includes data representing a plurality of business functions having the logical structure depicted in FIG. 4B. These functions make up BF#1, 3^{rd} Party Services, and BF#2, Internal Services, as described above. While the Parent Entity 1 data is logically related as shown in FIG. 4B, it is comprised of a data structure such as that shown in FIG. 4M.

As shown in FIG. 4M, the Parent Entity 1 includes a plurality of data structures each representing a business function that falls within Parent Entity 1. While the diagram shows two business functions, a typical bank will have many dozens or over one hundred business functions. However, the systems and methods described herein may of course be employed to characterize less than all parts of a functioning bank. Each depicted business function data structure includes some indicator, implemented as a data field or group of fields, indicting the location of the business function in the bank hierarchy. The preferred version uses the Division→Department→Business Unit→Business Function organization described herein, and may therefore include a separate field identifying each of these. The business function data structure preferably includes some indicator of its business function use category as described herein, which is used in the ART system to place the business function into the proper Parent Entity for analysis. Next, the business function data structure includes a description of the business function, which is at least one text field (or identifier related to a text field) and may be more than one.

Each depicted business function data structure further includes one or more risk factor fields or data structures, which indicate risk factors that affect the business function as discussed herein. In a preferred embodiment, the risk factors are stored in a Risk Factor Table (FIG. 8A-E) and are logically linked to their related business function. The preferred database design used herein employs a many-to-many table (shown in FIG. 8D and titled CLTz8MMBusFuncSTDRiskFactors) to relate the risk factors to their associated business functions. However, this is not limiting and other data structures may, of course, be used to achieve the logical relationship depicted here. In a preferred version, each risk factor includes a description data field. Each risk factor also preferably includes some indicator of a weight associated with the risk factor, and some indicator of a score associated with the risk factor. Some embodiments may include more complex scoring parameters as further described herein. The risk factors may have one or more control activities associated with them, as found in the depicted risk factors. Also in the preferred database embodiment, these control activities are stored in a control activity table and logically linked or associated with their respective risk factors. As those of skill in the art will appreciate after understanding this disclosure, this design is not limiting and the depicted logical relationships may be captured in any number of ways with various data structures.

In addition to the data fields discussed above, as part of the control reports provided in the ART system, each of the Business Function Titles defined within BF#1 and BF#2 above are given summary scores, which will be further described below, especially with regard to FIG. 6, with regard to how scores are generated.

Inherent Risk Score

Mitigation %

Control Weakness Score

Final Residual/Accepted Risk Score

Labor Costs to Perform the BF

These scores are preferably scored in data fields related to the business function. FIGS. 8A-F are inter-connected parts of an SQL schema for database tables implementing the parent entity structure and its associated scoring parameters as described herein. The figures are connected by the lines labeled with capital letters. This schema represents only one embodiment and other versions may use other database designs, or be implemented with other data structure technologies not generally considered as databases, such as XML data storage, or spreadsheets. The data gathering and input process for populating these fields with data is discussed further herein, for example with regard to FIGS. 5B and 5C.

### Parent Entity 2: Enterprise Control Functions (BF #3)

FIG. 4C shows a diagram of the second logical parent entity in the BPB model structure, the Enterprise Control Functions. FIG. 4N shows an example data structure implementing Parent Entity 2. This Parent Entity includes stand alone risk management or control activities that are not related to a specific service in the bank (as the term service is used herein), but are nevertheless performed by a specific department in the bank. Given that the Enterprise Control Functions are stand alone risk management/control duties that are performed by specific departments in the bank, there are no Risk Factors to be assessed in their execution. Therefore, the diagram does not include risk factors in this embodiment. However, the ART system does score the risk management function in various ways via the ‘Regulation Risk Matrix’. Note: see Regulation Risk Matrix in the Stack Rank Scoring table below for more description on the operation of the Regulation Risk Matrix.

As shown in FIG. 4N, and described in more detail in the preferred database design of FIGS. 8A-F, the Parent Entity 2 data structure includes a plurality of business functions. These are preferably stored in the art system similarly to the way those business functions in Parent Entity 1 are stored. Each depicted business function data structure includes some indicator, implemented as a data field or group of fields, indicting the location of the business function in the bank hierarchy. The preferred version uses the Division→Department→Business Unit→Business Function organization described herein, and may therefore include a separate field identifying each of these. The business function data structure preferably includes some indicator of its business function use category as described herein, which for Parent Entity 2: Enterprise Control Functions will be BF#3 in the nomenclature used herein. Next, the business function data structure includes a description of the control activity, which is at least one text field (or identifier related to a text field). As shown next, the business function data structure includes a description of the control activity objective, which is further discussed below. Finally, if the control activity is related to (i.e. is for the purpose of complying with) some regulation, the data structure in Parent Entity 2 includes some indicator of a related regulation statement. In a preferred version, the same database tables used to store the data of Parent Entity 1 are employed to store the data comprising the depicted data structure for Parent Entity 2.

In a preferred embodiment, the depicted data structure will also include, for each business function, the following additional indicators:

Frequency Performed

Time to Perform

Weakness

### Parent Entity 3: Enterprise Risk Management (ERM) Q&A Model

FIG. 4D shows a diagram of the third logical parent entity in the BPB model, the Enterprise Risk Management Q&A entity. This parent entity consists of, or represents, the enterprise-wide control functions operating within the bank. FIG. 4P is a block diagram of a data structure implementing Parent Entity 3 according to one embodiment. The data structure for Parent Entity 3 includes data representing a plurality of business functions having the logical structure depicted in FIG. 4D.

To understand the ‘ERM Q&A Model’ a definition and context of Enterprise Risk Management (ERM) is appropriate. Broadly speaking, ERM within financial institutions can be defined as an entity wide approach/framework by which the governance entities (namely the Board of Directors and Executive Management) effectively deal with uncertainty and its associated ‘risk and opportunity’; and thereby enhance the Bank's capacity to build value for the stakeholders. Proper ERM governance directed from the board and senior management typically involves the following:
Setting corporate objectives
Aligning corporate objectives, activities and behavior with the expectation that the institution will operate in a safe and sound manner and in compliance with applicable rules
Understanding what are the risks involved with the business and making sure the risks are managed
Making sure the day to day business is operated in a safe and sound manner to protect depositors
Making sure there is transparency in financial and operational reporting for stakeholders

Based on numerous regulatory mandates that have been levied upon financial institutions that originated from laws such as the Sarbanes-Oxley Act of 2002 and the Gramm—Leach—Bliley Act (GLB) of 1999, a particular ERM framework emerged to help comply with the regulations namely the ‘COSO ERM Framework’. According to COSO, within their executive summary entitled “Internal Control—Integrated Framework,” ERM consists of five interrelated components. The executive summary continues by stating, “These are derived from the way management runs a business, and are integrated with the management process. Although the components apply to all entities, small and mid-size companies may implement them differently than large ones. Its controls may be less formal and less structured, yet a small company can still have effective internal control.”

The ERM components as listed by COSO are:

1—Control Environment

2—Risk Assessment

3—Information and Communication

4—Control Activities

5—Monitoring

The concept behind the ‘Enterprise Risk Management Q&A Model (ERM-QA)’ employed in the ART system is to take the (5) ERM COSO components and establish ‘Best Practice Principles’ within each of the categories. These principles are categorized (within each of the ERM components) based on a three-tier hierarchy starting with a: (1) general process statement; (2) then a high level action statement; (3) then ending with a detailed ‘Action Statements’, as outlined in the Table below.

TABLE 3
ERM Q&A Model Concepts

| ERM Q&A Model | |
|---|---|
| Concepts | Example |
| COSO ERM Component | Control Environment |
| Tier #1: ‘General Process | Organization and Authority |
| Stmt.’ | |
| Tier #2: ‘High Level Action | Organization Policies & Procedures |
| Statement’ | |
| Tier #3: ‘Detailed Action | Organization policies such as conflict of |
| Statement’ | interest are adequately communicated |
| | throughout the organization. |

The Tiers #1 and #2 are conceptually the ‘Q’, or question, in Q&A; and the last tier namely the ‘Detailed Action Statement’ is the ‘A’ or answer. The value proposition for a Bank in implementing the ERM Q&A Model is to provide management a list of ERM related principles that should be functioning within the Bank and give them a Best Practice ‘Detailed Action Statement’ (i.e. answer) of what management should consider implementing as a component of their ERM framework.

Each component of the model listed in the table above appears in the example data structure of FIG. 4P. In a preferred embodiment, the database table design provided herein at FIGS. 8A-F may be employed to also store the depicted data structure. Such a scheme may be implemented, for example, by repurposing the Division, Department, BU, and BF fields to hold the ERM Q&A Model Tier #1-Tier #4 statements, respectively. Other designs may of course use dedicated database fields, or XML data structures without the use of traditional databases, for example, in implementing the data structures described herein. Depicted after the Detailed Action Statement in FIG. 4P is an indicator of one or more related BFs and an indicator of one or more related CAs. These indicators allow the client bank ERM activities to be characterized by what functioning Control Activities or Business Functions they relate to. They also allow the BPB bank model to store associated CAs or BFs that function in the best practices model, and thereby assess the gaps between the BPB model and the functioning bank activities captured in the CA-GA. Shown next in each ERM Q&A business function data structure is an indicator of one or more related COSO framework elements. These indicators allow the BPB model and the assessment data in client bank to reflect how various ERM activities link to individual requirements of the COSO framework. Shown next is an indicator of a related compliance statement. These indicators allow the BPB model and the assessment data in client bank to reflect how various ERM activities link to compliance statements as used herein in the Parent Entity 7 formal regulations model (FIG. 4H).

As with all of the data structures herein, the Parent Entity 3 data structure is preferably implemented through database tables (for example in one or more SQL databases) but may also be implemented, for example, with XML data structures for each of the elements described. The depicted data structure has, of course, been simplified down to basic elements in order to better explain the present embodiment. A typical implementation will include more data fields in implementing the ERM Q&A model. The example database schema for one preferred implementation, which is shown as previously mentioned in FIGS. 8A-F, includes the following fields related to Parent Entity 3: Enterprise Risk Management Q&A Models:
Objective—General ‘Control Statement’ using control language that describes what the objective is regarding the control.
DB field name: ControlObjective
   Policy Title normally related to this activity
   DB field name: CLTPolicyTitlelD and STDPolicyTitlelD in BPB
   Regulatory Control YN
   DB field name: RegulatoryControlYN
Time to perform data
DB field name: various fields as outlined in ‘FIG. 7F’
   Execution Complexity (HML)
   DB field name: ExecutionDcultyComplexity5310
   Time Constraint Variability (HML)
   DB field name: TimeConstraintVariabilty5310
   Performed by Title—The BPB provides a user title that typically performs the BF
   DB field name: PerformedByTitlelD

The following table describes the phases that a client bank typically passes through to employ the ERM-QA Model in use in the ART system.

TABLE 4
Phases of ERM Q&A Model

| Phase | What is performed | How |
|---|---|---|
| 1 | Map Tier #3 statements from the Best Practice | Multi Select Table |
| | Bank that are currently functioning | |
| 2 | Edit the Tier #3 statement descriptions to more | Text Editing |
| | closely mirror the actual activities of the Bank | |
| 3.1 | (1) Associate one or more ‘Parent Entities’ to each | (1) Drop Down List with filtering and |
| | Tier #3 statement | Multi-select capabilities |
| | (2) provide a description for how the association | (2) Text Editing |
| | supports the Tier #3 statement. | |
| 3.2 | Upload any supporting documentation (i.e. Word | ‘Document Upload’ User Interface |
| | docs or images etc.) | |
| 4 | Via appropriate risk assessments, identify Tier #3 | (1) Multi Select Table of all the Tier |
| | statements from the BPB that should be | #3 statements that were not |
| | implemented and move them through ART's ‘Bank | selected in Phase #1 |
| | Initiative Process’ provided via ART2. | (2) these Tier #3 statements can |
| | | managed via the module in ART2 |
| | | titled ‘01.2_BI Input - Committee or |
| | | Formal Meeting. |
| 5 | Regularly review the Bank's ERM posture. | Perform Phase #3 |
| | Audit Firm continuously updates the contents of the | |
| | BPB | |

The Enterprise Risk Management Q&A Model is not a functioning ERM Framework rather it is a tool that can help a bank's governance staff identify gaps in their ERM activities. The present ERM-Q&A Model defines not only what the bank is performing against the COSO ERM Categories, but also direct links to the actual ‘Parent Entity’ infrastructure that is supporting the statements.

Parent Entity 4: Outsourcing Engagements with Third Party Firms

FIG. 4E shows a diagram of the next logical parent entity in the BPB model, Outsourcing Engagements with Third Party Firms. FIG. 4Q is a block diagram of a data structure implementing Parent Entity 4 according to one embodiment. While the term “outsourcing engagement” is used, the system may not have a separate entry for each engagement, and may for example split up larger engagements into smaller activities for which risk may be better characterized. The BPB model employed the ART system provides a comprehensive list of Outsourcing Activities that a bank might choose. In a preferred version, the list is grouped by two Outsourcing Categories; namely, ‘Business Process Outsourcing (BPO)’ and ‘Information Technology Outsourcing (ITO)’. Each ‘Outsourcing Title’ within these categories is given a set of unique Risk Factors (see below) that are tailored to the circumstances inherent to outsourcing arrangements. Within the BPB, each of the risk factors are given (based on the Audit Firm's judgment) an appropriate set of control activities to mitigate the risk.

As depicted in FIG. 4Q, an example data structure implementing Parent Entity 4 includes a plurality of data structures each representing an outsourcing activity that falls within Parent Entity. While the diagram shows two outsourcing engagements, of course more are typically present. Each depicted outsourcing engagement data structure includes some indicator, implemented as a data field or group of fields, indicting the location of the outsourcing activity in the outsourcing hierarchy as described below. As shown in FIG. 4E, one implementation of this structure may repurpose fields in the example database herein to store the depicted data. That is, the Div, Dep, BU, and BF fields may be repurposed to hold the depicted indicators regarding outsourcing. The Risk Factor table and Control Activity Table may then be used seamlessly to characterize and score risk for outsourcing activities. The outsourcing engagement data structure preferably includes some indicator of its business function use category as described herein, which for this Parent Entity will have a value indicating outsourcing activity. Next, the business function data structure includes a description of the outsourcing activity itself, which is at least one text field (or identifier related to a text field) and may be more than one, describing what is being outsourced.

Each depicted outsourcing engagement data structure further includes one or more risk factor fields or data structures, which indicate risk factors that affect the business function as discussed herein. In a preferred embodiment, the risk factors are stored in a Risk Factor Table (FIGS. 8A-F) and are logically linked to their related business function, using the same techniques employed in the Parent Entity 1 data structure discussed above. However, this is not limiting and other data structures may, of course, be used to achieve the logical relationship depicted here. In a preferred version, each risk factor includes a description data field. Each risk factor also preferably includes some indicator of a weight associated with the risk factor, and some indicator of a score associated with the risk factor. Some embodiments may include more complex scoring parameters as further described herein. The risk factors may have one or more control activities associated with them, as found in the depicted risk factors. Also in the preferred database embodiment, these control activities are stored in a control activity table and logically linked or associated with their respective risk factors. As those of skill in the art will appreciate after understanding this disclosure, this design is not limiting and the depicted logical relationships may be captured in any number of ways with various data structures.

Mapping Outsourcing Sub-Categories from the Best Practice Bank

After an audit firm conducts a ‘Control Activity Gap Assessment’, the client selects all the ‘outsourcing sub-categories’ that are in-effect. And for each outsourcing arrangement the following is obtained:

Vendor Name

Date of Engagement

Current Engagement Contract End Date

Monthly avg of prior billing

Expected monthly avg of future billing

Upload engagement contract

Note: the calculation and final risk score of each outsourcing title is identical to the Risk Score Methodology and Calculation employed herein. The tables below provide the Outsourcing Primary Categories and Sub Categories.

TABLE 5
Business Process Outsourcing Categories
Business Process Outsourcing (BPO)

Accounts Payable
Accounts Receivable
Administration
Billing
Bookkeeping
Call Centre
Claims Processing
Contract Management
Customer Service
Due Diligence
Maintenance
Financial Services
Graphics
Human Resources
Logistics
Payroll
Procurement
Public Relations
Relationship Management
Sales & Marketing
Staffing
Strategy & Analysis
Supply Chain Management
Telecommunications

TABLE 6
Information Technology Outsourcing Categories
Information Technology Outsourcing

Application Development
Application Hosting
Application Management
Contingency Planning
CRM
Data Warehousing
Database Development
Database Management
Desktop Management
Disaster Recovery
ERP
Hardware Support
Help Desk
Network & Systems Management
Networking
Security
Server
Software Development
Staffing
Storage Management
Web Development
Web Hosting
Web Management
Wireless

The table below provides a summary of the various risk factors included in the ART system to measure outsourcing risk, along with the weight assigned each risk factor and the criteria used to determine its presence. (Source: Basel Committee on Banking Supervision (Outsourcing in Financial Services—February 2005.))

TABLE 7
Outsourcing Risk Factors and Corresponding Criteria and Weight

| | Risk Factor | Weight | Risk Factor Criteria |
|---|---|---|---|
| 1 | Strategic Risk | 3.0 | The third party may conduct activities on its own behalf which |
| | | | are inconsistent with the overall strategic goals of the |
| | | | regulated entity. |
| | | | Failure to implement appropriate oversight of the outsource |
| | | | provider. |
| | | | Inadequate expertise to oversee the service provider. |
| 2 | Reputation Risk | 2.5 | Poor service from third party. |
| | | | Customer interaction is not consistent with overall standards |
| | | | of the regulated entity. |
| | | | Third party practices not in line with stated practices (ethical |
| | | | or otherwise) of regulated entity. |
| 3 | Compliance Risk | 3.0 | Privacy laws are not complied with. |
| | | | Consumer and prudential laws not adequately complied with. |
| | | | Outsource provider has inadequate compliance systems and |
| | | | controls. |
| 4 | Operational Risk | 3.0 | Technology failure. |
| | | | Inadequate financial capacity to fulfill obligations and/or |
| | | | provide remedies. |
| | | | Fraud or error. |
| | | | Risk that firms find it difficult/costly to undertake inspections. |
| 5 | Exit Strategy | 2.5 | The risk that appropriate exit strategies are not in place. This |
| | Risk | | could arise from over-reliance on one firm, the loss of |
| | | | relevant skills in the institution itself preventing it bringing the |
| | | | activity back in-house, and contracts which make a speedy |
| | | | exit prohibitively expensive. |
| | | | Limited ability to return services to home country due to lack |
| | | | of staff or loss of intellectual history. |
| 6 | Counterparty | 2.0 | Inappropriate underwriting or credit assessments. |
| | Risk | | Quality of receivables may diminish. |
| 7 | Country Risk | 2.5 | Political, social and legal climate may create added risk. |
| | | | Business continuity planning is more complex. |
| 8 | Contractual Risk | 1.5 | Ability to enforce contract. |
| | | | For offshoring, choice of law is important. |
| 9 | Access Risk | 2.0 | Outsourcing arrangement hinders ability of regulated entity to |
| | | | provide timely data and other information to regulators. |
| | | | Additional layer of difficulty in regulator understanding |
| | | | activities of the outsource provider. |
| 10 | Concentration | 2.5 | Overall industry has significant exposure to outsource |
| | and Systemic | | provider. This concentration risk has a number of facets, |
| | Risk | | including: |
| | | | Lack of control of individual firms over provider; and |
| | | | Systemic risk to industry as a whole. |

### Parent Entity 5: Application System Services

FIG. 4F shows a diagram of the next parent entity in the BPB model, the Application System Services entity. Within the BPB, internal controls are often performed by an automated system or platform. The ART system allows client banks to enter their application services, and characterize the associated risk factors and the complexity of setting up and operating the application service. It also allows the client bank to map their application services to those found in the model BPB. The Application System Services BPB within ART1 provides a generic list of typical ‘Application Systems’ that function within a Bank. For each application system, a list of normal ‘Application Services’ are documented, preferably using the hierarchy given below.

### Hierarchal Example of the BPB Application System:

Level #1: Division ('Information Systems')
   Level #2: Department: ('Application Systems')
      Level #3: System Title: ('Account Analysis System-Deposits')
         Level #4: Application Service: (New AA Vendor Setup')
            The primary risk in an application system is centered upon an improper setup of the Administrative Controls within the application.

FIG. 4L shows a database schema for implementing the Application Service entity functionality in one preferred embodiment. While a database schema is shown, this is not limiting and an application service data structure may be provided using other suitable technology such as, for example, XML. The following data-points are collected within the CA-GA assessment:

### BPB Data Points Assigned to Each ‘Application Service’:

1. Complexity of ‘Risk Oriented—System Admin Control Settings (RO-SACS)’
   a. Score of [H-5/M-3/L-1]
   b. High scores are based on various factors; namely, (1) the number of steps required relative to other Admin Control Settings, (2) how difficult it is to determine the appropriate settings for the application service.
   c. The score is preferably determined as part of the CA-GA process, and stored in the data structure associate with parent entity 5. The example data structure in FIG. 4L shows a data field 4306 storing this complexity score. The score may be populated automatically from the BPB model, and then adjusted by the bank personnel or auditor who is entering the bank data for the CA-GA. Or, the score may be entered initially as part of the assessment data gathering process if the application service being characterized does not have a match or near-match in the BPB model.
2. If the complexity rating is High or Med, then one or more Risk Factors are identified that might transpire due to inaccurate setup of admin settings
   a. The Risk Factors are given a predetermined ‘Risk Factor Weight (RFW)’ from 3.0 to 1.0 in 0.5 increments. The weight value is based on the Firm Auditor's judgment of the relative significance of the particular Risk Factor. The risk factor weight data field is shown in FIG. 4L as item 4304, and is initialized or updated as discussed above with regard to item 4306.
   b. Each associated Risk Factor is assigned a ‘Risk Factor Score (RFS)’ of ‘5-High’, ‘Moderate-3’, and ‘1-Low’. A ‘High’ score is warranted when due to improper admin settings it could result in a significant and harmful loss to the Bank (financially or reputation). The risk factor score data field is shown in FIG. 4L as item 4302, and is initialized or updated as discussed above with regard to item 4306.
      The above scores allow for the stack ranking of risk resulting from an improper setup of each Application Services admin settings. Given that the client bank at Step 504 (FIG. 5A), identified the Active Application Systems, a stack rank report can be provided to the Client Bank based on the following risk score calculation:

### Risk Score Calculation—Application Service Admin Control Setting Risk (AS-ACSR):

AS-ACSR Score={[RFW−#1*RFS#1]+[RFW−#2*RFS#2]+[RFW−#n*RFS#n]}*RO-SACS

Note: the calculation allows for more than one risk factor to be associated to a particular Application System.

### Application Service—Admin Control Setting Risk Scoring Reports (aka Control Setting Risk Report):

The Control Setting Risk Report presentation medium is the dynamic ASP.NET grid-view report such as the one described with respect to FIG. 5K and FIGS. 7A-F. An example embodiment of the Control Setting Risk Report is shown in FIGS. 4J and 4K. FIG. 4J shows a Level 1 view of the report labeled 4100. Each application system listed in the depicted report is given a complexity score as discussed above and a risk score. The report is filterable and sortable with drill-down capability. This functionality allows the user to review, filter, and sort the AS-ACSR Score by the parent ‘Application System’ and individually at the ‘Application Service’ level. The user is able to access the details of the risk score by clicking the appropriate web page hyperlinks and/or context menus. For example, the risk score field 4102 comprises an active link letting the user drill down to the Level 2 report view 4200 depicted in FIG. 4K. Level 2 view 4200 provides the calculation details and basis for the risk score shown on the Level 1 view 4100. Preferably, each ‘data view’ can be exported to PDF, Word or Excel at any stage of review and stack rank process.

### Parent Entity 6: Products and Related Services

FIG. 4G is a diagram of the next logical parent entity in the BPB model, the Products and Related Services entity. FIG. 4R is a block diagram of a data structure implementing Parent Entity 6 in one embodiment.

In order to understand the role of this model entity in the ART system, a few definitions are in order:

1. Product—When the ‘Service/Product’ model uses the term ‘Product’, it is referring to ‘Product Titles (PT)’. These product titles are short phrases (preferably 1 to 4 words) comprising a description of what is ‘Marketed’ toward 3rd party clients. In a preferred embodiment, Product Titles have a 2-tier hierarchy; the first tier is a general title and is meant to bring order to the 2nd tier which lists the actual ‘Product Title’. One characteristic of a ‘Product’ is that income is generated toward the Bank from the services that are rendered to 3rd parties external the Bank. Another way of understanding Products is as a ‘marketing brochure’ list of what the Bank's clients have as an option to purchase. The following table provides a sample of the two-tier structure described above:

TABLE 8
Product Tier Structure

| Parent (Tier 1) | Child (Tier 2 - Actual Product Title) |
|---|---|
| Loans | Commercial Loan - Line of Credit |
| Loans | Personal Mortgage Loan (1 to 4 family) |
| Loans | Agricultural Operating Line of Credit |
| Deposits | Demand Deposit |
| Deposits | Deposit Overdraft Protection |
| Deposits | Certificate of Deposit |
| Cash Management | ACH Payroll Distribution |
| Merchant Services | Merchant Remote Deposit Capture |
| Merchant Services | Merchant Card Services |
| Teller Services | Lockbox |

2. Service—The term ‘Service’ within this module is meant to describe what is performed or offered to 3rd parties external the Bank. External in the sense that a particular Bank ‘Business Unit’ (personnel or application system) is serving an external 3rd party by: (1) supporting and/or establishing ‘Product’ or ‘Service’ offerings or (2) establishing ‘Goodwill’ with the external 3rd party. Services within Parent Entity 6 are synonymous with the ‘Business Function Use’ titled ‘Non-Control Activity 3rd Party Service’ as outlined in the Overview of Hierarchal Structure.
3. Relationship of Product to Service—It is likely that many services are not associated to a product. In other words, 3rd parties (external the bank) are being served by the Bank in some manner but there is no ‘product title’ to associate with the ‘service’. It is also likely that one or more ‘services’ are related to one ‘product’. It is required that at least one ‘service’ be related to a ‘product’.

The ‘Service/Product’ model described above is employed in the ART system Parent Entity 6, and allows Bank management the ability to review risk and value based on the ‘product titles’ that the Bank offers. In this manner, the ART system provides not only risk scores, but value scores relating to the value of each product. To provide the value score, the client bank during the ‘Control Activity Gap Assessment’ is able to assign one or more GL's of the Bank to particular ‘Non-Control Activity 3rd Party Service’ Business Functions. After the GL is related to the BF's, then the user is able to assign a particular dollar amount of the monthly GL average. This GL mapping is both for income and expenses.

It is possible that a Service is not associated to a Product. In this case, the product description will be assigned a generic Product title; however, when drilling down to the children (i.e. services) all the services with no associated product will be presented with their corresponding scores. If the same BF/service is referenced from two different products, the score is counted in both product scores.

The data structured depicted in FIG. 4R may now be understood in light of the above description. The depicted Parent Entity 6 data structure includes a plurality of product data structures, each reflecting a product characterized during the assessment process discussed above. (The BPB bank model also contains a similar data structure reflecting the best practices model.) The depicted product data structure includes a product description field, which includes the Product Title describing, quite simply, what is sold for a profit by the client bank. Next, the product data field includes an indicator of one or more related BF#1 Services, which links or associates this product to its related Service(s) in the Parent Entity 1 data structure. Shown next in each Product data structure is an indicator of one or more related GL accounts or items. This link allows the GL account income or expense to be mapped to the Product as discussed above. Shown next is the monthly average income or expense associated with the Product, which is preferably calculated by summing the contributions from all related GL accounts.

A preferred implementation uses the database design shown in the schema of FIGS. 8A-F. The Product and Service related fields are shown in FIG. 8C.

### Parent Entity 7: Formal Regulations Model

FIG. 4H shows a diagram of the next model parent entity, the formal regulations model. The foundation of the Regulation Model begins with a comprehensive formal title listing of the government's regulatory code that governs the operation of the bank, and the code's corresponding references to the USC and CFR code sections. Over 100 formal titles are documented within ART. This parent entity model, in a preferred embodiment, is structured as a three-tier data structure including at the first tier the United States Code (USC) sections that provide the relevant governing law and a statement of the Code of Federal Regulations (CFR) that provide the federal rules implementing the USC; at the second tier the formal regulations model provides a Regulation Statement detailing exactly what is the responsibility of the bank in complying with the regulations; and at the third level characterizes the control activities that are present in the Best Practice Bank model to implement compliance with the associated regulation. The table below shows a sample of the Information provided at the first level:

TABLE 9
Sample Data -- Formal Top Level Regulation Listing

| | | Informal | | | | Regulation |
|---|---|---|---|---|---|---|
| | | Name | | | | Type |
| Formal | Letter | (Street | | USC | CFR | (general |
| Name | Code | Name) | General Requirements | Section | Section | area) |
| Extension of | A | Not | Governs extensions of credit to | Federal | 12 CFR | Lending |
| Credit by | | Assigned | banks by the Federal Reserve Bank | Reserve | 201 FRB | |
| Federal | | | (FRB). Includes discount window, | Act various | | |
| Reserve Bank | | | adjustment credit, extended credit, | sections | | |
| | | | or emergency credit. | | | |
| Unfair or | AA | Not | Defines unfair and deceptive credit | 15 USC | 12 CFR | Lending |
| Deceptive | | Assigned | practices and acts. Requires | 57(a)f; 15 | 227 FRB; | |
| Acts or | | | specific disclosures to cosigners; | USC 41 | 12 CFR | |
| Practices | | | forbids confessions of judgment, | FTC Act | 535 OTS | |
| | | | wage assignments, and prohibits | | | |
| | | | the taking of non purchase money | | | |
| | | | security interest in household | | | |
| | | | goods. | | | |
| Equal Credit | B | Not | Prohibits credit practices that | 15 USC | 12 CFR | Lending |
| Opportunity | | Assigned | discriminate on the basis of race, | 1691 | 202 FRB | |
| Act | | | color, religion, national origin, sex, | | | |
| | | | marital status, age, receipt of public | | | |
| | | | assistance or the fact that the | | | |
| | | | applicant has exercised any right | | | |
| | | | under the Consumer Credit | | | |
| | | | Protection Act. Rules cover | | | |
| | | | advertising, credit applications, | | | |
| | | | adverse action notices, appraisals, | | | |
| | | | etc. | | | |
| Home | C | Not | To provide regulators and the | 12 USC | 12 CFR | Lending |
| Mortgage | | Assigned | public with loan data that can be | 2801 | 203 FRB | |
| Disclosure | | | used to determine whether banks | | | |
| Act | | | are serving the credit housing | | | |
| | | | needs of their communities. | | | |
| | | | Requires lenders to maintain a | | | |
| | | | Loan Application Register (LAR) as | | | |
| | | | a mechanism to report the data. | | | |

At the second level of the Formal Regulations Model entity, each ‘Formal Regulatory Title’ is mapped to one or more Regulation Statements. The ART system collects various data points for each Regulation Statement; as the following table shows:

TABLE 10
Data Collected for each Regulation Statement

| | | Source of | | |
|---|---|---|---|---|
| | Information | Data | | |
| | Collected | Collection | Details | Why Important |
| 1 | Compliance | Audit Firm | General statement consisting of no more than a | Provides an action |
| | Statement | (BPB) | few sentences that outlines the regulatory | statement of the |
| | | | responsibilities of the Bank. | compliance goal |
| | | | The statement is action/goal oriented and its | |
| | | | scope is ‘singular’ in terms of implementation | |
| | | | status. ‘Singular’ meaning that the scope of the | |
| | | | statement is narrowed down to the point where | |
| | | | when the Bank is determining whether a | |
| | | | particular event/transaction is ‘compliant’ with | |
| | | | the ‘Regulation Statement (RS)’, there is NO | |
| | | | opportunity for two or more elements of the RS | |
| | | | to possess differing compliance status. | |
| 2 | Related To External | Audit Firm | n/a | This helps in back- |
| | Service (Y/N) | (BPB) | | end reporting |
| 3 | Rule Section | Audit Firm | Formal Rule/Code relating to the Compliance | Allows for detailed |
| | | (BPB) | Statement (i.e. 15 USC 1691) | reporting |
| 4 | Rule Sub Section | Audit Firm | Formal Rule/Code sub sections relating to the | Allows for detailed |
| | | (BPB) | Compliance Statement (i.e. particular notations | reporting |
| | | | that indicate sub section ranges) | |
| 5 | one or more | Audit Firm | direct links to the sub section code. | Allows the client to |
| | hyperlinks to ‘rule sub | (BPB) | | review the source |
| | section’ | | | regulatory code |
| 6 | Execution | Audit Firm | Subjective score -- Each RS is scored (High—5, | High score is an |
| | Difficulty/Complexity | (BPB) | Med—3, Low—0) for how ‘difficult and complex’ | indication of high |
| | (H/M/L) | | it is for the Bank to comply with the RS. | compliance risk |
| 7 | Reg Impact Non | Audit Firm | Subjective score -- Each RS is scored (High—5, | High score is an |
| | Compliance (H/M/L) | (BPB) | Med—3, Low—0) for the impact to the Bank if | indication of high |
| | | | there is non-compliance. | compliance risk |
| 8 | High Regulatory | Client via | This data point is collected initially when an | (1) High score is an |
| | Scrutiny During Past | ‘CA Gap | audit firm conducts a ‘Control Activity Gap | indication of future |
| | Exams | Assessment’ | Assessment’ toward a client Bank and going | scrutiny |
| | (Date of exam/ | | forward annually. | (2) greater audit |
| | regulatory body) | | The client identifies particular ‘Regulation | and compliance |
| | | | Statements’ that were given high levels of | review should be |
| | | | regulatory scrutiny. The reason for the scrutiny | given to this RS if a |
| | | | can be of ‘client origin’ or just shifts in | ‘high’ rating is in |
| | | | regulatory exam practices. | conjunction with a |
| | | | For each item identified, the date of the exam | ‘high’ ‘Reg Impact |
| | | | and regulatory body is recorded. | Non-Compliance’ |
| | | | | score. |
| 9 | Key Personnel | (1) Audit Firm | The BPB identifies particular RS's that score | (1) for high score |
| | Reliance | (BPB) | (High—5, Med—3) for the impact to the short | RS's a bank might |
| | (Score and up to two | (2) Client via | term compliance of the RS if key personnel were | have some strategy |
| | users identified as | ‘CA Gap | to leave the Bank. | in place to mitigate |
| | key) | Assessment’ | The client is able to identify up to (2) users as | the risk |
| | | | key personnel for each RS. | |
| 10 | Regional Regulatory | Audit Firm | It is common for Audit Firms, following a | (1) High score is an |
| | Focus (National) | (BPB) | regulatory exam, to receive feedback from | indication of future |
| | | | Bank clients regarding what regulatory areas | scrutiny |
| | | | (i.e. Regulation Statements) were of ‘high | (2) greater audit |
| | | | focus/scrutiny’ during the exam. Feedback of | and compliance |
| | | | ‘high focus’ areas differ according to the | review should be |
| | | | following variables: (1) which regulatory body | given to this RS if a |
| | | | performed the exam (i.e. FDIC, OCC, State | ‘high’ rating is in |
| | | | etc.); (2) regional location of regulatory body | conjunction with a |
| | | | (i.e. SW, East etc.). ART provides the Audit | ‘high’ ‘Reg Impact |
| | | | Firm an interface to document the ‘high focus’ | Non-Compliance’ |
| | | | areas given the (2) variables mentioned prior. | score. |
| | | | ART is able to determine which region and | |
| | | | regulator body the client Bank is under and | |
| | | | pass the ‘high focus’ scoring (High-5, Med-3, | |
| | | | Low-0) to the appropriate Regulation | |
| | | | Statements. | |
| 11 | Regional Regulatory | Audit Firm | Some Banks are examined both by national | (1) High score is an |
| | Focus -- if applicable | (BPB) | regulatory bodies (i.e. FDIC) and by their ‘State’ | indication of future |
| | (State) | | regulatory agency; ART allows for ‘Regulatory | scrutiny |
| | | | Focus’ scoring to be given for both. | (2) greater audit |
| | | | | and compliance |
| | | | | review should be |
| | | | | given to this RS if a |
| | | | | ‘high’ rating is in |
| | | | | conjunction with a |
| | | | | ‘high’ ‘Reg Impact |
| | | | | Non-Compliance’ |
| | | | | score. |

At the third level of the Formal Regulations Model entity, each Regulation Statement is mapped to one or more Control Activities (CA). The model at this level therefore includes, at a minimum, an indicator of related control activity(ies) linking to one or more of any Parent Entity's (i.e. PE #1, 2, 3, or 4) associated control activity functioning at the client bank, or a statement describing the associated CA. These CA's are the actions/processes that are performed throughout the Bank to comply with the ‘Regulation Statement’. If each Control Activity is performed properly, the Bank has a high assurance that it is ‘in compliance’ in regard to the original Regulation Statement.

Often more than one Control Activity will be related to a particular Regulation Statement. In this case, the ART system assigns each CA a ‘Compliance Impact Score (CIS)’. Generally, the score is an indicator of how much the control effectuates or the extent to which it can be said to place the bank in compliance (i.e., does the activity cause the bank to be compliant, contribute to the compliance, or is it merely related to compliance without being critical to compliance). In one embodiment, the CIS score is represented by a bit ‘data type’ (i.e. ‘true’/‘false’/‘NULL’).
A ‘true’ CIS score means that if this CA is performed then the Bank is compliant with the Regulation Statement.
A ‘false’ CIS score means that the CA contributes to the final CA that is given a CIS score of ‘true’ (i.e. that this CA is critical to allow the final CA to be performed).
A ‘NULL’ CIS score means that this CA is not critical to the Bank's compliance with the Regulation Statement but is performed for one reason or another.
Only one CA can be given ‘true’ score
Each CA is given a sequence ID that defines the order in which the CA's are performed to establish compliance with the ‘Regulation Statement’.

### Stack Rank Scoring Tables

As discussed above, after an audit firm conducts a ‘Control Activity Gap Assessment’, the client is able to review the assessment report and stack rank various items in the report. Described below is a preferred implementation of the scoring scheme herein, which provides ability to stack rank on four (4) specific aspects of the Bank. The presentation medium for reviewing each ‘Bank Aspect’ and the related scores is the dynamic ASP .NET grid-view report such as the one described with respect to FIG. 5K and FIGS. 7A-F. The report is filterable and sortable with drill-down capability. This functionality allows the user to review, filter, and sort the primary scores and the detail of the primary scores by clicking the appropriate web page hyperlinks and/or context menus. Each ‘data view’ can be exported to PDF, Word or Excel at any stage of review and stack rank process. The four reportable aspects and their corresponding scoring elements are described in detail in the Table below. (The bracketed footnotes numbers are matched with notes following this table).

TABLE 11
Stack Rank Scoring

| | Primary Scores | Children Scores [1] | Comments |
|---|---|---|---|
| 1. Hierarchal | Level 1: Grouped by: | Level 2: The following is provided for each Risk Factor | This represents BF's |
| Services | Business Function | 1.1a Risk Factor Description - tbl3 | performed by particular |
| Performed | 1—Inherent Risk score | 1.1b Each Risk Factor Score (5-1) - tbl2 | Business Units of the Bank |
| (non-control) | 1.2—Control Mitigation | 1.1c Each Risk Factor Weight (5-1) - tbl3 | that benefit/serve either |
| | Score (contra) [1.2] | 1.1d Inherent Risk Score | external 3rd parties or |
| | 1.3—Control Weakness | 1.1e # of CA's | internal parties. |
| | Score (Add back) [1.3] | 1.1f Initial Mitigation Percentage | |
| | 1.4—Final Residual Risk | 1.1g Residual Risk Score (before CA weakness factor) | |
| | Score [1.4] | 1.1h Mitigation Markdown Percentage (MMP)/# of | |
| | 1.5—Mitigation | Defense Layers | |
| | Percentage [1.5] | 1.1i Mitigation Percentage (after MMP) | |
| | 1.6—Weighted Risk | 1.1j Final Residual/Accepted Risk Score | |
| | Factor Trend [1.6] | 1.1k Risk Factor Trend | |
| | 2. Monthly avg. cost of | Level 3: The following is provided for each CA within | |
| | personnel time to | the RF: | |
| | perform BF | 3.1a CA Type (Normal/Critical/Key) | |
| | 3.1 Overall Total # of | 1.3a Each ‘control item element’ that contributed to | |
| | CA's/Weakness pts. | the weakness score - tbls 4&8 | |
| | per CA | 1.3b Total Weakness Points - tbl4 | |
| | 3.2 Monthly avg. cost of | 1.3c Layered - Y₋ N/Percent Impact Exposure - tbl4 | |
| | personnel time to | 1.3d PIE score for each layered control | |
| | perform | 1.3e Monthly avg. cost of personnel time to perform | |
| | 4.1 Total # of Critical | User clicks 1.3e (Level 3) | |
| | CA's/Weakness pts. | y.1 Type of Item performed (i.e. Loan Document/ | |
| | per CA | deposit account etc.) - tbl8 | |
| | 4.2 Monthly avg. cost of | y.2 Frequency of occurrence (Daily/weekly/ | |
| | personnel time to | transactional etc.) - tbl8 | |
| | perform | y.3 if transactional, # of times performed daily - tbl8 | |
| | 5.1 Total # of Key CA's/ | y.4 Time to perform per item (Max/Min/Avg -- | |
| | Weakness pts. per CA | minutes) - tbl8 | |
| | 5.2 Monthly avg. cost of | -- see details: Calculation - ‘Personnel Time Cost’ | |
| | personnel time to | y.5 Estimated $ per minute for each of the 4-groups. - | |
| | perform | Notbl | |
| | 6.1 Total # of Regular | User clicks 3.2, 4.2, 5.2, and 6.2 - Based on ‘type’ of | |
| | CA's/Weakness pts. | control selected (the following is provided for each | |
| | per CA | CA in ‘type’ category: | |
| | 6.2 Monthly avg. cost of | z.1 Type of Item performed (i.e. Loan Document/ | |
| | personnel time to | deposit account etc.) | |
| | perform | z.2 Frequency of occurrence (Daily/weekly/ | |
| | Note: Each of the | transactional etc.) | |
| | ‘numerical statements’ | z.3 If transactional, # of times performed daily | |
| | above will be | z.4 Time to perform per item (Max/Min/Avg -- | |
| | represented in a table | minutes) | |
| | as ‘columns’; each | Sr. Level officers/Line level officers/Hrly wage High/ | |
| | column in the table will | Hrly wage low | |
| | have the option to sort | z.5 Estimated $ per minute for each of the 4-groups. | |
| | ‘ASC’ or ‘DESC’ | | |
| 2. Outsourced | Grouped by: | Identical to ‘children scores’ for #1 above | Client is able to stack rank all |
| Activities | Outsourced Activity | | outsourced activities by their |
| | Identical to ‘primary | | (1) relative risk; (2) their |
| | scores’ for #1 above (1 | | outsourcing cost and (3) cost |
| | to 6.2) | | of personnel time to |
| | 7. Cost of outsourcing | | maintain the due diligence |
| | [13] | | controls over the |
| | Note: Each of the | | outsourcing arrangement. |
| | ‘numerical statements’ | | |
| | above will be | | |
| | represented in a table | | |
| | as ‘columns’; each | | |
| | column in the table will | | |
| | have the option to sort | | |
| | ‘ASC’ or ‘DESC’ | | |
| 3. Products/ | Level 1: Grouped by | Note: [4] | |
| Services | ‘Product Title’ [2, 3] | Level 2: Grouped by Business Function | |
| Toward | Note: same scores as | List of BF/services that support the Product | |
| External 3rd | outlined in #1 above (1./ | (Note: summary information is identical to #1 primary | |
| Parties | 1.1/1.2/2/3.1-6.2) | scores above) | |
| | 3. GL Income (monthly | Level 3: for each BF clicked at ‘Level 2’ | |
| | avg.) | Note: the same scores as outlined in #1 above (1.1a to | |
| | 4. GL Cost (non | 1.1k/y.1 to z.5) | |
| | personnel) | 3a GL income directly related to this BF/Service | |
| | Note: Each of the | 4a GL cost directly related to this BF/Service | |
| | ‘numerical statements’ | — | |
| | above will be | — | |
| | represented in a table | | |
| | as ‘columns’; each | | |
| | column in the table will | | |
| | have the option to sort | | |
| | ‘ASC’ or ‘DESC’ | | |
| 4. Regulation | Level 1: Grouped by | Level 2: List of Regulation Statements | |
| Risk Matrix | ‘Formal Regulatory | 1a # of CA's used to comply with RS | |
| | Titles’ | 2a Monthly avg. cost of personnel time to perform all | |
| | 1. # of ‘Regulation | the CAs | |
| | Statements (RS)’ [5] | 3a the Scrutiny score for each RS | |
| | 2. Monthly avg. cost of | 4a the Complexity score for each RS | |
| | personnel time to | 5a the non-compliance impact score for each RS | |
| | perform the control | 6a The user name and score (concatenated string of | |
| | activities associated | User Name(s) and score) | |
| | with the RS's. | 7a Regulatory Focus score for each RS (National) | |
| | 3. High Regulatory | 8a Regulatory Focus score for each RS (State - if | |
| | Scrutiny During Past | applicable) | |
| | Exams Score [6] | Level 3: Row clicked from ‘level2’ | |
| | 4. Complexity Score [7] | The following is provided for each CA within the RS: | |
| | 5. Impact of Non- | 2a Type of Item performed (i.e. Loan Document/ | |
| | Compliance [8] | deposit account etc.) | |
| | 6. Key Personnel | 2b Frequency of occurrence (Daily/weekly/ | |
| | Reliance Score [9] | transactional etc.) | |
| | 7. Regional Regulatory | 2c if transactional, # of times performed daily | |
| | Focus (National) [10] | 2c Time to perform per item (Max/Min/Avg -- | |
| | 8. Regional Regulatory | minutes) - | |
| | Focus -- if applicable | -- Sr. Level officers/Line level officers/Hrly wage High/ | |
| | (State) [11] | Hrly wage low | |
| | 9. Control Weakness | 2d Estimated $ per minute for each of the 4-groups. | |
| | Score [12] | | |
| | Note: Each of the | | |
| | ‘numerical statements’ | | |
| | above will be | | |
| | represented in a table | | |
| | as ‘columns’; each | | |
| | column in the table will | | |
| | have the option to sort | | |
| | ‘ASC’ or ‘DESC’ | | |

The following points refer to the bracketed footnote numbers in Table 11.

1—Data points within the ‘Children Score’ column represent the details of what is summarized at the ‘Primary Score’ level.

1.2—Control Mitigation Score (contra): This score represents the initial risk mitigation based on the controls that are in place. It is scored by aggregating the total of each Risk Factor's ‘Inherent Risk Score’ times the Risk Factor's ‘Initial Mitigation Percentage’.

1.3—Control Weakness Score (Add back): This score represents how much ‘Inherent Risk’ is to be added back to the ‘Residual Score’ due to the weakness of the control structure. It is scored by first determining the Final Mitigation Markdown Percentage (FMMP) for each Risk Factor and multiplying it times the ‘Control Mitigation Score (1.2 above)’ for each Risk factor. Given the complexity of this scoring, it is beneficial to consider the information in this table further in view of the scoring process described below under the Risk Score Methodology and Calculation section and in FIG. 6.

1.4—Final Residual Risk Score: This score is the resulting risk i.e. the ‘Residual/Accepted Risk’ after the related controls and their weaknesses are taken into account.

1.5—Mitigation Percentage: This represents the percentage of the ‘Inherent Risk’ that has been mitigated by controls.

1.6—Weighted Risk Factor Trend: The client provides and assessment of ‘Risk Trend for each ‘Risk Factor’ by rating it according to the following scale: 5—Strongly Increasing; 4—Moderately Increasing; 3—Stable; 2—Moderately Decreasing; 1—Strongly Decreasing

2—It is possible that a service is not associated to a product. In this case, the product description will hold a generic title with no scores; however, when drilling down to the children all the ‘naked’ services will be presented with their corresponding scores.

3—If the same BF were referenced from two different products, the scores would be counted in both product scores.

4—Each product is mapped to one or more hierarchal Business Functions (non-control/BF #1).

5—‘Regulation Statements’: Each ‘Formal Regulatory Title’ is mapped to one or more ‘Regulation Statements’, which are defined as general statements consisting of a few sentences that outline the regulatory responsibilities of the Bank.

6—High Regulatory Scrutiny During Prior Exam Score: Based on the level of regulatory scrutiny and discussion toward particular ‘Regulation Statements’ in prior years, they are identified and scored by the client as ‘High Scrutiny’ (5 points).

7—Complexity Score: Given that each ‘Formal Regulatory Title’ is mapped to one or more Regulation Statements (RS), each RS is scored (High-5, Med-3, Low-0) for how ‘difficult and complex’ it is for the Bank to comply with the RS. These scores at this ‘child’ level are aggregated and presented to the ‘parent’ level.

8—Impact of Non-Compliance: Given that each ‘Formal Regulatory Title’ is mapped to one or more Regulation Statements (RS), each RS is scored (High-5, Med-3, Low-0) for the impact to the Bank if there is non-compliance. These scores at this ‘parent’ level represent an aggregate total of the ‘Regulation Statement’ scores.

9—Key Personnel Reliance Score: Given that each ‘Formal Regulatory Title’ is mapped to one or more Regulation Statements (RS), each RS is scored (High-5, Med-3, Low-0) for the impact to the short term compliance of the RS if key personnel were to leave the Bank. ART allows up to (2) users to be identified. These scores at this ‘parent’ level represent an aggregate total of the ‘Regulation Statement’ scores.

10—Regional Regulatory Focus: It is common for Audit Firms, following a regulatory exam, to receive feedback from Bank clients regarding what regulatory areas (i.e. Regulation Statements) were of ‘high focus/scrutiny’ during the exam. Feedback of ‘high focus’ areas differ according to the following variables: (1) which regulatory body performed the exam (i.e. FDIC, OCC, State etc.); (2) regional location of regulatory body (i.e. SW, East etc.). The ART system provides the Audit Firm an interface to document the ‘high focus’ areas given the (2) variables mentioned prior. The ART system is further able to determine which region and regulatory body the client Bank is under and pass the ‘high focus’ scoring (High-5, Med-3, Low-0) to the appropriate Regulation statements. These scores at this ‘parent’ level represent an aggregate total of the ‘Regulation Statement’ scores.

11—Banks are often examined both by national regulatory bodies (i.e. FDIC) and by their ‘State’ regulatory agency; the ART system allows for ‘Regulatory Focus’ scoring to be given for both.

12—Control Weakness Score: Each ‘Formal Regulatory Title’ is mapped to one or more Regulation Statements (RS) and each RS is mapped to one or more ‘Control Activities (CA)’. If each CA is performed properly, the Bank has a high assurance that it is ‘in compliance’ in regard to the original Regulation Statement. ART attempts to determine based on several variables a ‘Mitigation Markdown Percentage (MMP)’ for each CA. The score is provided as a percentage; 10% being ‘low in weakness’ while 90% would be very ‘high in weakness’.

13—Cost of Outsourcing: this is an anticipated monthly cost of each outsourcing arrangement based on the data collected as outlined in this section: Outsourcing Model—Best Practice Bank.

### The Scoring Process

FIG. 6 is a flow chart of a process for generating risk assessment scores that may be used in reports such as the CA-GA report discussed above. After an audit firm conducts the Control Activity Gap Assessment shown in FIG. 5, the client may assess the risk in more detail by using the risk scoring method illustrated in FIG. 6. In general, the process in FIG. 6 determines a ‘Residual Risk Score’ of a particular Business Function. This score is provided by first determining the BF's ‘Inherent Risk Score’; then reducing this score by an ‘Initial Mitigation Percentage Rate (IMPR)’ due to control activities; then adding back a ‘Control Weakness Score’ based on the ‘Mitigation Markdown Percentage (MMP)’ based on weaknesses of the control activities. The details of a preferred embodiment using the Inherent Risk Score, the IMPR, and the MMP are explained below.

At step 601, the process identifies a logical parent entity of the client bank being evaluated and assigns an appropriate set of Risk Factors associated with the parent entity. The parent entities are identified from the best practice bank (BPB) and include non-control business functions (BFs) and the BPB's outsourcing titles. There are two sets of Risk Factors: those associated with non-control BFs; and those associated with outsourcing BFs.

At step 602 in the process, bank auditors use their judgment to assess the risk of each related ‘Risk Factor’ and assign a corresponding Risk Factor Score (RFS) to each of the Risk Factors. In a preferred version, the RFS is based on a scale of 1 to 5, with ‘5’ corresponding to a high risk score, ‘3’ corresponding to a moderate risk score, and ‘1’ corresponding to a low risk score. The RFS is based on the overall nature, complexity, and volume of each of the processes being performed; this assessment of risk is made without considering risk management processes and controls. A “high” RFS is warranted when a disruption in the function of the Parent Entity could result in a significant and harmful loss to the client bank.

An exception to the above-described scoring process is the “Regulatory Risk” Risk Factor. In contrast to the other Risk Factors, the RFS for the “Regulatory Risk” factor is preferably determined using the procedure described below. First, bank auditors use their judgment to quantify a base point risk value corresponding to the “Regulatory Risk” Risk Factor, wherein the base point risk value is on a scale of 1 to 5, a ‘5’ representing the highest level of risk. As explained above with respect to the ART system provides the bank auditor with the ability to relate one or more CAs to each Risk Factor. The process then uses information regarding the Regulatory Focus and Regulatory Statements related to the CAs to modify the base point risk value into a “Regulation Risk” RFS. The details of this procedure are as follows:
1. If any of the CAs has a high “Regulatory Focus,” then the base point risk value is increased by 100%.
2. If any of the CAs has a medium “Regulatory Focus” AND none of the CAs has a high “Regulatory Focus,” then the base point risk value is increased by 50%.
3. If any of the Regulation Statements related to the CAs has received a “High Regulatory Scrutiny During Past Exams,” then the base point risk value is increased by 100%.
4. If any of the Regulation Statements related to the CAs has received an “Impact of Non-Compliance” score of “High,” then the base point risk value is increased by 100%.
5. If any of the Regulation Statements related to the CAs has received an “Execution Difficulty/Complexity” score of “High,” then the base point risk value is increased by 100%. It is noted that the “Regulatory Risk” RFS can assume a much larger numerical range than other RFSs. For example, a “Regulatory Risk” Risk Factor having a base point risk value score of 5 might also have risk value increases associated with high regulatory focus, high regulatory scrutiny, high impact of non-compliance, and high execution difficulty/complexity scores. In this case, each of the four risk value increases is 100% of the base point risk value score (5), so the total “Regulatory Risk” RFS could be as high as (5+5+5+5+5)=25. At the other extreme, a “Regulatory Risk” Risk Factor having a base point risk value score of 1 might have no associated risk value increases. In that case, the total “Regulatory Risk” RFS could be as low as (1+0+0+0+0). Thus, in contrast to the other RFSs, the “Regulatory Risk” RFS can potentially assume a value as high as 25 or as low as 1.

It should be noted that the process of modifying the base point risk value into a “Regulation Risk” RFS is an additive process, not a sequential multiplication process. That is, a base point risk value of 5 is increased by adding 50% or 100% increases to that base point value. The base point risk value is not increased, for example, by multiplying a base point risk value of 5 times 2 for “high regulatory scrutiny” risk increase, and then multiplying that product (10) times 2 for the “high impact of non-compliance” risk increase.

At step 603 in the process, bank auditors assign each risk factor a Risk Factor Weight (RFW) ranging from 1.0 to 3.0, in 0.5 increments. In a preferred embodiment, the RFW scores are assessed once (i.e predetermined), and the RFS scores are assessed on a per Parent Entity basis. The higher the RFW, the more a particular RFS will influence the final Inherent Risk Score that is assigned to a Parent Entity.

At step 604, the process calculates a Final Inherent Risk Score (FIRS) for each Risk Factor. The FIRS is equal to the sum of the product of each associated RFS with its corresponding RFW. In other words, FIRS=the sum of RFS*RFW for each RF.

An overall Inherent Risk Score may be calculated for each business function by adding the FIRS for each Risk Factor associated with that business function. For non-control service business functions, there are 19 possible Risk Factors that may be related to that Parent Entity type. Thus, for non-control service business functions, the overall Inherent Risk Score may reach a value of 60+212.5=275, wherein the 60 represents the FIRS associated with the “Regulatory Risk” RFS, and the 212.5 represents the sums of the FIRS associated with the other types of RFS. For the preferred embodiment described herein, for outsourcing titles, there are 11 possible risk factors that may be related to that Parent Entity type. Thus, for outsourcing titles, the overall Inherent Risk Score may reach a value of 60+122.5=182.5, wherein the 60 represents the FIRS associated with the “Regulatory Risk” RFS, and the 122.5 represents the FIRS associated with the other types of RFS.

At step 605, the process receives an indicator, typically through the web form interface, that one or more control activities (CAs) is associated with at least one of the set of risk factors, and the process assigns one or more control activities to the related risk factor which it mitigates.

### Accounting For Control Weaknesses

At step 606, the process determines an Initial Marginal Percentage Rate (IMPR) for each CA, the IMPR based on an assessment of how much the control activity mitigates its associated Risk Factor. During the Control Activity Gap Assessment, the client assesses whether each CA “fully mitigates” or “marginally mitigates” its associated Risk Factor. The details regarding the IMPR are as follows:
1. If ANY of the CAs related to a Risk Factor is given an assessment of “full mitigation,” then the IMPR is equal to 100%, and the Inherent Risk Score of the Risk Factor is fully mitigated.
2. If ALL of the CAs related to a Risk Factor are given an assessment of “marginal mitigation,” then the IMPR is calculated by multiplying a base of 20% times the number of “marginal” CAs. For example, if three CAs are assessed as “marginal,” the IMPR is 0.2+0.2+0.2=0.6, or 60%.

At step 607, the process calculates a total of Control Infrastructure Weakness Points (CIWP) based on a set of weakness point assignments associated with the CA. The CIWP is used to calculate a “markdown” of the IMPR. The following table lists the “weakness data points” for each CA and the corresponding weakness point value:

TABLE 12
Weakness Points

| CA Data Point | Point Assignment | Comments |
|---|---|---|
| Preventative or Detective | P = 0 pts. | A detective control is after the fact which weakens the |
| (P/D) | D = 1 pts. | full mitigation |
| Fully Automatic (Y/N) | Y = 0 pts. | Fully automatic in the sense that a Bank system is |
| Note: the following are | N = .5 pts. | performing the control (i.e. no human interaction is |
| only applicable if ‘N’ is | | required) |
| chosen | | |
| Execution Complexity (5- | High (5) = 2 pts. | Complexity - high scores are based on the # of steps; |
| 3-1) | Med (3) = 1 pts. | relative to other controls. |
| | Low (1) = 0 pts. | |
| Learning Curve (5-4-3-1) | Very High (5) = 3.5 pts. | Learning Curve - high score is based on how difficult it is |
| | High (4) = 2.5 pts. | it and how long it takes for the user to become proficient |
| | Med (3) = 1.5 pts. | in performing the control. |
| | Low (1) = 0 pts. | The existence of the following contributing factors should |
| | | increase the final rating: |
| | | Detailed/complex reference material supports the |
| | | control |
| | | User during the ‘Learning Curve’ is continually |
| | | referring to reference material to perform the control |
| | | properly. |
| | | Only users that possess a particular skill set perform |
| | | this control efficiently and predictably. |
| Time Constraint | High (5) = 3 pts. | This score can be looked at from two different angles |
| Variability (5-3-1) | Med (3) = 2 pts. | describing the same assessment: |
| | Low (1) = 0 pts. | In the case of ‘control failure scenario’, how variable is |
| | | the result of a control when the user performing the |
| | | control is under greater than normal time constraints. |
| | | Measures how easy it is for a user to perform the letter |
| | | of the control but not the spirit of the control. (Note: An |
| | | example of performing the letter but not the spirit would |
| | | be to sign-off on a reconciliation but not actually |
| | | performing the document review that the signature |
| | | indicated had been performed.) |
| Effectiveness | Highly Effective (5) = 0 | The risk manager is asked to rate the ‘effectiveness’ of |
| Assessment (5-4-3-2-1) | pts. | the control. |
| | Mostly Effective (4) = 1 pts. | Effective in terms of how effective the ‘client manager’ |
| | Somewhat Effective (3) = 2 | feels the control is toward mitigating the risk factor that it |
| | pts. | is related. |
| | Marginally Effective (2) = 3 | |
| | pts. | |
| | Not Effective (1) = 5 pts. | |

Preferably, the weakness points are summed to yield a CIWP for the associated control activity.

At step 608, for one or more of the set of Risk Factors having two or more associated CAs, the process receives a percent impact exposure (PIE) for each of the CAs associated with the Risk Factor. Although it is customary to have one CA mitigating one Risk Factor, multiple CAs may be assigned to mitigate the risk associated with a single risk factor. When multiple CAs are applied at different points in time to mitigate a risk factor, this strategy is known as “layered defense” or “defense in depth.”

In a layered defense scenario, each CA is assigned a PIE score associated with the Risk Factor. The PIE score allows a bank auditor to identify the relative effectiveness or importance of controls that have been assigned to mitigate the Risk Factor. For example, if a first CA and a second CA were associated with a Risk Factor, the first CA might be given a PIE score of 90%, while the second CA might be given a PIE score of 10%. In this case, any weakness points assigned to the first CA would cause the final residual accepted risk score (explained in more detail below) of the business function to be higher than if the PIE scores of the first CA and second CA were the same. It should be noted that the sum of all PIE scores for each risk factor must total 100%. If the bank auditor does not specifically assign a PIE score, the model assigns a PIE default value of: [1/(# of CAs)]. The model allows for a layered defense sequence to be established which identifies the order in which the controls are performed. It should be further noted that multiple Risk Factors within the same business function cannot use the same CA to mitigate the Risk Factors. That is, the CAs are intended to have specific objectives and Risk Factors are intended to be scored mutually exclusively from one another.

At step 609, the process calculates a mitigation markdown percentage (MMP) for each Risk Factor. The MMP=(CIWP for the associated CA*0.1*PIE for the associated CA). For Risk Factors having more than one CA, the total MMP is equal to the sum of the MMPs for each CA. That is, total MMP=[(CIWP for CA #1)*(0.1)*(PIE for CA #1)]+[(CIWP for CA #2)*(0.1)*(PIE for CA #2)]+ . . . +[(CIWP for CA #n)*(0.1)*(PIE for CA #n)].

At step 610, for Risk Factors having more than one CA, the process uses the total MMP to calculate a final mitigation markdown percentage (FMMP) for each Risk Factor, where FMMP=MMP/# of layers.

At step 611, the process uses the FIRS, the IMPR, and the FMMP of each Risk Factor to calculate a Residual/Accepted Risk (RAR) for each Parent Entity, wherein the RAR=For RF#1 [FIRS−(FIRS*IMPR)+(FIRS*IMPR*FMMP)]+For RF#2 [FIRS−(FIRS*IMPR)+(FIRS*IMPR*FMMP)]+ . . . For RF#n [FIRS−(FIRS*IMPR)+(FIRS*IMPR*FMMP)].

The RAR is a quantification, for each Parent Entity, of the amount of residual risk left after any mitigating controls have reduced the overall inherent risk of the Parent Entity.

### Scoring Examples

FIGS. 7A-7F illustrate an example of the risk scoring process described generally with respect to FIG. 6. Specifically, FIGS. 7A-7F illustrate the risk scoring process for the “Process Wire Request” business function, which corresponds to element 596 in FIG. 5K.

With regard to FIG. 7A, a user may cause the screenshot of FIG. 7A to be displayed by clicking on BF 596 in FIG. 5K, for example, to provide expanded detail of how the depicted score for that business function is calculated. For the selected business function, FIG. 7A provides two overviews of the risk factors associated with that business function. The first overview, entitled “Excluding New,” is an overview of the business function that does not include the new control activities that have been recommended as part of the CA-GA. The second overview, entitled “Including New,” is an overview of the business function that includes the new control activities that have been recommended. Thus, the display shown in FIG. 7A allows a user to quickly assess how the recommended new control activities affect the residual risk of the selected business function.

Each of the overviews in FIG. 7A includes two Risk Factors associated with the selected business function: a Risk Factor titled “Regulatory Risk” 702 and a Risk Factor titled “Fraud Risk Internal” 704. Each Risk Factor includes a missing CA number 706 specifying a number of control activities missing from a Risk Factor, as determined by the CAGA report. It should be noted that the missing CA numbers 706 in the “Including New” overview will be zero because the “Including New” overview assumes that any CAs recommended by the CAGA report have been implemented. Each Risk Factor includes a Risk Factor Score 708 and a Risk Factor Weight 710, respectively assigned by the ART system or entered by an auditor at step 602 and 603 of FIG. 6. Each Risk Factor further includes an Inherent Risk Score 712, determined by multiplying Risk Factor Score 708 by Risk Factor Weight 710. The Inherent Risk Scores 712 for each Risk Factor are added to yield a Final Inherent Risk Score 714, determined at step 604 of FIG. 6. Each Risk Factor further includes a number of CAs 716, a number of critical controls 718, and a number of key controls 720.

Each Risk Factor further includes a mitigation percentage 722, calculated by adding the Initial Mitigation Percentage Rate (IMPR) for each CA in the Risk Factor. In the illustrated example, each of the CAs associated with the business function has been given an assessment of “marginal mitigation,” corresponding to a base mitigation percentage of 20%. Because there are two CAs associated with the “Regulatory Risk” Risk Factor, and three CAs associated with the “Fraud Risk Internal” Risk Factor, the two Risk Factors have a mitigation percentage of 40% and 60%, respectively.

Each Risk Factor further includes a Residual Risk Before Weakness 724, calculated using the formula (Inherent Risk Score−Inherent Risk Score*mitigation percentage), and a number of Control Activity Weakness Points 726. Each Risk Factor also includes a mitigation percentage after weakness points 728, which is calculated using a function of the weakness points.

For each Risk Factor, the Inherent Risk Score 712 is multiplied by the mitigation percentage after weakness points 728 to yield a Residual Risk Final Value 730. The Residual Risk Final Value for the Risk Factors correspond to the Final Residual Risk Scores 730 shown in FIG. 7D. The Residual Risk Final Values are added to produce the business function Residual Risk Score 5102.

FIG. 7A further displays a Risk Factor Trend 732 for each Risk Factor. The Risk Factor Trend is based on the client's assessment of whether the risk as defined by the Risk Factor is increasing, decreasing, or relatively stable.

FIG. 7A further includes a difference bar 734. The difference bar 734 displays, for the selected business function, the differences in the risk-related quantities before and after enacting the control activities recommended by the CAGA report. In the illustrated example, enacting the recommended CAs causes the residual risk associated with the business function to drop from 12.6 to 7.1, a drop of 5.5 points. Thus, the display shown in FIG. 7A provides a user with a high-level view of the overall risk impact that implementing the CAs would have on a particular business function.

Referring now to FIG. 7D, FIG. 7D shows detailed calculations of each of the current risk scores 599 for the Process Wire Request BF 596. To reach a screen or display such as that in FIG. 7D in the CA-GA report, a user may click on any of the current risk scores for the desired business function, such as Residual Risk Score 5102 in FIG. 5K.

FIG. 7D includes the two Risk Factors also shown in FIG. 7A: the “Regulatory Risk” Risk Factor 702 and the “Fraud Risk Internal” Risk Factor 704. In the illustrated example, the “Regulatory Risk” Risk Factor 702 includes two control activities: CA#1 and CA#2, and the “Fraud Risk Internal” Risk Factor 704 includes three control activities: CA#3, CA#4, and CA#5. “Regulatory Risk” Risk Factor 702 and “Fraud Risk Internal” Risk Factor 704 are each associated with a Residual Risk Final Value 730. The two Residual Risk Final Values 730 are summed to calculate the Business Function (BF) Residual Risk Score 5102. The calculation of the Residual Risk Final Values 730 and BF Residual Risk Score 5102 will be explained in more detail below.

Inside the dashed box on the right of FIG. 7D are multiple columns of numbers, labeled ‘A’ through ‘G’. Each column contains multiple numbers, each number corresponding to a respective one of control activities CA#1 through CA#5, or to a respective Risk Factor. The numbers in columns ‘A’-‘G’ are used in the calculation of the Residual Risk Final Value 730.

Column ‘A’ contains a number of Inherent Risk Scores 712, each Inherent Risk Score 712 associated with a respective Risk Factor. Each of the Inherent Risk Scores 712 corresponds to the FIRS determined at step 604 in FIG. 6. The Inherent Risk Scores 712 are totaled to result in the Final Inherent Risk Score 714, shown in FIG. 7A.

Column ‘B’ contains a number of Initial Marginal Percentage Rates (IMPR) 744, each IMPR 744 associated with one of control activities CA#1 through CA#5. For each Risk Factor, the IMPRs 744 add to a mitigation percentage 722, also shown in FIG. 7A.

Column ‘C’ contains a number of “Point %” scores 748 calculated in this embodiment by multiplying the assigned Weakness Points of each control activity by 0.1, each Point % score associated with one of control activities CA#1 through CA#5. The Weakness Points in the formula above is explained with respect to element 607 of FIG. 6.

Column ‘D’ contains a number of percent impact exposure (PIE) scores 750, each PIE score associated with one of control activities CA#1 through CA#5. The PIE score 750 denotes the relative effectiveness or importance of controls that have been assigned to mitigate an associated Risk Factor. As explained above with respect to element 608 of FIG. 6, the PIE scores 750 are assigned by an auditor, and all of the PIE scores 750 associated with a particular Risk Factor must add to 1.

Column ‘E’ contains a number of products 752, each product calculated by multiplying the point % score 748 and the PIE score 750 for the respective one of control activities CA#1 through CA#5. For each Risk Factor, the products 752 are added to produce a Risk Factor product 754. Each of the Risk Factor products 754 in column ‘E’ corresponds to the MMP shown at step 609 in FIG. 6.

Column ‘F’ contains the respective number of layers 756 associated with each of the “Regulatory Risk” Risk Factor 702 and the “Fraud Risk Internal” Risk Factor 704. Each layer includes a number of controls that are implemented at a certain point in time within a Risk Factor. In the illustrated example, the number of layers 756 in each Risk Factor is equal to the number of control activities, indicating that each of the control activities within the same Risk Factor is implemented at a different point in time but directed toward mitigating the same risk.

Column ‘G’ contains a final mitigation markdown percentage (FMMP) 758 for each of the “Regulatory Risk” Risk Factor 702 and the “Fraud Risk Internal” Risk Factor 704. The FMMP 758 for each Risk Factor is calculated by dividing the respective product 754 in column ‘E’ with the respective number of layers 756 in column ‘F’. The FMMP 758 corresponds to the FMMP determined at step 610 of FIG. 6.

To calculate the sub-total Final Residual Risk Score 730 for each of the Risk Factors “Regulatory Risk” 702 and “Fraud Risk Internal” 704, the process uses the formula (‘A’−(‘A’*‘B’)+((‘A’*‘B’)*‘G’). That is, for each of the two Risk Factors, the process uses the relevant Inherent Risk Score 712 in column ‘A’, the mitigation percentage 722 in column ‘B’, and the FMMP 758 in column ‘G’ to calculate the corresponding Residual Risk Final Value 730. The Residual Risk Final Values 730 are added to produce a BF Residual Risk Score 5102, also shown in FIG. 5K.

Referring now to FIG. 7A, a user may click on one of the Inherent Risk Scores 712 in the “Excluding New” overview in FIG. 7A to activate the display in FIG. 7B. For the selected business function, FIG. 7B displays more specific information regarding the control activities than does FIG. 7A or FIG. 7D. FIG. 7B also displays information regarding the cost of performing the existing control activities.

For the selected business function, FIG. 7B displays the two Risk Factors shown in FIGS. 7A and 7D: the “Regulatory Risk” Risk Factor 702 and “Fraud Risk Internal” Risk Factor 704. FIG. 7B further displays each of the CAs associated with each of the Risk Factors. The “Regulatory Risk” Risk Factor 702 includes two CAs: CA#1 and CA#2, while the “Fraud Risk Internal” Risk Factor 704 includes three CAs: CA#3, CA#4, and CA#5.

FIG. 7B includes a control priority level 760 associated with each CA. The control priority level 760 may be ranked as critical, key, or normal. Upon failure of a Key Control, the risk of occurrence of an undesired activity would not be mitigated regardless of other controls identified. That is, reasonable assurance of achieving the process' objectives could not be obtained. Upon failure of a Critical Control, the risk of occurrence of an undesired activity would not be mitigated regardless of other controls identified within ANY process. Failure of critical controls would affect the ability of management to achieve not only process objectives, but also the Bank's financial statement objectives. FIG. 7B further includes a CA sequence 762 that denotes the chronological order in which the CAs are performed. Each number in the CA sequence 762 denotes a different CA layer, corresponding to the number of layers 756 shown in FIG. 7D. The number of layers 756 associated with a particular Risk Factor affects the calculated FMMP.

Only business functions that have a Risk Factor of “Regulatory Risk” associated will have a regulatory statement ID 764 defined. The regulatory statement ID 764 corresponds to a particular ART Regulation Statement (as defined in in said document within the section titled “Parent Entity 7: Formal Regulations Model”). Some CAs may not be associated with a regulatory statement; the regulatory statement ID 764 for such CAs is denoted as “N/A.”

A P or D indicator 766 is associated with each CA, the P or D indicator is either Preventative or Detective respectively. A Preventative control is before the fact; where a Detective control is after the fact which weakens the full mitigation.

A fully automatic indicator 768 is associated with each CA. The fully automatic indicator 768 is a binary value that indicates whether the associated CA is performed fully automatically within the client bank's processes. If the associated CA is fully automatic, the fully automatic indicator 768 is given a Weakness Point value to indicate this, such as an integer value of ‘1’. If the associated CA is not fully automatic, the fully automatic indicator 768 shows this for example with a value of ‘0’.

An execution complexity indicator 770 is associated with each CA, the execution complexity indicator 770 denoting the difficulty of implementing the associated CA. The execution complexity is rated on a scale of 0 to 2, with 0 indicating a relatively low difficulty of execution, 1 indicating a medium difficulty of execution, and 2 indicating a relatively high difficulty of execution.

A learning curve indicator 772 is associated with each CA, the learning curve indicator 772 denoting the amount of time a typical bank employee would require to learn (via training or time on job) how to effectively perform the CA. The learning curve indicator 772 is rated on a scale of 0 to 3.5, with 0 indicating a low amount of time to learn how to perform the relevant CA, 1.5 indicating a medium amount of time, 2.5 indicating a high amount of time, and 3.5 indicating a very high amount of time.

A time constraint variability indicator 774 is associated with each CA, the time constraint variability indicator 774 denoting the variation in the quality of performance of for the associated CA, if it is completed under a time constraint. The time constraint variability is rated on a scale of 0 to 3, with 0 indicating a low amount of variability or quality sensitivity to time constraints, 2 indicating a medium amount, and 3 indicating a high amount.

An effectiveness assessment indicator 776 is associated with each CA, the effectiveness assessment indicator 776 denoting the observed effectiveness of the relevant CA, preferably based an input reflecting the judgment of an auditor (although other users such as an internal bank risk manager may input these values in other embodiments or scenarios). The effectiveness assessment indicator 776 is rated on a scale of 0 to 3, with 0 indicating a very high observed effectiveness, 1 indicating a high effectiveness, 2 indicating a medium effectiveness, and 3 indicating a marginal effectiveness.

The scores displayed in P or D indicator 766, fully automatic indicator 768, execution complexity indicator 770, learning curve indicator 772, time constraint variability indicator 774, and effectiveness assessment 776 represent weakness points that are used to calculate a mitigation markdown percentage (MMP) for each CA. For each CA, the weakness points are added for that CA, and the sum is displayed as a total weakness points indicator 778. Within each Risk Factor, the total weakness points indicators 778 are totaled to result in the Control Activity Weakness Points 726 associated with that Risk Factor, as also shown in FIG. 7A.

A marginal mitigation indicator 780 is associated with each CA, the marginal mitigation indicator denoting whether the relevant CA fully or partially mitigates the risk associated with the relevant business function. The marginal mitigation indicator is assigned a value “Y” or “N,” with “Y” indicating that the relevant CA mitigates the risk by 20%, and “N” indicating that the relevant CA completely mitigates the risk.

A PIE score 750 is associated with each CA. The PIE score is explained in more detail with respect to FIG. 7D.

A personnel cost indicator 784 is associated with each CA, the personnel cost indicator 784 denoting an estimated average cost required to perform the associated CA over the course of a month.

A business function sub-total line 786 displays total weakness point values associated with a corresponding Risk Factor within the selected business function. For each of the weakness point FIGS. 766 through 778, the business function sub-total line displays the sum of the values associated with each CA within that Risk Factor. In addition, the business function sub-total line 786 displays the sum of personnel costs 784 for each CA within the Risk Factor. Because there are two Risk Factors in the illustrated example, there are two business function sub-total lines 786.

A grand total line 788 displays total weakness point values associated with the selected business function. For each of the weakness point FIGS. 766 through 778, the grand total line displays the sum of the sub-totals associated with each Risk Factor. In other words, the grand total line 788 displays the sum of the sub-totals displayed on the business function sub-total lines 786. In addition, the grand total line 788 displays the sum of the personnel costs 784 for each CA within the business function. Thus, the display illustrated in FIG. 7B allows a user to quickly assess the weakness points and costs associated with the existing control activities for a selected business function.

Regarding FIG. 7C, FIG. 7C has a layout similar to that of FIG. 7B. However, while FIG. 7B displays information regarding only the existing control activities, FIG. 7C displays information regarding the both existing and new control activities. Thus, the “Regulatory Risk” Risk Factor now has three associated CAs (CA#1-CA#3), while the “Fraud Risk Internal” Risk Factor now has five associated CAS (CA#4-CA#8).

FIG. 7C also differs from FIG. 7B because FIG. 7C has an additional column that FIG. 7B does not: a column of new key indicators 790. Each new key indicator 790 is a binary value associated with a CA, the new key indicator 790 denoting whether the associated CA is new, or whether it is a previously existing CA. If the new key indicator 790 contains a “Y”, the CA has been newly added following the CAGA report, and is not an existing CA. Thus, in FIG. 7C, CA#3, CA#7, and CA#8 are newly added control activities.

A user may compare FIG. 7C to FIG. 7B to quickly assess the cost of implementing the new CAs. In the illustrated example, FIG. 7B shows that the cost of the existing CAs is $509.00 per month, while FIG. 7C shows that the cost of the existing and new CAs is $660.25 per month. Thus, the additional cost of implementing the new CAs is ($660.25−$509.00)=$151.25.

Regarding FIG. 7E, FIG. 7E has a similar layout to that of FIG. 7D. However, while FIG. 7D displays information regarding only the existing control activities, FIG. 7E displays information regarding both the existing and new control activities. Thus, the “Regulatory Risk” Risk Factor now has three associated CAs (CA#1-CA#3), while the “Fraud Risk Internal” Risk Factor now has five associated CAs (CA#4-CA#8).

In FIG. 7E, it may be seen that the new CAs, specifically CA#3, CA#7, and CA#8, cause their respective Residual Risk Final Value 730 to be lower than those in FIG. 7D. Specifically, new CA#3 has caused the Residual Risk Final Value 730 of the “Regulatory Risk” Risk Factor 702 to fall from 5.9 to 4.1. In addition, new CA#4 has caused the Residual Risk Final Value 730 of the “Fraud Risk Internal” Risk Factor 704 to fall from 6.8 to 3.0. Therefore, the BF Residual Risk Score 5102, a sum of the Residual Risk Final Value 730, has fallen from 12.6 to 7.1. That is, the addition of the new CAs has caused the risk associated with the selected business function to decrease.

Regarding FIG. 7F, a user may click on a personnel cost indicator 784 for a desired CA in FIG. 7B or 7C to display FIG. 7F. The display shown in FIG. 7F provides the user with a more detailed breakdown of the cost associated with the selected CA. In the illustrated example, a user has reached FIG. 7F by clicking on the personnel cost indicator 784 associated with new CA#7 in FIG. 7E. FIG. 7F displays three main sections: an employee cost assumption spreadsheet 792, an item cost spreadsheet 794, and personnel cost 784.

Employee cost spreadsheet 792 (Section A) includes a column of employee rank indicators 796. Each of employee rank indicators 796 denotes a different level of employee who may be involved in the execution of the selected CA. Each employee rank indicator 796 is associated with an average salary indicator 7100, estimated benefit indicator 7102, and estimated tax indicator 7104 that respectively indicate an average annual salary, average annual benefit, and annual income tax associated with the corresponding employee rank. For each employee rank, the indicators 7100 through 7104 are used to calculate an hourly cost per employee 7106. For each employee rank, the hourly cost per employee 7106 is divided by 60 to yield an employee cost per minute 7108.

Item cost assumption spreadsheet 794 includes an item name indicator 7110, a frequency of occurrence indicator 7112, and a daily occurrence indicator 7114. The item name indicator denotes the type of action being performed, while the frequency of occurrence indicator 7112 specifies a basis on which the act is performed. For example, if an item does not occur at regular, predictable intervals, the frequency of occurrence indicator 7112 is marked as “transactional,” indicating that the item is conducted every time a transaction occurs. Other possible Frequency values include the titles of Daily, Weekly, Monthly, Quarterly, Annually. When any of these other frequencies are selected, the Frequency title indicates the frequency by which the control is performed. The example of Monthly means that the control is performed once a month.

For items that occur on a “transactional” basis, the daily occurrence indicator 7114 specifies an average number of times that the item is performed daily.

Item cost assumption spreadsheet 794 further includes, for each employee rank listed in employee cost spreadsheet 792, the following indicators: a minimum time indicator 7116, a maximum time indicator 7118, an average time indicator 7120, and an average cost indicator 7122. The minimum time indicator 7116 denotes a low-end estimate of the amount of time, in minutes, that an employee of the corresponding rank would require to complete one occurrence of the listed item. The maximum time indicator 7118 denotes a high-end estimate, in minutes, of the amount of time an employee of that rank would require. The minimum time indicator 7116 and the maximum time indicator 7118 are averaged to calculate average time indicator 7120 for the respective employee rank, the average time indicator 7120 denoting an average amount of time, in minutes, that an employee of the corresponding rank would require to complete one occurrence of the selected item. Average time indicator 7120 is multiplied by the cost per minute indicator 7108 associated with an employee of the corresponding rank to calculate the average cost indicator 7122. The average cost indicator 7122 denotes an estimated average cost required for an employee of the corresponding rank to complete one occurrence of the selected item.

Personnel cost 784 denotes an estimated total cost per month associated with the performance of an item. Personnel cost 784 is calculated using the formula (average cost indicator 7122*daily occurrence indicator 7114*days occurrence is performed per month). To more clearly illustrate how total personnel cost 784 is calculated, FIG. 7F will be explained with regard to the exact numbers shown in the example. Turning first to item cost spreadsheet 794, the minimum time indicator 7116 and maximum time indicator 7118 are filled out for a rank 3 employee (line level officer), indicating that a line level officer performs the relevant item. From the associated employee cost per minute indicator 7108 in employee cost assumption spreadsheet 792, it may be seen that the estimated cost per minute for a line level officer is $0.35/minute. Returning to item cost spreadsheet 794, the minimum time indicator 7116 is set to 0.5, and the maximum time indicator 7118 is set to 2, indicating that a typical line level officer would require between 0.5 minutes and 2 minutes to perform the selected item. The average of these figures, 1.25, is shown in the average time indicator 7120. To determine the average cost indicator 7122, the average time indicator 7120 (1.25) is multiplied by the cost per minute indicator 7108 ($0.35), yielding an average cost of $0.44 per action. The personnel cost 784 is determined by multiplying the average cost indicator 7 times the daily occurrence indicator, and multiplying that product times the number of days per month during which the item is performed. Because one month contains four weeks, and each week typically contains five workdays, the default number of days per month during which an item is performed is 20. Thus, the total cost associated with performing the action over the course of a month is indicated as $0.44*7*20=$61.60.

### BPB Model Updates

FIG. 9A is a flow chart illustrating a method of updating best practice bank changes, and transferring those changes to a client bank server. The BPB model may be updated when the audit firm determines that best practices have changed related to a particular control activity based on regulatory changes or other industry developments. In this case, the BPB model needs to be updated and distributed to each client bank employing the model as a benchmark. In general, the update process is preferably initiated by the audit firm, which updates the BPB SQL Schema and hosts it on their server (ART1 system). Then SQL update scripts are pushed to multiple client banks, preferably via a web service, to update the banks internal model stored with its ART2 application. After an update occurs, the bank may choose to create an initiative to bring its internal processes into conformance with the new best practices as reflected in the updated BPB model. This process is described in more detail below.

Referring to FIG. 9A, the BPB model update process begins when an audit firm personnel wishes to make a change to the BPB model, the auditor first defines an “end goal” justification for performing the changes at step 940. Next at step 941, the auditor documents the BPB change goal through a form presented by the Best Practices Bank-Attributes model (FIG. 2A) and subjectively selects an importance level of “high,” “medium,” or “low” of performing the change, preferably based on the following criteria. 1. High—Significant changes to the BPB infrastructure due to new technology, methodology, or regulations. 2. Medium—A marginal change to the BPB infrastructure due to new technology, methodology, or regulations. 3. Low—A cosmetic change to the BPB infrastructure. In a preferred embodiment, these update characteristics are then saved to a change log table to track the purpose and importance of the BPB model changes. FIG. 9C shows an example BPB update database schema, employed to track BPB model changes in one embodiment. In the depicted SQL schema, the table titled ‘BPB00ParentEntityChangeLogHeaders’ is updated at step 941 to save the inputs made related to the goal of the update. Preferably, step 941 saves changes to the following critical fields: (1) ‘BPB01ParentEntityID’ (this field is a foreign key to the ‘BPB01ParentEntities’ table and related the overall change to a parent entity; (2) ‘EndGoalSupportingDesc’, which holds a text description of a user provided ‘end goal’ justification for performing the changes; and (3) ‘ImportanceLevel531’, which holds the ‘BPB Change Importance Level’ of ‘High’ ‘Medium’ or ‘Low’ described above.

At step 942, the ART1 user performs one or more changes to BPB to finalize implement ‘Change Goal’. At step 943, when the auditor implements and saves these changes to the BPB model, data describing the change is written to an appropriate change log table. This change log table is preferably stored on the ART1 server in the table titled ‘BPB00ParentEntityChangeLogDetails’ (FIG. 9C). For each change that is performed, the following key fields are obtained to outline the changes. All of the fields are automatically determined based on the actions that the user performs. The word ‘AUTO’ after the ‘field name’ designates that ART2 automatically associates the contents of the field based on the context of users actions: (1) ‘BPB00ParentEntityChangeLogHeaderID’ AUTO—this is a foreign key (FK) to the HeaderID established at step 941. This ID establishes the parent child relationship; (2) ‘BPB00ParentEntityChangeLogTypeID’ AUTO—this is a FK to the Change Log Type Table; (3) ‘NewParentEntityElementTF’ AUTO—True indicates that this change is a new ‘element’ addition to the Parent Entity. False indicates that this is a change to the existing BPB data points; (4) ‘BPBDatabaseTableDesc’ and ‘BPBDatabaseTableID’ AUTO—these fields indicate what table was affected by the change.

At steps 944 and 945, copies of the newly updated BPB model and change log table updates are automatically transmitted to the ART2 server. In a preferred embodiment, ART1 employs WCF Services to send to the various ART2 applications in the field SQL script that will update ART2's ‘Change Log Tables’ to mirror ART1's tables. Such a transmission will typically include, in some format, the key data described above, which is stored in the Change Log Tables 922 (FIG. 9B), but may include in some embodiments the updated BPB SQL Schema structure and data 920. In some embodiments, the update fields are transmitted and the SQL update script is generated at the receiving end. Preferably, the transmission is conducted using Windows Communication Foundation (WCF) technology and authenticated and secured using practices according to chapter 13 of Microsoft's publication title “Patterns and Practices Improving Web Services Security: Scenarios and Implementation Guidance for WCF.” While the depicted flow chart shows two separate transmissions, this is not limiting and various embodiments may include all data necessary to perform and characterize the update in a single transmission. Further, while the preferred embodiment herein uses an update script, this is merely an embodiment of the general concept that update data is transmitted to the banks. The method generally sends update data to the client bank ART2 system, providing the system with information necessary to make the update. In some embodiments this information may only include the updated data, while in others it may includes instructions or scripts necessary to make the update on the client bank ART2 system.

At step 946, the ART2 system executes the received scripts and notifies a change log reviewer (930 in FIG. 9B) at the client bank, who examines the newly updated BPB model and change log tables, as further described with respect to FIG. 9B.

In response, the ART2 system enables the reviewer 930 to take several possible actions after the updated BPB model and change logs are stored on the client bank server, depicted as options in the flow chart. At step 947, the change log reviewer may review the change log report. If the change log reviewer 930 requires additional information regarding the nature of the changes to the BPB, he may review the details in the reports linked to the change logs at step 948. Preferably, the system has a defined set of ‘Change Log Types’, each associated with an appropriate report template that allows the user to see the changes in context with other Parent Entity elements. The system uses such templates, populated with the received change log data, to provide reports to the user regarding the received changes. In addition, the change log reviewer 930 may execute a bank initiative submission at step 949. The actor ‘Role_Best Practice Bank Change Log Reviewer’ is provided in the header row of the ‘Change Log Report’ a clickable ‘link button’ to start the process of inputting a ‘Bank Initiative’. An input template is provided to input a new Bank Initiative based on the particular change to the BPB model.

FIG. 9B is a system architecture diagram 900 of a client bank server module in the ART2 system that allows the client bank to automatically integrate and update BPB model data from an outside source over the internet. The source may be the ART1 system running on an audit firm's server, or a third party data service. The module 900 includes a Standard Data Integration Objects (SDIO) structure 902 and a Windows Communication Foundation (WCF) structure 904. An admin/developer 906 and a title bank DBA 908 are authorized to access the data structure 900 and may input information into the elements within data structure 900, or receive information from the elements, as described below.

Regarding SDIO structure 902, it is the common practice of ART2 to not have authentication into any ‘Network Target Repository’ (NTR)’ that requires authentication to access the data. The strategy to access the NTR data is for the NTR to export the data to a CSV file within a network directory that a specific user roles on the ART2 Server have access to.

SDIO structure 902 includes a primary user authentication data structure 910, a human resources (HR) data structure 912, a vendor data structure 914, and a general ledger (GL) data structure 916.

Regarding the primary user authentication data structure 910, primary user authentication structure 910 contains a directory of personnel authorized to access ART2. The directory includes employee data such as the employees' names, contact information, social security, and job title. The admin/developer 906 or title bank DBA 908 may add, change or delete information from primary user authentication data structure 910 as needed.

Regarding HR data structure 912, HR data structure 912 includes additional employee data for personnel authorized to access ART2. This data may include information such as the employee's manager's name, the department in which the employee works, the employee's job description, and a strata of pay corresponding to the employee's salary. For example, employees in a highest salary bracket might correspond to an “A” strata of pay; employees in a second-highest salary bracket might correspond to a “B” strata of pay, and so on. The admin/developer 906 or title bank DBA 908 may add, change or delete information from HR data structure 912 as needed.

Regarding vendor data 914, vendor data structure 914 includes vendor information from the client user's core Customer Information File (CIF) records. The data may include the following data elements:

1. Date of Data Import

2. CIF #

3. Last 5 TIN #

4. Origination Date

5. Name

6. Date Last Paid

7. Paid YTD

8. Paid 1-yrs Prior (12 mths)

9. Paid 2-yrs Prior (12 mths)

Regarding GL data 916, GL data structure 916 includes GL information from the client user's core GL records. The data may include the following data elements:

1. Date of Data Import

2. GL Acct Name

3. GL Account Number

4. If Income statement, the Mthly Avg over the past 12-mths.

5. If Income statement, the Mthly Avg over the past 3-mths.

6. If Balance Sheet, the End of Mth Avg over the past 12-mths

7. If Balance Sheet, the End of Mth Avg over the past 3-mths

8. The GL Account ‘Category Title’

9. The Category Title ‘Sequence’

10. The Category Title ‘Hierarchal Level Indicator’

11. The Category Title ‘Description’

WCF structure 904 includes a UBPR Bank data structure 918, a BPB SQL Schema 920 data structure, and a BPB Change Log Tables data structure 922.

Regarding the UBPR Bank data structure 918, the UBPR Bank Data Structure 918 issues a daily call for the download of a Uniform Bank Performance Report (UBPR). The UBPR is an analytical tool created by the Federal Financial Institutions Examinations Council (FFIEC) to help supervise and examine financial institutions. On a quarterly basis each financial institution that is regulated by the FDIC, FRB, or OCC must file a ‘call report’ of key financial data-points. Based on these call reports, the FFIEC issues the UBPR, which serves as an analysis of the impact that management and economic conditions can have on a bank's balance sheet. The UBPR examines liquidity, adequacy of capital and earnings and other factors that could damage the stability of the bank. The UBPR is issued in a standardized format that can be downloaded by the public.

A third party, or an appropriate department of the audit firm, transposes the UBPR report into particular tables and columns. This formatted data is hosted on an “Application Server” that is downloaded by the ART2 client into UBPR Bank data structure 918 on a daily basis and utilized within the client bank application.

Regarding the BPB SQL Schema 920, the BPB SQL Schema structure 920 contains a copy of the full SQL schema of the best practices bank (BPB). The BPB SQL Schema is updated on the audit firm's server, and then transferred to the client bank's server, as explained with respect to FIG. 9A. In addition, when the BPB SQL Schema is updated, log tables indicating the changes are also stored on the audit firm's server and transferred to a Changed Log Tables structure 922 within the client firm's server.

After ART2 receives a WCF notification from ART1 that the BPB has changed, ART2 automated system process 926 at step 924 executes an event notification to authorized users, as described with respect to FIG. 9A.

### Policy Mapping

FIG. 10A is a diagram of a use case for a policy mapping process according to another embodiment. The process is preferably conducted through the ART1 or ART2 platform, through the Policy Statement Mapping to Services and Controls modules (FIG. 2A). The depicted process generally provides a tool with which the bank and audit firm can map the bank's internal policies, reflected in policy documents, to the various Control Activities (CAs) or ERM activities conducted in the bank.

The need for such a services arises because there is often a disconnect between the various ‘Board of Directors Policy Statements’ and the Business Function/control structure that supports the statements. This service bridges this disconnect by mapping the two, allowing bank management to track what policies match with what controls. Given the considerable time and expense to map policy statements to control activities, this service would typically only be performed by Clients that intend to utilize ART2 to help manage their Policies and to implement the appropriate Control Activities. Preferably, this service is performed after the CA Gap Assessment has been finalized. The process includes a set of steps 1000 typically conducted by the clients internal staff, while the remaining steps are preferably conducted by the audit firm, although this is not limiting and all of the steps may be performed by the client or the audit firm.

The steps 1000 are intended to prepare the bank's policy documents for processing and mapping by the ART system. At step 1001, the bank personnel save a copy of the bank's policies to a folder in preparation for a bulk upload to the ART system. Next at step 1002, the bank personnel, preferably through automation provided by the ART system, convert the policy documents to MS Word format (or another suitable standard) and rename the policy document files according to a supplied syntax for file naming. Next at step 1003, the bank personnel upload the policy document files to the ART1 server in a secure bulk upload process.

After the upload to the ART1 system running at the audit firm, the auditors preferably take over the process for steps 1004-1008. At step 1004, the auditor maps the uploaded document titles to a policy title present in the BPB model bank policies. Next, at step 1005, the ART1 system parse each uploaded ‘Policy Document’ into various ‘Meta Data Elements’ (i.e. Sections/Paragraphs/Images/Sentences/Table Data/bulleted lists/Outlines etc.) and save the elements into the SQL database. Each Meta Data Element is given a unique ID within the application. Next at step 1006, the auditor uses ART1 to group Meta Data Elements together in logical “buckets” to form ‘Policy Statements’. ART1 allows either the Client or the Audit Firm auditor to perform an initial edit regarding the Meta Data Elements. The intended outcome of the initial edit is to group together one or more ‘unique IDs’ related to a particular policy to provide a “bucket” or group of the more detailed data elements (i.e. Sentences/Table Data/bulleted lists/Outlines) that make up the policy. This is preferably accomplished through a drag and drop interface where each Meta Data Element is visible to the auditor and can be dragged into an area associated with a group. The result is that particular groups of Meta Data Elements comprise the various ‘Policy Statements’. At step 1007, the ART1 system produces this policy statement by either allowing the auditor to enter a statement summarizing the various elements inside each bucket, or by automatically preparing a summary or complete statement of such elements.

Next, at step 1008, these policy statements that are related to the Bank's Control Activities. In a preferred version, each policy statement is mapped to one of the following: (1) If control related, it is mapped to the “Control Activity” (2) if ERM Q&A Model related, it is mapped to the ERM Q&A Tier#3 Statement. In this manner, the Policy Statements based on the banks existing policies are mapped to control activities and ERM activities within the relevant Parent Entities already determined during the CA-GA process that maps the banks control activities and ERM activities to the BPB model parent entities. This allows the Policy Statement to be mapped to the associated risks and scoring described above with respect to the CA-GA process.

ART1 is able to provide ‘version differences’ when the client changes or deletes aspects of a ‘Policy Statement’. Given that Policy Statements are linked to Risk scores, the ‘Annual Policy Board of Director Review’ process is more effective as Policy Annual Reviews can show the whole Policy but with version changes and risk scores associated to each of the Policy statements.

The policy mapping process allows the auditor to provide various deliverables to the client bank after Policy Statement Mapping. First, a Missing Business Function/Policy Statement Gap Report can be provided. Each Policy statement is related to one-or-more Business Functions. If the BF does not exist, it is placed on this report for the Client to either remove from the policy or create a Business Function toward. Also, the system can provide insight into what policies are missing with a Missing Policy Statement/Business Function Gap Report. Each Business Function that is related to one or more Key or Critical control activities is related to one or more Policy Statements. If the Policy Statement is not found then it is added to this report with the following variables related to the BF:
Total risk score

If regulatory related,
Total monthly avg cost to comply with reg.

If non-system,
Avg. complexity rating (i.e. how difficult is it to execute properly)
Avg. Time Constraint Variability (i.e. If the user is pressed for time, how variable/susceptible is the set of CA's to being non-compliant)

Further, when a hard copy of a policy is needed, ART builds an XML document from the MDE's. Through this method, the ART system makes available a number of Documentation Content options for the user whom is creating the XML:
Red line changes to Policy Statements
Versioning reports
Stack Ranking of Policy Statement Risk Scores
Etc.

FIG. 10B is a diagram of an SQL schema used to implement the policy mapping process described with respect to FIG. 10A. Referring to FIG. 10B where particular fields are highlighted and called out as 1011, shown are the essential fields to bulk upload original policies and to assign policy titles as outlined in steps 1003 and 1004. Also, referring to FIG. 10B where particular tables are highlighted and called out as 1012, shown are the fields required to store the parsed elements in step 1005 as well as the Policy Statement Buckets as outlined in step 1006 and 1007. Continuing to refer to FIG. 10B where particular fields are highlighted and called out as 1013, shown are fields required to identify controls and ERM Tier #3 Statements as outlined in step 1008.

As used herein, the terms “comprising,” “including,” “carrying,” “having,” “containing,” “involving,” and the like are to be understood to be open-ended, that is, to mean including but not limited to.

Any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

1. A method of assessing risk management in a bank using one or more software applications running on one or more application server processors, the method comprising:
a) providing a data model of a hypothetical best practices bank stored in memory of one of the application servers;
b) presenting one or more web forms to one or more client bank employees and receiving through the web forms data indicative of first risk management control activities operating at the client bank;
c) receiving data classifying selected ones of the first risk management control activities as being associated with certain business functions present in the data model of the hypothetical best practices bank;
d) generating a control activity gap assessment report comparing the first risk management control activities to the data model of the hypothetical best practices bank and identifying areas where the first risk management control activities are lacking compared to the hypothetical best practices bank; and
e) making the control activity gap assessment report accessible to an employee of the client bank.

2. The method of claim 1 wherein the data model of the hypothetical best practices bank is a hierarchical data model including data classifying certain best practices bank business functions by their department, business unit, and business function and further wherein the web forms receive data classifying one or more client bank business functions according to their department, business unit, and business function.

3. The method of claim 1 wherein the data model of the hypothetical best practices bank model includes a plurality of business function data structures each associated with respective external services of the client bank and each including an indicator of one or more related risk factors, each of the one or more related risk factors having a related weight, a related score, and an indicator that at least one of the first risk management control activities is directed to mitigating the risk factor.

4. The method of claim 3 further comprising generating the related score for at least one of the risk factors by taking into account an indicator of control activity weakness.

5. The method of claim 1 in which the one or more web forms include forms constructed to receive from the client bank employees selections classifying selected active business functions of the client bank as matching business functions present in the hypothetical best practices bank.

6. The method of claim 5, further comprising displaying the report in an interactive web form allowing browsing through multiple levels showing a basis of calculation of a plurality of residual risk scores associated with second selected active business functions of the client bank.

7. A method of providing risk scoring services to a bank using one or more software applications running on one or more application server processors, the method comprising:
a) receiving an indication that a set of risk factors is associated with a logical parent entity of an institution being evaluated;
b) providing an indicator of a risk factor score associated with an estimated inherent risk level for each respective one of the set of risk factors;
c) providing an indicator of a risk factor weight associated with each response one of the set of risk factors;
d) calculating a final inherent risk score value for each of the respective set of risk factors from its associated risk factor score and risk factor weight;
e) receiving an indicator of one or more control activities associated with at least one of the set of risk factors;
f) for each control activity related to each risk factor, providing an indicator of an initial marginal percentage rate based on an assessment of how much the control activity mitigates the respective associated risk factor;
g) for one or more of the set of risk factors having two or more associated control activities, receiving an assessment of a percent impact exposure for each of the control activities associated with the risk factor;
h) for each control activity, providing a weakness point total based on a set of weakness point assignments associated with the control activity;
i) calculating a mitigation markdown percentage for each control activity based on its respective weakness point total and percentage impact estimate;
j) for one or more of the set of risk factors having two or more associated control activities, calculating a final mitigation markdown percentage based on the mitigation markdown percentage and a number of layered control activities associated with each risk factor;
k) calculating a residual risk score for at least one of the logical parent entities based on the final inherent risk score, the initial marginal percentage rate, and the final markdown percentage for all of the risk factors associated with the parent entity.

8. The method of claim 7, wherein calculating a final residual accepted risk score for each parent entity further includes calculating using the following equation:
RAR=RF#1 [FIRS−(FIRS*IMPR)+(FIRS*IMPR*FMMP)]+RF#2 [FIRS−(FIRS*IMPR)+(FIRS*IMPR*FMMP)]+ . . . RF#n [FIRS−(FIRS*IMPR)+(FIRS*IMPR*FMMP)], (a)
where RAR is the final residual accepted risk score; RF#1-RF#n are the respective ones of the set of risk factors, FIRS is the final inherent risk score for each respective risk factor, IMPR is the initial marginal percentage rate for the relevant control activity associated with each respective risk factor, and FMMP is the final mitigation markdown percentage associated with each respective risk factor.

9. The method of claim 7, wherein providing an indicator of an initial marginal percentage rate further comprises determining whether one or more control activities are assessed to fully mitigate the risk factor and if so setting the rate to indicate full mitigation, and determining whether one or more control activities related to the respective risk factor are given assessments of marginal mitigation, and if so calculating the initial marginal percentage rate using a partial mitigation percentage assigned to each of the respective of control activities that are assessed to provide marginal mitigation.

10. The method of claim 7, wherein the set of weakness points includes at least two of the following:
a) a “preventative or detective” metric indicative of whether the control is a preventative control or a detective control;
b) a “fully automatic” metric indicative of whether the control is executed fully automatically within the institutions electronic systems;
c) an “execution complexity” metric indicative of whether the control has a high complexity to execute based at least on the number of steps in the control;
d) a “learning curve” metric indicative of how difficult it is for users to learn the control and how long it takes users to learn the control;
e) a “time constraint variability” metric indicative of whether the control might suffer in quality if performed under time constraints;
f) an “effectiveness assignment” metric indicative of an assessment by a client risk manager of how effective the control is toward mitigating the associated risk factor.

11. The method of claim 10, wherein the set of weakness points includes at least three of the weakness points listed in claim 10.

12. The method of claim 10, wherein the set of weakness points includes at least five of the weakness points listed in claim 10.

13. The method of claim 10, wherein the step of receiving an indication that a set of risk factors is associated with a logical parent entity of an institution being evaluated is performed over an application server adapted to allow first entry of the indication by a client bank employee and second verification of the indication by an external audit firm personnel.

14. A method of providing an update to a data model of a best practices bank, the data model employed by a client bank to assess adequacy of their functioning control activities, the method comprising:
a) storing, in memory at an application server, a data model of a best practices bank;
b) determining that an update is needed to the best practices bank model;
c) receiving, by the application server, an indication of a change goal related to the update;
d) receiving, by the application server, an indication of a change to be made to implement the change goal;
e) preparing update data to send to a client bank application server indicative of the change to the made to implement the update;
f) transmitting the update data to the client bank application server.

15. The method of claim 14, wherein the update data includes data indicating the change goal is related to the update.

16. The method of claim 14, wherein the update data includes at least one script command.

17. The method of claim 16, wherein the at least one script command is a database update script command.

18. The method of claim 14, wherein the step of transmitting the update data to the client bank application server is conducted by the application server interacting with a web service application running on the client bank application server.

19. The method of claim 14, wherein the update data further includes data comprising the entire data model of the best practices bank.
